(19) United States
(12) Patent Application Publication
(10) Pub. No.: US 2004/0103147 A1
(43) Pub. Date: May 27, 2004

(54) System for enabling collaboration and protecting sensitive data

(76) Inventors: Kevin E. Flesher, Broomfield, CO (US); Richard G. Tolley, Greenwood Village, CO (US); Keith Franklin, Highlands Ranch, CO (US); Michael I. Schwartz, Denver, CO (US); Charles W. Auten, Parker, CO (US); Todd Frauenhoff, Lakewood, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 10/459,394

(22) Filed: Jun. 10, 2003

Related U.S. Application Data
(63) Continuation-in-part of application No. 10/293,246, filed on Nov. 13, 2002.
(63) Continuation-in-part of application No. 10/293,230, filed on Nov. 13, 2002, now abandoned.
(63) Continuation-in-part of application No. 10/293,230, filed on Nov. 13, 2002, now abandoned.
(60) Provisional application No. 60/337,499, filed on Nov. 13, 2001.
(60) Provisional application No. 60/370,464, filed on Apr. 5, 2002.
(60) Provisional application No. 60/385,515, filed on Jun. 4, 2002.
(60) Provisional application No. 60/385,518, filed on Jun. 4, 2002.
(60) Provisional application No. 60/337,499, filed on Nov. 13, 2001.
(60) Provisional application No. 60/370,464, filed on Apr. 5, 2002.
(60) Provisional application No. 60/385,515, filed on Jun. 4, 2002.
(60) Provisional application No. 60/385,518, filed on Jun. 4, 2002.

(51) Int. Cl. G06F 15/16; G06F 7/00

(52) U.S. Cl. 709/204; 709/229; 713/201; 707/9

(57) ABSTRACT

The inventive system facilitates collaboration between multiple network users with respect to collaboration subject matter while maintaining the integrity of sensitive data. In one implementation, the system (200) includes a radiant collaboration subsystem (202) and a radiant sanitizer/guard subsystem (206). The guard (202) receives input information (206), reformats the input information (206) as necessary, and processes the input information and sanitizes the input information (206) based on predefined rules regarding dissemination of sensitive information to particular recipients. Sanitized outputs are provided by the guard (204) on a recipient-specific basis. The collaboration subsystem (202) allows for establishing a conference of collaborators identifying a document or documents to be included in the conference and allowing such documents as well as such documents to be represented to individual collaborators in accordance with the noted rules governing distribution of sensitive information. In this manner, collaboration is facilitated among collaborators that may have different limitations regarding access to sensitive data. The system (200) is useful in a variety of contexts, including the sharing of information as between public and private sector entities related to homeland security.

### RELATED APPLICATION INFORMATION

This application claims priority from U.S. patent application Ser. No. 10/293,246 filed on Nov. 13, 2002 entitled “Information Aggregation, Processing and Distribution System, and U.S. patent application Ser. No. 10/293,230 filed on Nov. 13, 2002 entitled “System for Enabling Collaboration and Protecting Sensitive Data”, and each of the '246 and '230 applications claim priority from U.S. Provisional Application Serial No. 60/337,499 which was filed on Nov. 13, 2001, entitled “Collaborative Information System and Method”; U.S. Provisional Application Serial No. 60/370,464 which was filed on Apr. 5, 2002, entitled “Radiant Trust Implementation of Terrorist Tracking Capability Pilot”; and U.S. Provisional Application Serial No. 60/385,518 which was filed on Jun. 4, 2002, entitled “Real-Time Collaborative Information Acquisition and Distribution System”. The entire disclosures of the referenced applications are incorporated herein by reference.

### FIELD OF THE INVENTION

The present invention relates in general to network-based collaboration and, in particular, to a system for facilitating collaboration where the collaboration subject matter includes sensitive information that may need to be handled in accordance with a policy defining multiple levels of access or use rights.

### BACKGROUND OF THE INVENTION

Older data access and analysis systems were generally built as large application programs where most, if not all, system capabilities were tightly coupled within the application. Having one large application proved difficult and costly to maintain. Changes to a single capability within the application often caused ripple effects throughout the source code requiring extensive changes to other areas of the application. Repeated modification to the application sometimes resulted in a system that was so large and complex that enhancements became too cost prohibitive to implement. As a result, in such data access and analysis systems, tools were generally restricted to a specific data source, there was difficulty in analyzing data from various sources, the systems were costly to enhance, and there was an inability to collaborate on multiple data sources at the same time to solve a problem.

More recently, certain systems have been proposed to enable sharing of tools and collaboration among multiple network users on a document, data or other subject of collaboration. In some cases, these systems require specialized software or hardware associated with each user's equipment to coordinate the collaboration effort or otherwise require a high level of specialized compatibility between the user systems. Additionally, in some cases, the subject of the collaboration is transferred from its source to a storage area designated for the collaboration effort or is otherwise made available for open access by other collaboration user systems. In any event, in conventional collaboration systems, when a particular subject of collaboration is designated for the collaborative effort, the provider of that subject matter typically relinquishes, to some extent, ownership or control of that subject matter. This is not necessarily problematic in the common case of fully trusted collaboration among peers with respect to collaboration subject matter that does not include sensitive information.

However, collaboration is often desired in other contexts. Examples include joint research and development, component or system integration efforts among unrelated companies, standardization discussions among potential competitors, interagency law enforcement efforts, international or cooperative public/private sector intelligence gathering and sharing, medical research based on private medical records from multiple facilities, etc. In such cases, collaboration may be desired to enable access to a broader scope of information, tools and expertise. However, the providers of collaboration subject matter in such contexts may not be willing to relinquish ownership or control of the subject matter to the extent required by certain conventional collaboration systems. As a result, there may be a chilling effect on otherwise desirable collaboration and the potential benefits thereof may not be fully realized.

The case of tracking suspected terrorists is illustrative. Information useful to identify and track terrorists may reside in many sources. For example, various data repositories within the intelligence communities of different countries may identify suspected terrorists as well as known aliases and other information regarding the suspected terrorists. Such information may be based on communication intercepts, intelligence sharing, field operations and the like. Other potentially relevant sources of information may include travel reservation databases, phone records, border crossing records, internet usage patterns, records of weapons purchases, financial transaction records, police contact records, records reflecting organization affiliations, records showing specialized training in areas of interest, e.g., flight school records, records of attempted or actual network security breaches, records of individuals having access to certain chemical or biological agents, etc.

Many different potential recipients may benefit from access to such information or the results of analysis thereof. Such recipients may include intelligence agencies who desire to aggregate and process such information to better identify and track suspected persons, airlines, arms salesmen, border officials, police, government agencies responsible for visa and passport issuance, etc.

It will be appreciated that the attempts to process and share information are currently hampered by a number of factors. First, the information resides in many sources associated with a variety of legacy systems. These systems are often proprietary systems with closed data structures, data formats and messaging protocols. For example, airline reservations databases and intelligence agency databases are not necessarily designed as open systems for purposes of interoperability. Accordingly, direct exchanges of information between such systems are generally not supported. Moreover, the sources of information are controlled by governmental and private entities. As a result, sharing of information invokes privacy and other civil liberties issues. The sources may transcend national boundaries, raising security concerns. Even within national boundaries, or within a single entity, different recipients may have different security clearances or internal authorizations allowing access to different levels or portions of sensitive information.

All of these factors indicate a need for great care in processing and exchanging information. Yet the need for real-time processing and exchange could hardly be more compelling.

Similar needs apply in other contexts. For example, companies may desire to automatically screen electronic communications from company network nodes to ensure compliance with policies regarding proprietary information while addressing privacy concerns. Within entities, electronic communications may be managed relative to email content policies and limitations on access to certain information. Financial institutions and other entities having peculiar security concerns may also benefit from careful but rapid processing of information exchanges in accordance with predefined rules as well as auditing of transmissions. Similarly, medical research may benefit from access to patient records from a variety of legacy sources provided that privacy concerns can be adequately addressed. It is apparent that such needs are not fully addressed by conventional systems available in these contexts.

### SUMMARY OF THE INVENTION

The present invention is directed to method and apparatus (“utility”) for facilitating collaboration between multiple network users with respect to collaboration subject matter while maintaining the integrity of sensitive data. The collaboration subject matter may include one or more documents, images, processing tools, database records, data objects or the like utilized in the collaboration utility. Collaboration, in this regard, involves at least one of: 1) making information available to multiple network users for substantially concurrent processing by the multiple users (“multiple user parallel processing”); 2) making information available to multiple network users which persists across time and allows all network users to see a coordinated view of the same data, irrespective of who changed it and when (“multiple user data collaboration”); 3) making information from multiple sources available for processing by a common tool, tool set, or tool programming interface (“multiple source aggregation”); and 4) making a common tool or tool set available for use by multiple users (“tool sharing”). Such collaboration is facilitated in accordance with the present invention while allowing the provider of the collaboration subject matter to maintain full ownership and control of the subject matter, thereby encouraging ever-increasing trust between collaborators and, in turn, an ever increasing degree of collaboration.

According to one aspect of the present invention, a utility is provided for automatically managing a collaborative environment involving multiple data systems. The utility involves: providing a collaboration system for controlling communications between the data systems, where the collaboration system communicates with the data systems via a defined interface; accessing a communication between users (two or more) of the multiple data systems; accessing processing information, indexed to one or more of the users, including executable rules for use in processing the communication; using the rules and the communication to obtain processed information; and providing an output to one or more of the identified users based on the processed information.

The executable rules may control handling of communications in a manner dependent on a source, a recipient, a source/recipient pairing and/or a direction of transmission between a source and recipient of the communication. In this regard, a single communication may have multiple such pairings. The rules may address a form and/or a content of the communication. In the latter regard, the rules may control access to or use of particular items of information to effect a policy regarding sensitive information. Such a policy may be negotiated between or otherwise agreed to by the collaborators. This policy may control access to or use of sensitive information on a recipient dependent basis, for example, by associating rule sets with particular individuals or classes of individuals. Multiple classification levels may be supported in this regard. The system may generate logs of activities concerning communications to facilitate auditing compliance with the policy. Additionally, the system may provide for automated auditing in this regard.

According to another aspect of the present invention, a utility is provided for making information available to multiple users in a collaborative environment in accordance with content-based rules specific to each of the users. For example, the utility may be used to facilitate multi-user parallel processing type collaboration while maintaining the integrity of sensitive data. The utility involves a collaboration system for enabling access to collaboration subject matter, based on input information, by multiple user systems. The collaboration subject matter may be provided by one of the user systems and/or by another source or sources. The collaboration system is operative to receive at least a portion of the collaboration subject matter and identify the user systems designated to access or use the subject matter. The user systems may be identified, for example, based on a previously established distribution list for the collaboration subject matter, address information included in a message or messages from the input source or access requests by or on behalf of the first and second user systems. The collaboration system is further operative for accessing content-based rules associated with each of the identified user systems, processing the input information based on the content-based rules, establishing multiple outputs for the multiple user systems, and enabling access to the outputs. In this manner, the multiple user systems can be used for collaborative work related to the collaboration subject matter in accordance with content-based rules.

In one implementation, the collaboration system is used to filter information disseminated to multiple recipients so as to protect sensitive data. Thus, for example, the content-based rules may be used to implement policies (e.g., established by specific users, collaboration groups or defined enclaves or established based on a relationship between a given source and recipient) regarding transmissions of sensitive information or to facilitate collaboration between users having different nationalities, security clearances, statuses (e.g., public or private sector) or authorizations relative to sensitive information. Thus, for example, the content-based rules may be associated with particular intended recipients based on the identity of that recipient or the nationality, security clearance, title, affiliation or other attribute of that recipient. The filtering may involve removing or modifying the sensitive information to comply with rules protecting the information. For example, names may be deleted or changed (e.g., genericized) to protect privacy or security concerns or sensitive data may be deleted or the accuracy of data may be changed to accommodate access limitations of particular intended recipients. By using multiple rules associated with multiple users, collaboration is facilitated even in environments where individual user access to the collaboration subject matter may be limited.

In accordance with another aspect of the present invention, a utility is provided for making information from multiple sources available to a user system in a collaborative environment in accordance with content-based rules. For example, the utility may be used to facilitate multi-source aggregation type collaboration while maintaining the integrity of sensitive data. The utility involves operating a collaboration system to receive multiple collaboration subject matter inputs from multiple source systems and identify a user system for receiving an output. The collaboration system is further operative for processing each of the inputs based on a content-based rule set associated with the identified user system and providing the user system access to one or more outputs based on the inputs and the content-based rule set.

The utility may be used in a variety of contexts. For example, in connection with a product development process involving multiple component providers and a system integrator, specification information from each of the component providers may be provided via the collaboration system to the system integrator, or to another component provider, to the extent necessary for the development process as governed by rules defined by the participants. In the contexts of law enforcement, intelligence gathering and regulatory compliance, information from private and/or public sector sources may be provided to the relevant government entity based on rules implementing privacy, civil liberties and other policies or legal safeguards. In this manner, an environment of trust is fostered which promotes collaboration. The utility may also be operative for combining or fusing multiple inputs to generate enhanced data, e.g., combining information regarding multiple instances of sightings of a person being tracked to provide improved location information.

In connection with the noted multi-user parallel processing and multi-source aggregation environments, it will be appreciated that it is desirable to maximize sharing of collaboration subject matter within the bounds of protecting sensitive information. Additionally, it is desirable to execute the content-based rules rapidly so as to enable substantially real-time collaboration. It is also desirable to execute the content-based rules consistently and objectively so as to engender trust among collaborators and thereby more fully realize the intended benefits for which the content-based rules were established. This is accomplished in accordance with the present invention through the cooperative use of certain parsing and sanitization tools.

In accordance with another aspect of the present invention, a utility is operative for recursively parsing an input to provide a desired or selectable level of parsing resolution. The associated methodology involves: establishing a module for processing an information stream, the module including a parsing engine and a processing engine; first operating the parsing engine to select a portion from said data stream (e.g., the full text of a message or a portion thereof) and define said portion as a parent object; second operating the parsing engine to parse the parent object into multiple child objects, where each child object has a child content that is a subset of a parent content of the parent; third operating the processing engine to perform a predefined process (e.g., performing a security “dirty word” screening process) on at least one of the child objects; redefining at least a second one of the child objects (the same as or different from the first one) as a parent object; and repeating the steps of second operating and third operating with respect to the redefined object.

The utility is thus operative for recursively processing the input information stream to provide a desired or selectable level of processing resolution. In this regard, the process of redefining a child object as a parent object and repeating the noted steps with respect to the redefined object may be conducted iteratively until sufficient parsing is achieved. Different portions of the input, e.g., a message, may be parsed to different resolutions if desired for a particular application. Similarly, sibling objects may undergo a different number of iterations to achieve a common parsing resolution. For example, a parsing process may be conducted on a text based document. The desired resolution for the process may be word-by-word parsing. An initial step of the process may parse the document into a number of headings and a corresponding number of sections. Each such initially parsed token, referred to below as a “MAG”, is a sibling object. The headings may be directly parsed into words whereas the text sections may require further recursive parsing into paragraphs, sentences and the like. Thus, the parsing process, by virtue of its recursive functionality, is highly adaptive to various applications and types of content.

According to a further aspect of the present invention, a machine-based utility is operative for selectively sanitizing sensitive subject matter from a message to produce a sanitized message for retransmission. That is, the utility does not merely make a binary transmit/do not transmit decision, but sanitizes messages for transmission with sensitive subject matter removed or otherwise protected. The associated method includes the steps of: establishing a computer-based sanitization tool for sanitizing messages based on pre-defined sanitization rules; operating the tool to receive a message relative to a first external system, the first message including sensitive information and clean information relative to an identified recipient; operating the computer-based sanitization tool to identify the sensitive information within the message and to sanitize the message relative to the sensitive information, thereby generating a sanitized message including the clean information; and operating the computer-based sanitization tool for transmission of the sanitized message to the identified recipient. By virtue of this utility, messages can be quickly sanitized such that the identified recipient can access the clean information.

In one implementation, the utility can access multiple rule sets to manage distribution of information relative to a variety of users. The rule sets may be based on the identity of the recipient, an affiliation or nationality of the user or other parameters. An associated sanitization process involves accessing a database including multiple rule sets, using a parameter associated with the identified recipient to select a rule set, and applying the rule set with respect to the message to sanitize the message. It will be appreciated that the utility has particular advantages with respect to systems where a goal is to enable distribution of information to multiple recipients while maintaining multiple levels of security with respect to information dissemination.

According to a related aspect of the present invention, a sanitization utility is operative for transmitting multiple versions of a given message to multiple recipients. The associated method involves: receiving a message for potential distribution; identifying at least first and second potential recipients associated with first and second policies regarding information distribution, respectively; sanitizing the input message to generate a first sanitized message for transmission to the first recipient; and sanitizing the input message to generate a second sanitized message, different than the first sanitized message, for transmission to the second potential recipient. In accordance with the present invention, a substantially unlimited number of recipients can be accommodated in this regard. The invention thus has particular advantages in contexts where fast and broad dissemination of information is critical, such as multi-lateral defense/policing or intelligence cooperation and private or public sector activities involving multiple parties.

According to a further aspect of the present invention, a sanitization utility is implemented in conjunction with a recursive parsing tool to enable high resolution analysis of messages for security purposes. In this regard, the utility is operative for receiving a message, recursively parsing the message such that the message is parsed into tokens of a desired size, applying sanitization rules with respect to the parsed tokens to identify at least one dirty token, sanitizing the message relative to the dirty token to generate a sanitized message for transmission to an identified recipient. The size of the tokens may be determined based on the sanitization rules, or may be determined based on the nature of the subject matter, processing limitation or other criteria. The utility can thus analyze messages with a high degree of resolution, if desired, such that transmission of clean information is maximized while simultaneously protecting security interests.

According to a still further aspect of the present invention, a utility is provided for selectively sanitizing information from multiple services and making the sanitized information from the multiple sources available for processing by a single processing tool. The information for each source is sanitized, relative to sensitive information, based on stored rules associated with that source. In this manner, entities that provide information can individually or cooperatively define rules for protecting sensitive information, thereby engendering trust. The information thus sanitized is made available to a single processing tool that may separately process information from each source, use information from multiple sources in an algorithm or otherwise aggregate the information from the multiple sources. For example, in the contexts of law enforcement investigation, suspected terrorist identification, or identification of potentially unauthorized financial transactions, information obtained from multiple sources potentially may be processed using an algorithm developed to identify potentially suspicious activities. In this regard, information available from multiple sources may increase the effectiveness of such tools. Conversely, by reliably protecting sensitive information based on rules trusted by information sources, the most effective tools may gain access to information that was previously unavailable to those tools. In this manner, a broad range of expertise and multidisciplinary analyses of information from multiple sources can be utilized to address problems that otherwise appear intractable. In the context of medical research, sensitive personal information may be edited from private medical records from multiple sources to comply with relevant policies and laws. In this manner, large quantities of information can be aggregated, free from privacy concerns, for improved statistical or other analyses.

In connection with collaboration systems as described above, it is useful to make resources of particular user systems available to the collaborative enterprise, e.g., those users of the collaboration system who are allowed at least some access to such resources according to rules agreed on by or otherwise established for the collaborators. As discussed below, a variety of architectures reflecting a variety of degrees of integration of the individual resources into the collaboration system are possible. The resources may include, for example, a database, database search tool or other data processing routine or application. In one implementation, this is accomplished by a computer program device including logical instructions on a computer readable medium, e.g., software, hardware and/or firmware. The logical instructions enable the associated computer to access resources having a system dependent attribute and establish an interface to the resources such that the system dependent attribute is rendered system independent. In this manner, the resources are made available for use across the network subject to rules governing interaction between the source systems. For example, the resources may include information from a source database that has a proprietary data structure or format. The logical instructions may operate to access information from the database and associate the information with XML tags or the like such that the data is self-describing. Such data can then be readily processed to execute the noted rules governing interaction of the users.

### BRIEF DESCRIPTION OF DRAWINGS

For a more complete understanding of the present invention and further advantages thereof, reference is now made to the following Detailed Description taken in conjunction with the drawings, in which:

FIG. 1 illustrates a web of relationships between users of a Radiant Trust system in accordance with the present invention;

FIG. 2A illustrates a component view of the radiant trust system of FIG. 1;

FIG. 2B illustrates a configuration overview of the Radiant Sanitizer/Guard component of the Radiant Trust system of FIG. 1;

FIG. 2C illustrates a portion of the configuration of FIG. 2B associated with a single input channel;

FIG. 3 illustrates a domain view of a network employing multiple Radiant Trust system in accordance with the present invention;

FIG. 4 illustrates enclaves of trust and hierarchies of enclaves defined in connection with the Radiant Trust system of the present invention;

FIG. 5 illustrates a cross checking thread implemented by the Radiant Trust system of the present invention in connection with an aviation safety application;

FIG. 6 illustrates a watch list update thread executed by a Radiant Trust system according to the present invention in connection with an aviation safety application;

FIG. 7 is a schematic diagram of a classified information processing and distribution system in accordance with the present invention;

FIG. 8 is a schematic diagram showing an information flow relative to a MAG module in accordance with the present invention;

FIG. 9 illustrates an input data transformation in accordance with the present invention;

FIG. 10 illustrates an output data transformation in accordance with the present invention;

FIG. 11 illustrates a high-level architecture of the MAG module of FIG. 8;

FIG. 12 illustrates a parse tree that may be executed by the MAG module of FIG. 8;

FIG. 13 is a flowchart of a Mag parse function in accordance with the present invention;

FIG. 14 is a flowchart of a Mag format function in accordance with the present invention;

FIG. 15 is a schematic diagram of an ADS module in accordance with the present invention;

FIG. 16 is a schematic diagram of an alternative implementation of an ADS module in accordance with the present invention;

FIG. 17 is a schematic diagram of a further alternative implementation of an ADS module in accordance with the present invention;

FIG. 18 illustrates the sanitization guidance system in accordance with the present invention;

FIG. 19 is a flowchart of an image message process in accordance with the present invention;

FIG. 20 is a flowchart illustrating a process for development of rules for rule-based sanitization;

FIG. 21 is a flow chart of the collaborative environment;

FIG. 22 is an overview of how clients participate with a document;

FIG. 23 is a flow chart illustrating how a client interacts with data on a document;

FIG. 24 illustrates the collaboration process on multiple views;

FIG. 25 is a flow chart illustrating flexibility and collaboration;

FIG. 26 is a pictorial summation of how a client accesses information;

FIG. 27 is a flow chart of the architectural strategy;

FIG. 28 is a flow chart of the services based architecture;

FIG. 29 is a flow chart of the system to extend the infrastructure;

FIG. 30 is a flow chart of minimum level integration with legacy systems;

FIG. 31 is a flow chart of mid-level integration with legacy systems;

FIG. 32 is a flow chart of full integration with legacy systems;

FIG. 33 is a chart summarizing the importance of having a data-centric collaboration network;

FIG. 34 is a first chart illustrating collaboration application management;

FIG. 35 is a second chart illustrating collaboration application management;

FIG. 36 is a flow chart of the repository query and document management;

FIG. 37 is a map and white-board interaction;

FIG. 38 illustrates the function of the extended properties editor;

FIG. 39 illustrates the output from an X-Y plotter;

FIG. 40 illustrates the output in a list viewer;

FIG. 41 illustrates the chat tool capability;

FIG. 42 is a flow chart illustrating the performance metrics;

FIG. 43 illustrates the high level interaction between various information access service (IAS) components in accordance with the USGIS;

FIGS. 44-46 illustrate the lower level interaction between IAS components;

FIGS. 47-51 illustrate the inheritance structure of the various IAS components illustrated in FIGS. 43-46 is illustrated in FIGS. 47-51;

FIG. 52 illustrates the data channel services framework;

FIG. 53 illustrates the versioning of data changes in the data channel;

FIG. 54 illustrates the components that make up a “feature collection”;

FIGS. 55-56 illustrate the directed a-cyclic graph data structure format.

### DETAILED DESCRIPTION

In the following description, the invention is described in the context of a transliteration, sanitization and collaboration system, denoted the Radiant Trust System, for promoting collaboration among various users in relation to various homeland security and defense applications such as potential terrorist tracking, pre-flight passenger screening and border security and multilateral policing activities. Although these represent particularly advantageous application of the present invention, as noted above, the invention is applicable in a variety of contexts including private sector applications, public sector applications and public/private sector applications. Accordingly, the various aspects of the present invention are not limited to the context described in detail below.

The description below begins with an overview of the Radiant Trust System describing the system architecture and network environments. Thereafter, the Radiant Sanitizer Guard subsystem is described in more detail. The final section below includes a detailed description of the Radiant Collaboration subsystem.

### I. Overview of the Radiant Trust System

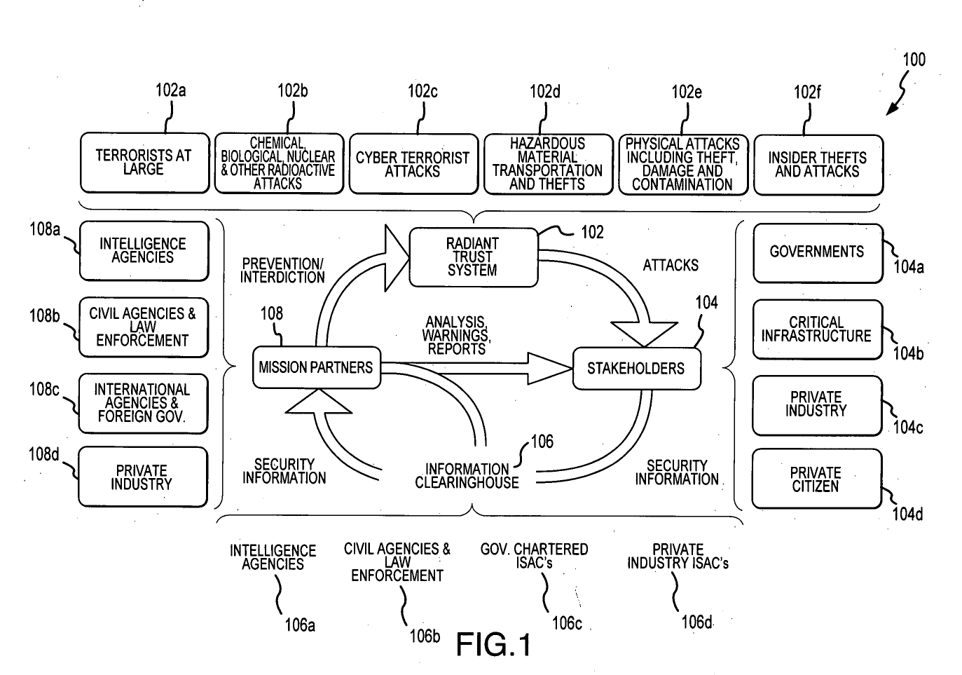

FIG. 1 illustrates a cycle 100 of relationships, stakeholders and participants of the Radiant Trust System of the present invention. One of the goals of the Radiant Trust System is to create an environment of trust among users. With regard to information sources, this environment of trust is fostered by protecting sensitive information and respecting privacy and other civil liberties issues. The trust that is thus earned encourages sharing of information so that system partners can have more complete information and perform better analyses of the data. Based on these analyses, more useful warnings can be provided to system users and others, which further encourages sharing of information.

The cyclical nature of this process is illustrated in FIG. 1. The risks 102 addressed in the illustrated implementation of the Radiant Trust System include: terrorists at large 102a; chemical, biological, nuclear and other radioactive attacks 102b; cyber terrorist attacks 102c; hazardous material transportation and thefts 102d; physical attacks including theft, damage and contamination 102e; and insider thefts and attacks 102f. These risks 102 pose a threat of attacks on stakeholders 104. The stakeholders in the illustrated implementation of the Radiant Trust System may include governments 104a, critical infrastructure 104b, private industry 104c and private citizens 104d. These stakeholders 104 may possess a variety of information that is relevant to analyzing the risks 102. Such information may include information about attacks and attempted attacks, as well as information which, considered individually, may not necessarily indicate a risk. For example, travel industry database records indicating that John Doe and Jane Doe plan to be on a particular flight may not indicate a risk until that information is correlated with a suspected terrorist watch list of a government intelligence agency identifying both John Doe and Jane Doe as suspected terrorists. It will be appreciated that the types of information that may be useful in such analyses are as varied as the types of analyses that may be devised and would be expected to evolve with experience. The Radiant Trust System is designed to accommodate such flexibility and, indeed, to promote use of information sources whose efficacy may not previously have been fully explored. It is important to note in this regard that the Radiant Trust System addresses a number of issues which have previously hampered coordination among different government agencies, potentially competitive private entities, and among public and private sector entities.

Such information is provided by the stakeholders 104 to one or more trusted information clearinghouses 106. These information clearinghouses implement the Radiant Trust functionality governing sharing of information while protecting sensitive information and addressing privacy and other civil liberties issues. In the illustrated implementation, such systems are operated by intelligence agencies 106a, civil agencies and law enforcement agencies 106b, government chartered ISACs 106c and private industry ISACs 106d. As will be discussed in more detail below, in certain implementations, information passing from, for example, a private industry source to a government recipient may pass through a first clearinghouse operated by a private sector entity and a second clearinghouse operated by a government entity. The information clearinghouse may also perform a number of functions related to transliterating data formats and otherwise ensuring technical compatibility as well as providing certain data processing and collaboration functionality. The resulting information, which may be sanitized relative to sensitive information and reformatted, is made available to mission partners 108. In this regard, such information may be made available on a continuous or regular basis in response to standing queries or content-based rules governing distribution, or such information may be provided in response to a specific inquiry from a mission partner 108.

In the illustrated implementation, the mission partners include intelligence agencies 108a, civil agencies and law enforcement agencies 108b, international agencies and foreign governments 108c and private industry partners 108d. These mission partners 108 may perform a variety of different analyses and provide a variety of different outputs. Indeed, it is a goal of the Radiant Trust System 100 to encourage creativity in this regard. As illustrated, one result of these analyses may be prevention and interdiction efforts to directly reduce or eliminate the risks 102. Additionally, the mission partners 108 may provide analysis, warnings and reports to the stakeholders 104. For example, analysis may be provided with respect to a reported cyber attack, providing some information about the methodology employed by the cyber terrorist. This information may be used by a stakeholder to patch firewalls or otherwise address network security. Warnings of potential terrorist activity may be provided to local governments or frontline private industry entities such as airlines. Reports based on security information may be provided to stakeholders 104 to keep the stakeholders better informed and/or to help stakeholders evaluate risks.

Similar information may be provided by the mission partners 108 to the information clearinghouse 106. For example, such information may be reported to the information clearinghouse 106 to be relayed to stakeholders where the relevant stakeholders are not known to the mission partners due to privacy concerns. In addition, such information may encompass enhanced security information determined through data fusion or other processing which may be of interest to other mission partners 108. It will thus be appreciated that the system 100 feeds on itself such that, even in the context of a closed system with respect to the participants involved, ever-increasing degrees of information sharing and processing are achieved. As will be discussed below, it is anticipated that such systems generally will not be closed. In fact, it is expected that as trust is gained and benefits are demonstrated, systems will be interlinked to create a radiating web of trust transcending national and public/private sector boundaries.

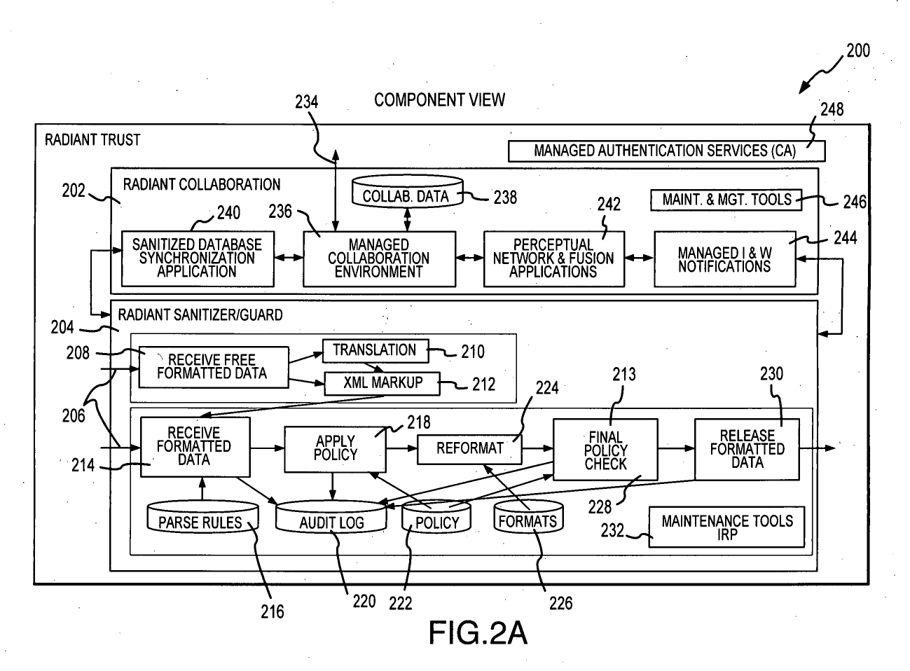

FIG. 2A illustrates a component view of the Radiant Trust System 200. As shown, the system 200 generally includes a radiant collaboration subsystem 202 and the radiant sanitizer/guard subsystem 204. Each of these subsystems is described in more detail in its own section later in this description. The radiant sanitizer guard 204, as shown in FIG. 2, receives input information 206 that may include formatted and free formatted data. In this regard, the formatted data is data that is already formatted in the desired internal format of the Radiant Trust System 200. The free formatted data may be formatted in accordance with the legacy system of the associated source. One of the strengths of the Radiant Trust System 200 is the ability to handle a variety of formats such that information from a greater variety of sources can be made available. In this regard, such free formatted data may be received by an input module 208. As will be described in more detail below, this free formatted data may then be translated or transliterated into an internal format by a translation module 210 and associated with XML tags and otherwise processed by XML markup module 212. The resulting formatted data is then provided to the formatted data input module 214 where it is processed in the same manner as preformatted data.

The input module 214 constitutes the input port of sanitizer 213. The sanitizer 213 implements an automated process for protecting sensitive information included in the inputs. In this regard, the inputs are automatically processed to execute content-based rules related to specific information sources and intended recipients. In particular, participants in the Radiant Trust System may develop rules determining what information can be shared with whom. The nature of these rules and the manner of executing the rules will be discussed in more detail below. It should be noted, however, that is desired to prevent the unauthorized dissemination of sensitive information while making as much information as possible available for use in the Radiant Trust System and to external users. This is accomplished by parsing the input information into information objects, using MAGs of the desired size or resolution and applying the content-based rules with regard to each information object. Each information object can selectively be deleted, modified, or passed into the output stream. Thus, in the illustrated implementation, parse rule database 216 stores the rules for governing the process by which the input information is parsed into MAGS. The policy processor 218 then applies the content-based rules which are stored in the policy database 222 to construct a recipient-specific output in compliance with the predefined content-based rules. This output is provided to a reformatting processor 224 that reformats the data in a form for use by the intended recipient system. Information defining these formats is stored in tables of the format database 226. A final check module 228 performs a final check on the output to assure compliance with the policies indicated by the content-based rules and the resulting output is provided to an output module 230 for transmission to the intended recipient system or systems.

The sanitizer 213 also includes an audit log 220 and maintenance tools 232. The audit log database 220 is interfaced with the modules 214, 218, 228 and 230 to compile complete records identifying the inputs received, the modifications made to the inputs to implement the content-based rules and the output transmitted by the sanitizer 213 together with information identifying the information sources and the recipients. In this manner, users can verify that information has been disseminated only in accordance with the predefined rules, thereby further encouraging trust. These logs can be reviewed, e.g., in the form of a hardcopy report, by an official, collaborator or trusted third party to audit policy compliance. Moreover, such compliance auditing may be performed automatically by the System 200 on a periodic or random basis. In addition, information transmissions can be checked when appropriate to provide evidence of and address any misuse of information. The maintenance tools 232 provide the functionality necessary to update, repair and otherwise maintain the radiant sanitizer/guard subsystem 204. In this regard, it will be appreciated that reliable operation of the system 200 is essential to achieving the goals of the system 200.

The radiant sanitizer/guard subsystem 204 thus, of itself, enables substantially real-time sharing of information between multiple sources within the network and multiple recipients within the network in accordance with predefined rules governing such exchanges of information based on content and the identities of the sources and recipients. This represents a significant step toward achieving the goals of the system 200. However, in some cases, it may be desired to enable collaborative work on particular documents or subject matter as between multiple system participants. This is facilitated by the radiant collaboration subsystem 202. In particular, the subsystem 202 allows for establishing a conference of collaborators, identifying a document or documents to be included in the conference, allowing such documents as well as changes to such documents resulting from the collaboration process to be represented to individual collaborators in accordance with the content-based rules as well as system-specific parameters related to display and the like, and allowing for processing of information contained in the documents using tools common to the conference or system 200.

Specifically, the environment manager module 236 receives inputs 234 defining the managed collaboration environment. These inputs may define, for example, the participants in the conference, the documents that are to be the subject of collaboration, and certain parameters of the participant systems. The documents or the other subject matter of collaboration may be stored in the collaboration database 238.

Representations of the collaboration data are provided to each of the conference participants via the interface 234 to enable collaboration. In order for such outputs to conference participants to be managed in accordance with the content-based rules, the radiant collaboration subsystem 202 is interfaced with the radiant sanitizer/guard system 204. This interface is managed by the sanitized database synchronization application 240. In particular, this application 240 handles all operations necessary to provide formatted or free formatted data to input ports 208 or 214 and receive sanitized data from the output port 230. These operations include identifying the conference participants to the sanitizer 213 and associating the multiple outputs with the intended conference participants. These sanitized outputs are provided by the application 240 to the environment manager 236 which manages output of the information in accordance with particular participant system parameters to the participants via the interface 234. In this regard, the environment manager 236 may invoke certain applications 242 so as to make certain processing tools available to all conference participants and associate visualization and control properties with the data so that the data becomes self-describing. Such association of visualization and control properties with the data may be performed by a perceptual network application.

An example of tools that may be made available to the conference includes fusion applications for aggregating data from multiple sources so as to generate enhanced data. The radiant collaboration subsystem 202 further includes a notification manager module 244 for issuing notifications of interest to participants of system 200 based on the results of the collaboration effort. For example, where the conference participants collaboratively identify a risk of terrorism, appropriate notifications may be made available to system users via the radiant sanitizer/guard subsystem 204. Maintenance and management tools 246 are also provided as part of the subsystem 202 to update and repair the subsystem 202 for increased reliability. It will be appreciated that the Radiant Trust System 200 may further make use of managed authentication services 248 for authenticating system users.

FIG. 2B illustrates a processing configuration 250 of the Radiant Trust Sanitizer/Guard subsystem. In the illustrated configuration, the sanitizer receives inputs via multiple input channels 252. Screens 254 are provided for each input channel to perform a variety of different input channel-specific functions such as verifying access authorization, reformatting, and parsing the input information to the desired resolution. Instantiations of the input information may be also be generated for each addressee of the information. Processor 256 then performs addressee specific processing including processing based on addressee profiles. Output guards 258 are provided for each addressee and channel to ensure against improper information dissemination, e.g., provision of classified information to channels or individuals not having sufficient clearance levels. The information is then output via the multiple output channels 260. As shown, the configuration can very greatly, depending on the number of addressees associated with each input channel and the number of output channels associated with each input channel. Although not illustrated in FIG. 2B, it will be appreciated that information from different input channels 252 may be directed to a single output channel 260.

The processing components associated with a single input channel system 262 are shown in more detail in FIG. 2C. In particular, an input received on a first channel 264 is first processed by a parser 266 to parse the input to the desired parsing resolution and the parsed input is then stored in work queue 268. Channel-specific input screens 270 then filter the input and perform a number of other channel-specific tasks. Processors 272 then apply the addressee profiles including filters, tasks, and reclassification of information, e.g., where the input information has been modified to reduce its classification status. The guard 274 then implements addressee specific and channel-specific guard functions and the resulting information is output to the channels 276.

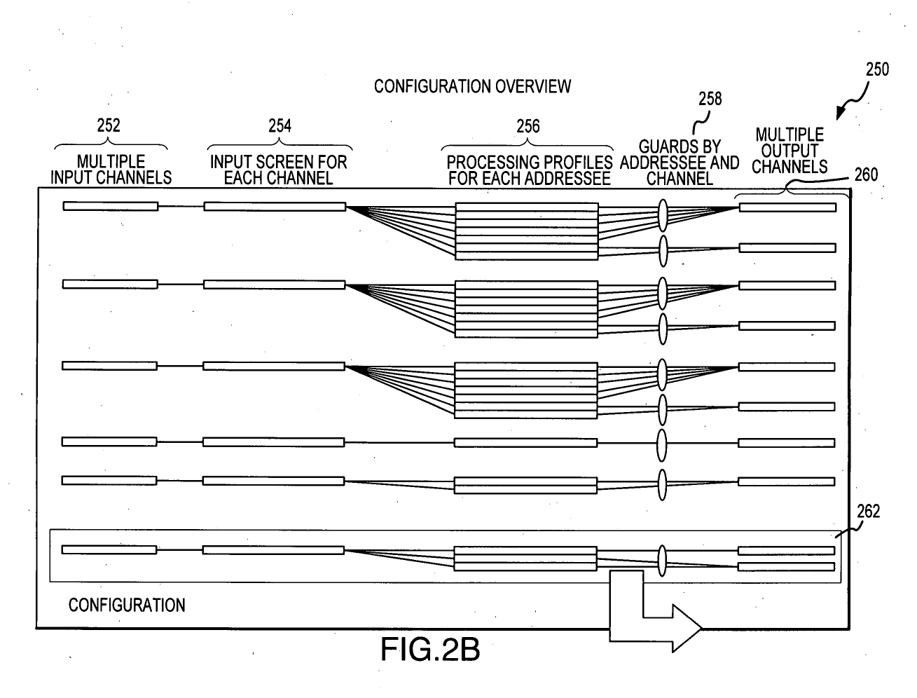

As noted above, multiple Radiant Trust Systems may be utilized within a network to implement a hierarchy of policies or peer policies relating to exchange of information across user domains. This is illustrated by the network 300 of FIG. 3. That network 300 includes a first Radiant Trust System 302 and a second Radiant Trust System 304. For example, the first Radiant Trust System 302 may be operated by a private sector entity and may be operative for managing exchanges of information as between private sector domains such as domain three 306 and domain four 308. The second Radiant Trust System 304 may be operated by a public sector entity and may be operative for managing exchanges of information as between public entity domains such as domain one 310 and domain two 312. Each of the Radiant Trust Systems 302 and 304 may be fully operative as discussed above to manage exchanges of information and allow for collaboration as between its associated domains. In this regard, each system 302 or 304 may execute its own domain policies regarding exchanges of information, continuously audit exchanges of information and provide various services as described above.

Additionally, the first Radiant Trust System 302 may be interfaced with the second Radiant Trust System 304 so as to enable exchanges of information therebetween. Thus, for example, information regarding a cyber attack may be provided by the private sector participant of domain three 306, e.g., an internet service provider, to a government sector participant of domain two 312 such as an intelligence agency. The information from domain three 306 may be processed by the first Radiant Trust System 302 to execute a content-based rule requiring that the name of the domain three user be replaced by a generic designation such as “Internet Service Provider” in the context of a public sector recipient or based on identification of the specific recipient of domain two 312. An output from the first Radiant Trust System 302 is then provided to the second Radiant Trust System 304. The second system 304 may output the information to domain two 312 and/or make the information available for use in a conference involving domains one and two 310, 312. As a result of processing within domain two 312 or in conjunction with a collaborative conference, it may be desired to issue a warning or report to the user of domain three 306 or to a number of system users such as the users of domains three and four 306, 308. For example, a report may be generated by the user of domain two 312 which is forwarded to the user of domain three 306 via the first and second Radiant Trust Systems 302 and 304. In this manner, the public sector user of domain two 312 gains access to information regarding a cyber attack which might not have been made available outside of the trusted environment created by the Radiant Trust Systems 302 and 304. The user of domain three 306 receives useful analysis and feedback regarding the cyber attack. Moreover, the user of domain three 306 may be comforted in the knowledge that its identity never left the private sector environment defined by the first Radiant Trust System 302 and its associated domains 306 and 308. In this manner, numerous enclaves of trust may be defined.

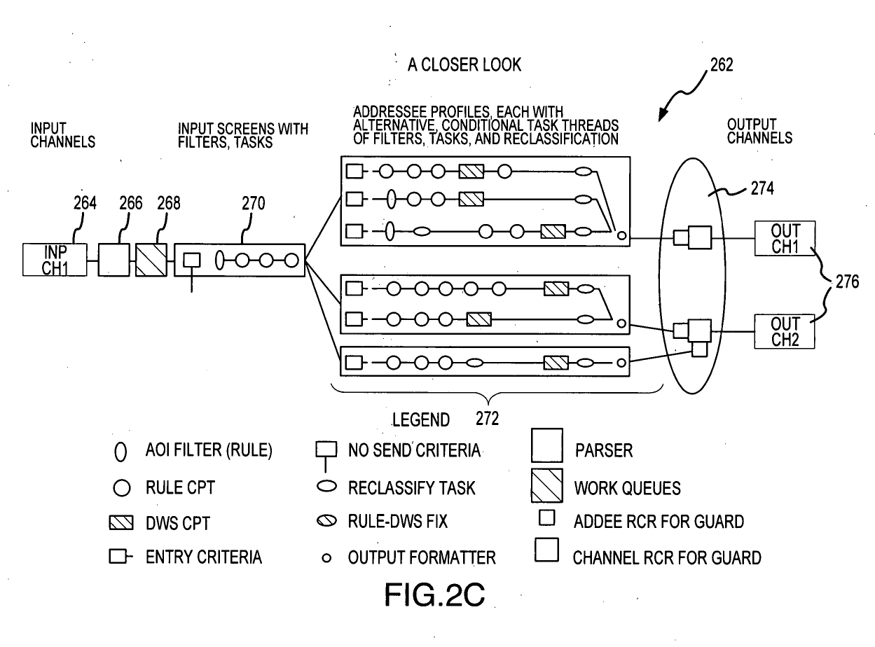

These enclaves may be arranged in peer groups, hierarchies of peer groups, peer hierarchies, and hierarchies of hierarchies, as illustrated in FIG. 4. The illustrated network 400 includes a first hierarchy 402 of enclaves 402a-e, a second hierarchy 404 of enclaves 404a-c, a third hierarchy 406 of enclaves 406a-c and an independent emergency services enclave 408. Each of these enclaves 402a-e, 404a-c, 406a-c and 408 is depicted in FIG. 4 as a ring of peer entities centered about a Radiant Trust System. Hierarchy 402 includes a private industry enclave 402a, a law enforcement enclave 402b, an intelligence enclave 402c, a counter-terrorism enclave 402d and a homeland security enclave 402e. Hierarchy 404 includes a local enclave 404a, a state enclave 404b and a federal enclave 404c. Hierarchy 406 includes a private industry enclave 406a, an ISAC enclave 406b and an infrastructure protection enclave 406c. This hierarchy may also include an optional international enclave.

It will be appreciated that the illustrated hierarchies do not necessarily denote a particular sequencing or importance of the functions performed by the associated Radiant Trust Systems. For example, in the case of hierarchy 402, the hierarchical structure does not suggest a one way flow of information from the private industry enclave 402a to the homeland security enclave 402e. Although such hierarchical rules may be built into a hierarchy, for example, by agreement of the participants, the illustrated hierarchies merely provide a convenient conceptual framework. Additionally, the illustrated hierarchies are not intended to limit the types of relationships that may be defined between the participants. Thus, for example, within the hierarchy 406, sub-hierarchies may be defined. For example, a banking ISAC or telecom ISAC of enclave 406b may be associated with particular private industry participants of enclave 406a.

Moreover, it should be appreciated that the illustrated proliferation of Radiant Trust Systems do not necessarily entail a directly corresponding proliferation of computing platforms. In this regard, the functionality of a given system may be distributed over multiple platforms and functionality of different systems may be performed over a common platform. As illustrated in FIG. 4, the Radiant Trust network 400 flexibly allows for exchanges of information within an enclave, between enclaves, between hierarchies, or between a hierarchy and an enclave. Such exchanges of information generally involve at least one Radiant Trust System but do not necessarily require a predefined sequence of Radiant Trust Systems associated with a particular hierarchy.

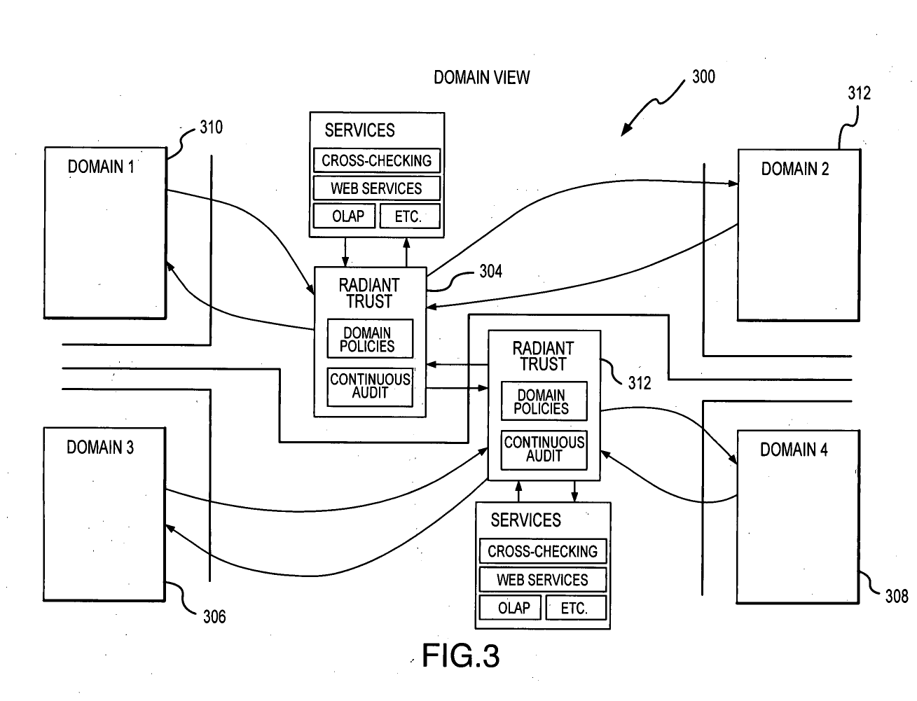

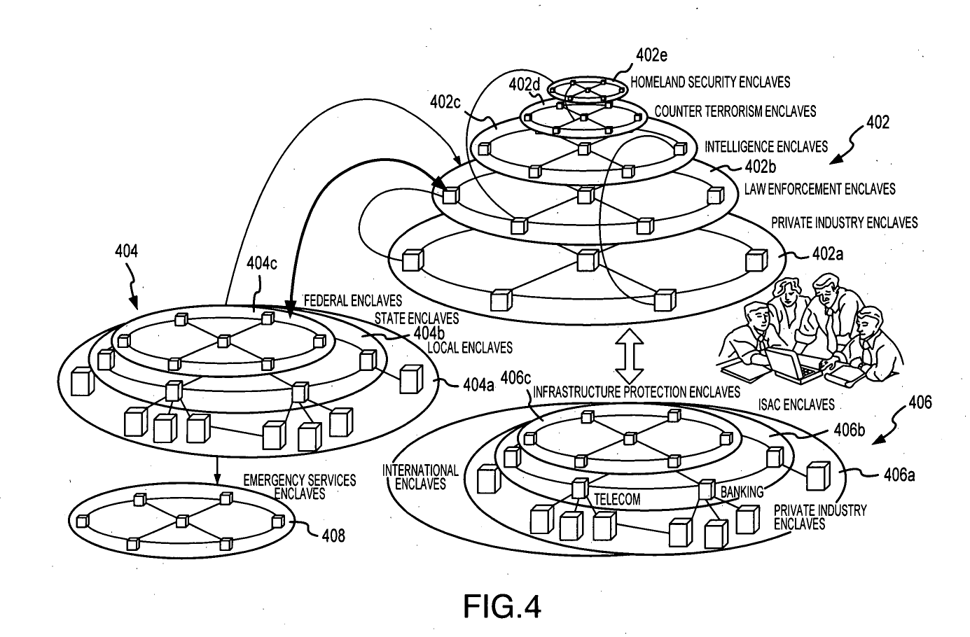

FIGS. 5 and 6 depict certain processing threads implemented using the Radiant Trust System in the context of an aviation safety application. In particular, FIG. 5 illustrates a cross-checking thread 500 that may be used to cross-check an airline reservation system record against an intelligence agency terrorist watch list. FIG. 6 illustrates an update thread that can be used to update a terrorist watch list. Referring first to FIG. 5, an industry Radiant Trust System 502 receives an input from an airline industry reservation system 504. In this case, the input is a passenger record including at least the passenger name and flight information. The industry Radiant Trust System 502 in the illustrated implementation is operated by an industry-based entity. As noted above, this system 502 is operative to handle varying input formats and to protect any sensitive information.

The first Radiant Trust System 502 forwards information including at least a passenger name to a cross-checking application 506 which checks the passenger name against an existing terrorist watch list. The application 506 responds to the industry Radiant Trust System 502 with information including at least the passenger name and an indication that the cross-check resulted in a match or did not result in a match. In the case of a match, the industry Radiant Trust System 502 may forward an alert to a second Radiant Trust System 508, e.g., operated by a government entity. Alerts may also be forwarded to peers in the aviation industry. In this regard, sensitive information may be deleted or modified to address civil liberties concerns or competitive concerns. The government Radiant Trust System 508 distributes the alert to identified alert recipients 510. Such recipients may include law enforcement officials, intelligence agencies and foreign intelligence agencies or governments.

FIG. 6 illustrates a thread 600 by which the cross-checking application 506 may be compiled and updated. As shown, the watch list information may come from a variety of sources including various intelligence agencies, law enforcement agencies and foreign sources. This information is provided to the government Radiant Trust System 508 which logs and validates the information, aggregates the information and generates a sanitized consolidated watch list. This watch list is provided to the industry Radiant Trust System 502 which, in turn, forwards the information to the cross-checking application 506. As shown, the government Radiant Trust System 508 may be operative to disseminate the consolidated list back to the individual sources in raw or sanitized form, depending on the associated policy rules.

### II. Radiant Sanitizer/Guard

As noted above, the Radiant Trust System includes a Radiant Sanitizer/Guard subsystem and a Radiant Collaborative subsystem. The Radiant Sanitizer/Guard subsystem is described in more detail in this section and the Radiant Collaborative subsystem is described in the following section.

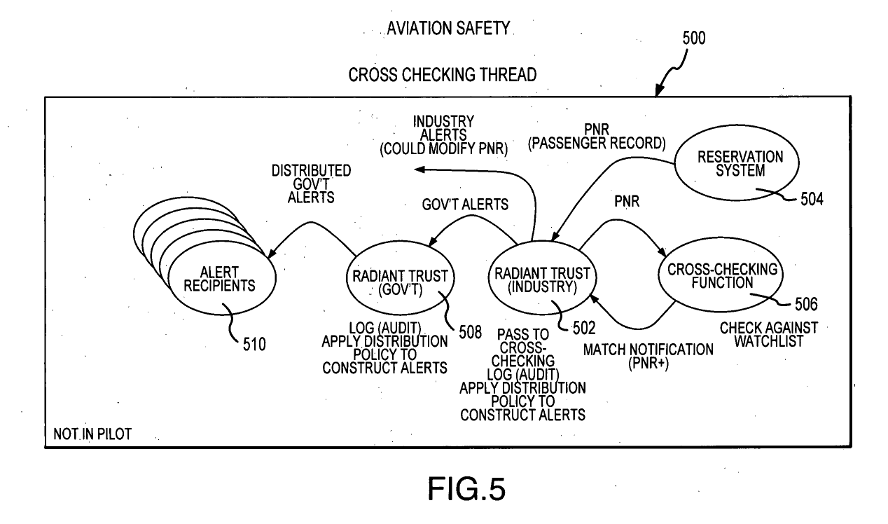

FIG. 7 is a schematic diagram providing an overview of a sanitizer/guard subsystem that may be incorporated into a Radiant Trust system as described above. In this case, the subsystem is illustrated in connection with an application for handling classified information as may be required in various defense contexts. As shown, multiple input sources 702 provide information to the system 700 at various levels of classification. In the illustrated example, these classifications include “secret” and “top secret”, as well as sensitive compartmented information (SCI). This information is reported over various communication channels 706, 708 and 710 and in different message formats, in this case designated formats A-D. The system 700 sanitizes that data to the classification levels required for dissemination over lower level channels 712 and 714 to addressees 704, at least some of whom do not have clearance sufficient to receive all of the input information, i.e., addressees who are only authorized to see sanitized versions of the data. In the illustrated case, the output channels 712 and 714 are associated with classification levels “Secret” and “Secret Rel NATO.” The system 700 accommodates different addressee consumers by reporting data in formats they understand or can process, which may or may not be the same as the original reported format. In the illustrated embodiment, the output channels 712 and 714 are shown as handling data in formats C and E, i.e., one of which (C) overlaps the input formats and one of which (E) does not.

The system 700 supplements or replaces conventional manual sanitizer terminals previously used in such applications and provides a standard intelligence data communications interface. The system 700 implements sufficiently trusted software and hardware within a system concept that removes the human interaction required by manual sanitization. This accelerates delivery of time sensitive information, since human intervention is not required for each message release. It also increases the level of trust, since a computer can be relied upon to perform repeatedly the same tasks in exactly the same way, unaffected by the type of performance distractions to which a human operator may be subject.

Application of the “need-to-know” doctrine within the compartmented security system of the United States means that various users are to receive only selected subsets of the information and products produced by the intelligence community. Gatherers of this intelligence information and creators of the intelligence product initially are responsible for determining the security level of their output. Systems which subsequently distribute and further process this information, including the illustrated system 700, are responsible for insuring that the integrity of the security classifications are maintained.

The classification of a message such as an individual contact report is defined by the sensitivity of the information in the data fields within the report format. It is possible to modify (e.g., change or delete) the information in specific fields within the contact report to reduce the overall classification of the message information and so give the message a broader releaseability. In the past, this action required determination by an operator/analyst to insure that product dissemination did not compromise higher-level accesses or compartments. This added processing delay time to contact data which is often time-critical to the final tactical user, e.g., the Command and Control tactical decision-maker or the Over-the-Horizon weapon system.

In some cases, the nature of the data and message formats used for data distribution permit the system 700 to insure that sanitization, downgrading or screening is properly accomplished quickly. This is especially true in the following cases: where message formats are well-defined and controlled and contain free text fields; where these free text fields may be simply eliminated from the resultant outgoing product; and where the rules governing information classification and the formatted data fields are well defined and understood.

The illustrated system 700 generally includes an Automatic Data Sanitizer (ADS) module 716 and a Message Analysis and Generation (MAG) module 710. These modules encompass functionality similar to that of various components described above, and provide certain functionality specific to the classification screening context. The ADS module 716 provides the automated means by which formatted multi-level classified data, including SCI, is sanitized and rapidly disseminated at different classification levels. The module 716, in cooperation with the MAG module 718, accepts classified data from designated communications channels, sanitizes and then reclassifies the data according to user-designated rules, and verifies that the data meets a set of precisely defined and rigorously controlled criteria for release. The ADS module 716 releases the information at a different level of classification or compartmentation, typically at the general service (GENSER) level. The system 700 disseminates the information only to users cleared for that level of classification and/or compartmentation. It does not disclose or release data to unauthorized consumers.

The MAG module 718 addresses issues relating to accommodating different data formats. As noted above, the various external systems that define the input sources and output addressees/consumers of classified information are characterized by a proliferation of data transmission formats. The MAG module 718 generally performs two transformation functions in this regard. First, the module 718 transforms input data from the various external formats into the internal data representation of the ADS module 716. Then, the MAG module 718 receives sanitized information from the ADS module in the internal representation and transforms such information into the various external formats of the addressee systems. It will thus be appreciated that the MAG module 718 is capable of handling a variety of external formats. As will be described in more detail below, the MAG module 718 is a table driven subsystem that can access multiple external format specifications stored in a table structure so as to implement these transformation functions without undue delay.

The following description is generally divided into two subsections. First, the various interface functions as implemented by the MAG module 118 are described. These functions include the parsing of input data and formatting of output data. Next, the following description includes a detailed discussion of the various sanitization related functions implemented by the ADS module 116.

A. The MAG Module

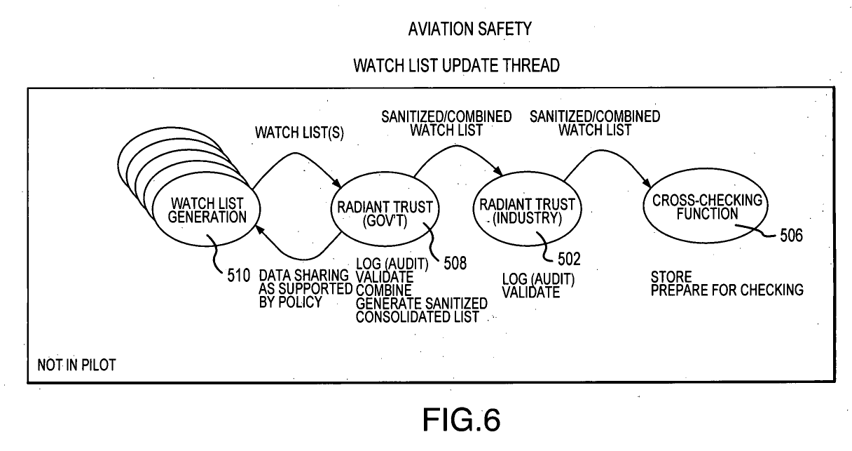

FIGS. 8-14 illustrate the various structures and processes of the MAG module. Although the MAG module is described for use in connection with the sanitization and distribution of classified information and has particular advantages in this regard, it will be appreciated that various aspects of the MAG module are useful in other contexts in connection with other applications. In this regard, many applications need to parse and format message data. These functions are generally transformations between external and internal (application-specific) representations of information. The MAG module provides a simply invoked and powerful utility for both transformations.

FIG. 8 provides a schematic diagram of the MAG module functionality. In the illustrated example, the MAG module 802 is incorporated into and may be called by a processing system 800 such as the classified information processing and distribution system of FIG. 7. The system 800 receives messages 804 in any of multiple external formats. The module 802 receives an input 206 based on the received message 804 and processes the input 806 to provide a transformed input 808 reflecting an application-specific data representation. The processed input 808 is then further processed by the system 800 to generate an output 810, again reflecting an application-specific data representation. This output 810 is then processed by the MAG module 802 to generate a processed output 812 reflecting an external format of an identified addressee system. The system 800 then provides e.g., transmits or otherwise makes available for transmission an output message 814 based on the processed output 812.

As will be discussed in more detail below, the MAG module 802 is recursively invoked and is driven by format specifications. Such recursive invocation enables the module 802 to provide a selectable parsing resolution to address specific parsing processes. In this regard, the utility can parse entire messages, data sets within a message, data items within a data set and sub-items within a data item. The data can thus be analyzed in a tailored fashion as precisely as the calling application requires. The module 802 can thereby implement single instances of various message processing functions (e.g., extraction, content validation, checks and validation) at each such level of a message. All of this functionality is based on a platform and application independent library enabling reuse of the MAG module 802 in a variety of computing environments. Moreover, the common form of the internal representation of data used by the module 802 simplifies message translation.

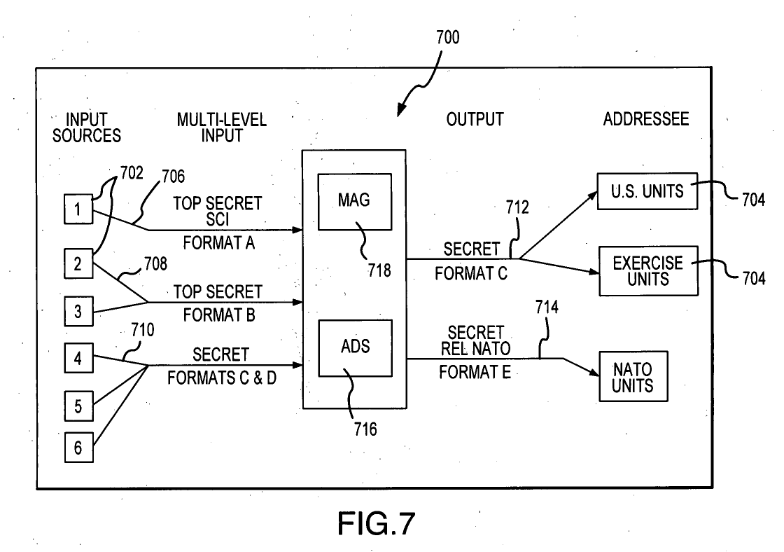

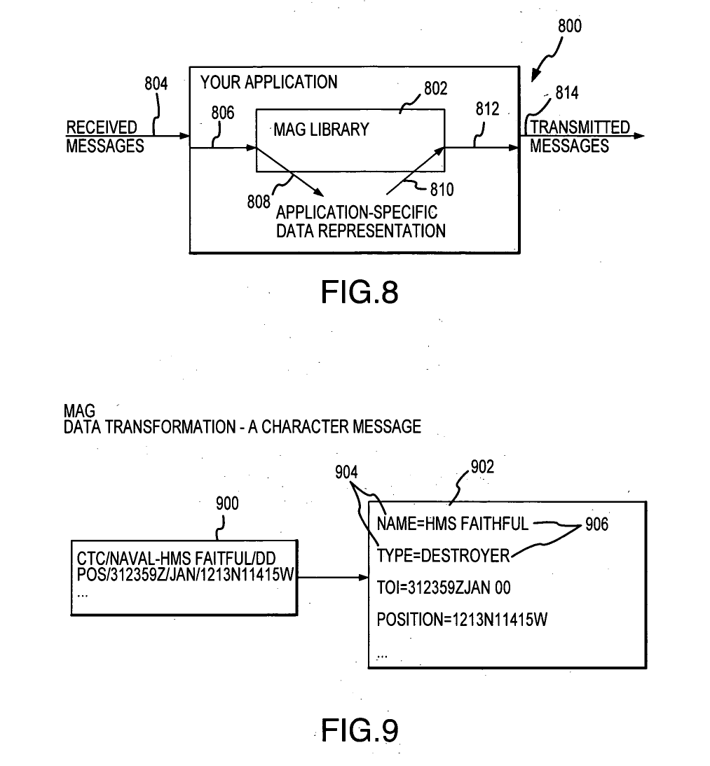

As noted above, the illustrated MAG functions entail two separate data transformations. The module 802 can handle various messaging formats including character-oriented (ASCII) and bit-oriented (binary) messages. The transformation processes that are possible are as varied as the permutations of different source and addressee formats. FIGS. 9 and 10 schematically illustrate character and binary message transformations respectively. Specifically, these FIGS. illustrate an exemplary information flow through a sanitization system incorporating the MAG module 802 where input text is received in a character-based input format and sanitized data is output in bit-based format.

Referring first to FIG. 9, box 900 illustrates a formatted character-based message input. The input 900 includes a number of data fields from which useful data can be extracted. The process for extracting such data involves accessing a format specification, using the format specification to parse the message into its various fields and reading the information from the various fields. Box 902 illustrates an internal data representation that can be understood by the calling application. In this case, the internal representation 902 includes a number of tags 904 identifying the data fields together with content 906 associated with each such tag. FIG. 9 thus illustrates an input transformation process from an external format to an internal data representation.

FIG. 10 illustrates an output transformation. Box 1000 represents an internal data representation. The content of this message may be the same or different than the input message. In the illustrated example, the message 1000 is a sanitized message (at least the Time of Intercept—TOI—field has been eliminated from the input message as shown in FIG. 9). In the illustrated example, the message 1000 is transformed to a binary message output 1002. The binary message 1002 includes all of the data for message 1000 organized in a format that will be understood by an identified addressee system. Again, this transformation is performed based on a format specification defining the corresponding external format.

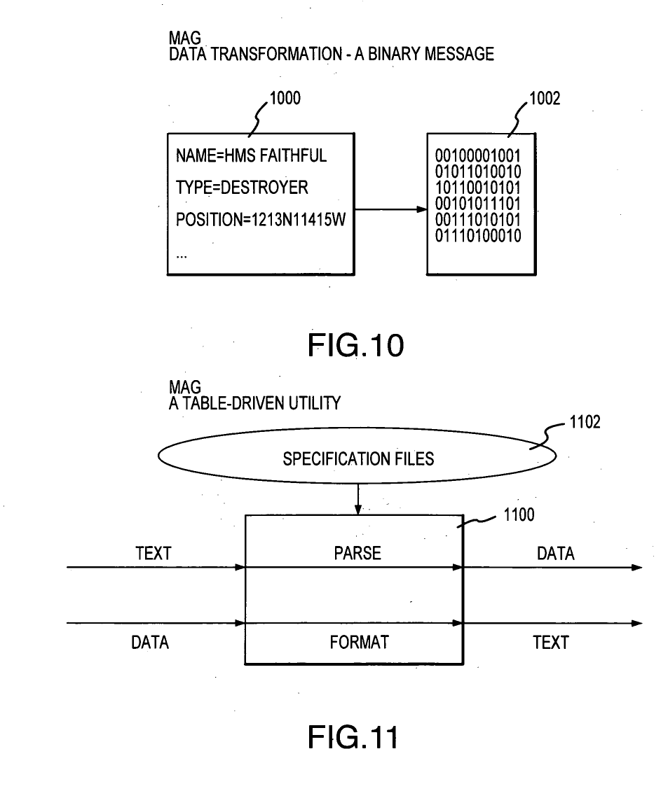

The MAG module thus provides a message disassembly and reassembly engine. A preferred architecture for such a module 1100 is generally illustrated in FIG. 11. As shown, the module 1100 is configurable for different transformation processes by accessing stored specification files 1102. The specification files 1102 may be stored in format-specific tables, e.g., in a relational database where each table includes a format specification and an identifier or link for that format. Details of the various formats thus reside outside of the executable software of the module 1100 and outside of the calling application. When the module 1100 is required to process a new message format (input or output format) software modifications are generally not required. Rather, a new format specification can simply be added to the specifications files 1102. Similarly, when an existing message format changes, or a source system breaks predefined rules, it is generally unnecessary to rewrite software. Such issues can generally be addressed by modifying a file of the specification files 1102.

The formats and associated specifications may be standard or custom formats. Examples of formats that may be supported by the module 1100 include OTHT—Gold, OILSTOCK, KLIEGLIGHT, TACELINT, TACREP, TIBS binary, ENSCORE—ELD, NITF, SENSOREP, SAR, TRE Tabular, various inter-database formats and numerous specialized formats. The module 1100 can process and transliterate on a line-by-line or similar basis relative to such formats. Simple user interfaces may be provided for selecting and defining formats to be supported for a particular application, as set forth in U.S. Provisional Patent Application Serial No. 60/215,114.

The specifications are thus external to the compiled software. As a result, it is unnecessary to recompile software each time processing formats change. The specifications are also generally hierarchical. That is, the specifications may be defined relative to an overall message, a data group, a data item, and data sub-items. Accordingly, as will be discussed below, the module 1100 can implement a substantially unlimited depth of resolution and text analysis. Moreover, many of the attributes of the specifications are inheritable. That is, many specifications evolve from a common lineage. For example, two specifications may have evolved from a common parent. In such cases, many of the specifications' attributes can be inherited from the parent, thus simplifying specification definition and reducing the required storage space. Similarly, many of the attributes of the various specifications are reusable. For example, it is generally unnecessary to respecify the known months of the year each time a message references one.

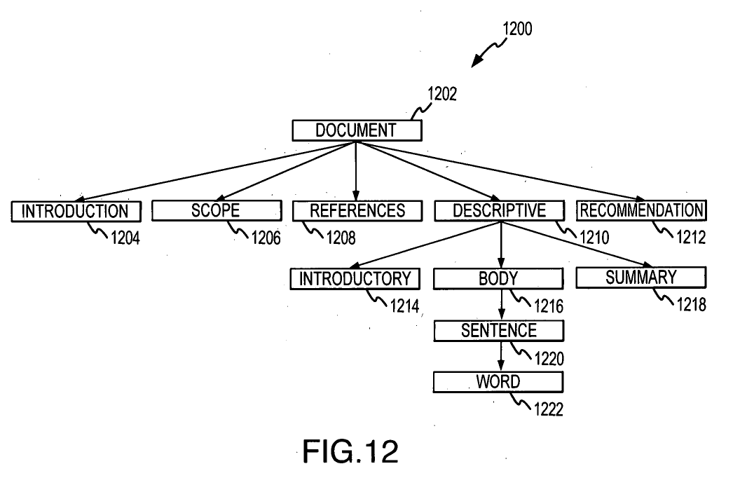

The basic paradigm of a system implementing the MAG module is a parse-process-reassemble paradigm. An example of the intermediate process step is set forth in the latter section of this description. The associated concepts of parsing, parsing resolution, inheritance and the like may be better understood by reference to the parse tree 1200 of FIG. 12. For the purposes of this example, consider the components that constitute a simple document 1202. In this case, the document 1202 is composed of sections of text separated by section markings. The defined sections might include introduction 1204, scope, 1206, references 1208, descriptive 1210 and recommendation 1212 sections. Each descriptive section 1210 may be further divided into an introductory paragraph 1214, a series of section body paragraphs 1216 and a summary paragraph 1218, each separated by a blank line. Each paragraph may be divided into sentences 1220 separated by periods, question marks, or exclamation points. Each sentence may further be divided into words 1222 separated by blanks. The parsing functionality of the MAG module is recursive. That is, the module can iteratively access and parse the “tokens” that constitute the content of various levels of the parse tree 1200. The specifications describing these various tokens are referred to herein as “MAGs.” Thus, in the illustrated example, the specification describing the document is the top level MAG. The introduction, scope, references, descriptive and recommendation section MAGs are all children of the document MAG, and each is a sibling MAG to one another. Similarly, each descriptive section MAG is a parent to (or composed of) an introductory paragraph MAG, a repeatable body paragraph MAG, and a summary paragraph MAG. The hierarchy of parent and child continues to the lowest level of individual words in a sentence in this example. Thus, the MAG module can be recursively invoked to provide substantially any level of processing resolution. For example, a message may be parsed to the word level to search for “dirty words”. In such a context, a sanitization process can be tailored to carefully protect against dissemination of protected information while enabling maximal transmission of clean information.

Also, from the parse tree of FIG. 12, it will be observed that many of MAGs' attributes can be inherited from related MAGs, thereby simplifying MAG definition and the required storage. The associated MAG specification tree, including all specifications of alternatives, components, delimiters, and so on, provides the roadmap needed to traverse the textual message. As the text of the message is sequentially parsed, available branches of the specification tree are followed or rejected to allow full understanding of message content. The text pertinent to an accepted branch is isolated and provided to higher resolution (component) specifications: a line of text is isolated and extracted based on its delimiters and lengths and is then handed down to component field specifications which perform similar functions, isolating and extracting text for processing by component sub-field specifications.

The specifications define various MAG parameters. A MAG parameter is a variable aspect of the MAG definition that controls some part of MAG behavior. Most parameters of a MAG specification need not be defined; typically, this means that the validation or construction associated with that parameter specification will not be performed. Parameters may also be inherited from a parent MAG, so that child MAGs need not repeat the specification of parameters of the parent. For each parameter, the requirements may be grouped by applicability to specification parse and format.

A detailed listing of parameter types is provided in U.S. Provisional Patent Application Serial No. 60/215,114 as well as user interface implementations related thereto. Some of these parameters are: identification parameters that allow for identification of a MAG, including specification of component or parent relationships and inheritability of parameters and specification of MAG type such as format-type (e.g., TACELINT) or field-type (e.g., ORIGINATOR); delimiting and length parameters that provide the means by which the content or text domain associated with a MAG is distinguished or isolated from the text that surrounds it, including definition of delimiter symbols, maximum length and minimum length; content restriction parameters such as verification of allowed characters and detection of non-data indicators; and component parameters by which each MAG can specify a list of components that must be parsed in conjunction with the process by which the higher level MAG is itself parsed. This last parameter type will be better understood upon consideration of the following process flow discussion.

The processes implemented by the MAG module include parsing and formatting. In the context of the illustrated implementation of the present invention, parsing is the transformation of information from the input text domain to the internal data domain and formatting is the transformation of information from the internal data domain to the output text domain. While parsing is essentially a message-driven activity in which MAG specifications are chosen from those available based on how well they accommodate the message, formatting is a specification-driven activity in which text is generated based on the availability of internal data to populate it.

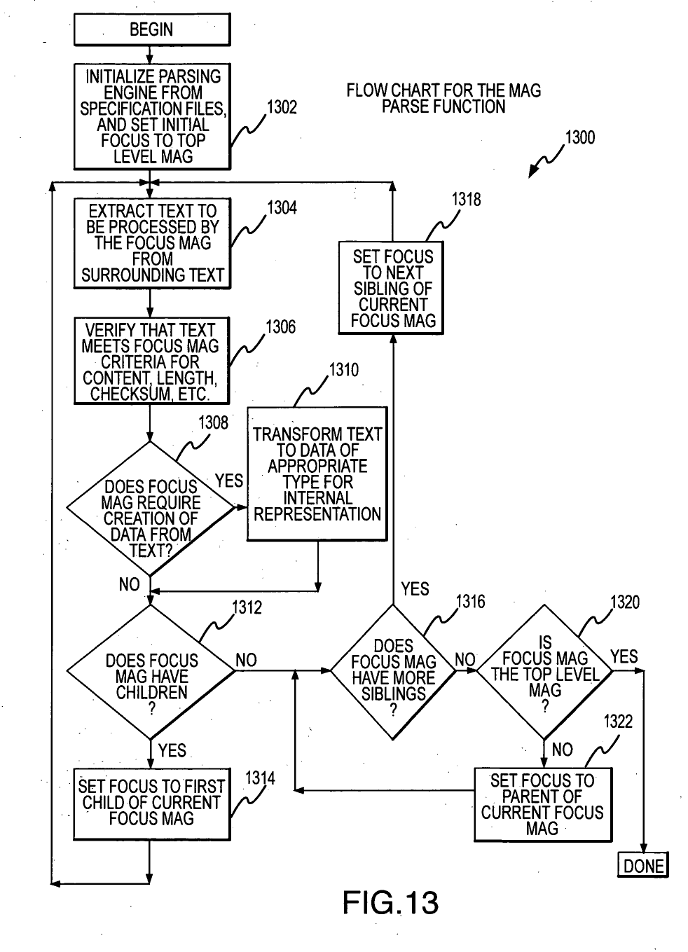

FIG. 13 is a flow chart illustrating the MAG parse function 1300. The function 1300 begins with initializing (1302) the parsing engine component of the MAG module from specification files and setting the initial focus of the parsing engine to the top level MAG. This involves identifying the external format of the information source accessing the corresponding specification from the specification tables and using the specification to configure the parsing engine. The specification will also define the top level MAG. This MAG becomes the “focus” MAG for the ensuing processing. The MAG module then extracts (1304) the text to be processed by the parsing engine using the focus MAG from the surrounding text. Specifically, a primary purpose of the parsing function 1300 is to transform a message from an external format to an internal representation. This is implemented based on the specification for the external format. For each token of a parse tree, the associated text is processed based on its MAG.

Prior to transformation, the MAG module verifies (1306) that the text meets focus MAG criteria for content, length, checksum, etc. It is then determined (1308) whether the focus MAG requires creation of data from text. If so, the text is transformed (1310) to data of an appropriate type for internal representation. If not, further parsing may be required. In this regard, the MAG module next determines (1312) whether the focus MAG has any children. If so, the focus of the parsing engine is set (1314) to a first child of the current focus MAG and the process defined by blocks 1304, 1306, 1308 and 1310 is repeated using the new focus MAG. It will thus be appreciated that loop 1304, 1306, 1308, 1310, 1312 and 1314 defines a process for recursively parsing along a particular lineage (the “intralineage parsing process”) to achieve the parsing resolution required for an application under consideration. If it is determined during any such iteration at block 1312 that the focus MAG does not have children, then the MAG module determines (1316) whether the focus MAG has any siblings. If so, the focus of the parsing engine is set (1318) to the next sibling of the current focus MAG and the intralineage parsing process is repeated with respect to this sibling. In this manner, different lineage branches of the parse tree can be parsed to the resolution required for a particular application.

If it is determined at block 1316 that the current focus MAG has no more siblings, then the MAG module determines (1320) whether the focus MAG is the top level MAG. If not, the MAG module sets (1322) its focus to the parent of the current focus MAG to see whether the parent has any siblings. The loop thus defined can be iterated to work back up through the parse tree to the top level MAG. In this manner, any MAG relationships that may have been missed working downward through the tree can be identified. Once the top MAG is reached, the process is complete.

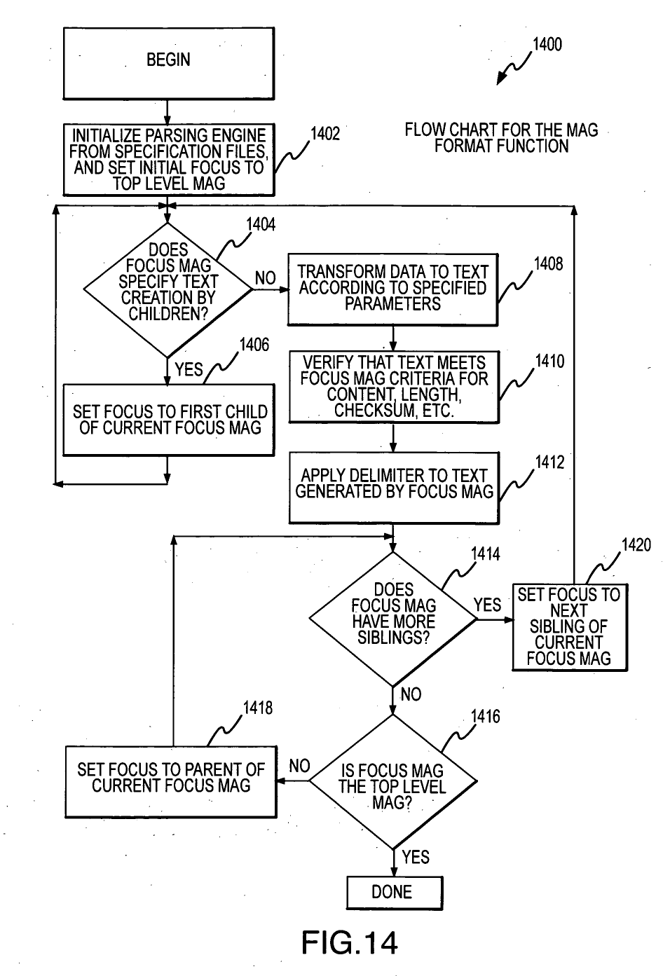

FIG. 14 shows a flow chart for the MAG format function 1400. The process begins by initializing (1402) the parsing engine from the specification files and setting the initial focus of the engine to the top level MAG. Similar to the process described above, this involves identifying a format of an external addressee system and accessing the corresponding specification table to configure the parsing engine. In order to transform a message from an internal application-specific representation (e.g., in a data format) to an external addressee format, it is necessary to parse the message to the parsing resolution required for transformation to the target format. Thus, the MAG module next determines (1404) whether the focus MAG specifies text creation by children of the current focus MAG. If so, then the focus is set (1406) to the first child of the current focus MAG. The loop defined by blocks 1404 and 1406 is then iterated until the MAG module determines at block 1404 that the focus MAG does not specify text creation by children. At this point, the required processing resolution has been achieved with respect to the focus MAG. In this case, the MAG module transforms (1408) the content associated with the focus MAG from the internal representation (e.g., data) to the target format (e.g., text) according to the parameter specified by the focus MAG. The resulting text is then analyzed to verify (1410) that it meets focus MAG criteria for content, length, checksum, etc., and any appropriate delimiters are applied (1412) to the resulting text.

Next, the MAG module determines (1414) whether the focus MAG has any siblings. If so, the focus is set (1420) to the next sibling of the current focus MAG and the preceding parsing and transformation steps are repeated. If the focus MAG does not have siblings, the MAG module determines (1416) whether the focus MAG is the top level MAG. If not, the focus is set (1418) to the parent of the current focus MAG and the resulting loop is iterated to work back up through the parse tree and identify any MAG relationships that may have been missed working downward. When it is determined at block 1416 that the focus MAG is the top level MAG, then the process is complete.

In the context of the system 700 of FIG. 7, the MAG module 718 as described above is operative to interface the ADS module 716 with the various source systems and addressees. The operation of the ADS module 716 will now be described.

B. Ads Module

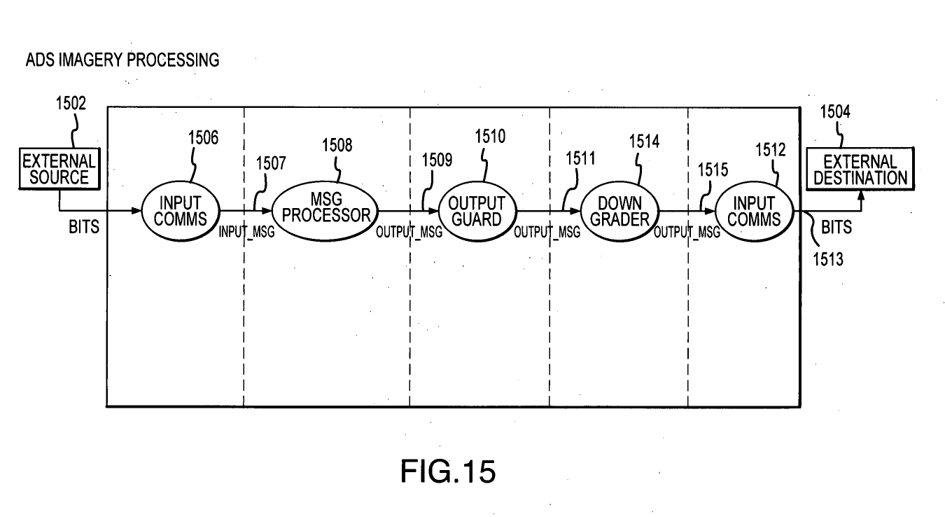

FIG. 15 is a schematic diagram of the ADS module 1500. The module 1500 automatically modifies, or sanitizes, formatted data from an external source system 1502, according to sanitization rules, for release to an external destination system 1504 so that the destination system receives only that portion of the original data for which it is authorized access. The module 1500 generally includes an Input Comms Module 1506, a Message Processor 1508, an Output Guard 1510, and a Downgrader 1514 and Output Comms 1512. The Input Module 1506 supports the communications protocol dictated by the external source system 1502 and forms a complete message from the message segments provided to it by the external system 1502. The resulting complete input message 1507 is then provided to the Processor 1508 which sanitizes the message according to rules written for the specific external system 1504 under consideration. The sanitized message 1509 is then passed to the Guard 1510 which verifies that the modifications performed by the Processor 1508 are correct. The Guard 1510 then passes the verified message 1511 to the Downgrader 1514 that in turn passes an output message 1515 to the output directory of the Output Module 1512, which supports the communications protocol dictated by the external destination system 1504 so as to effect communication of an output message 1513 from the ADS module 1500.

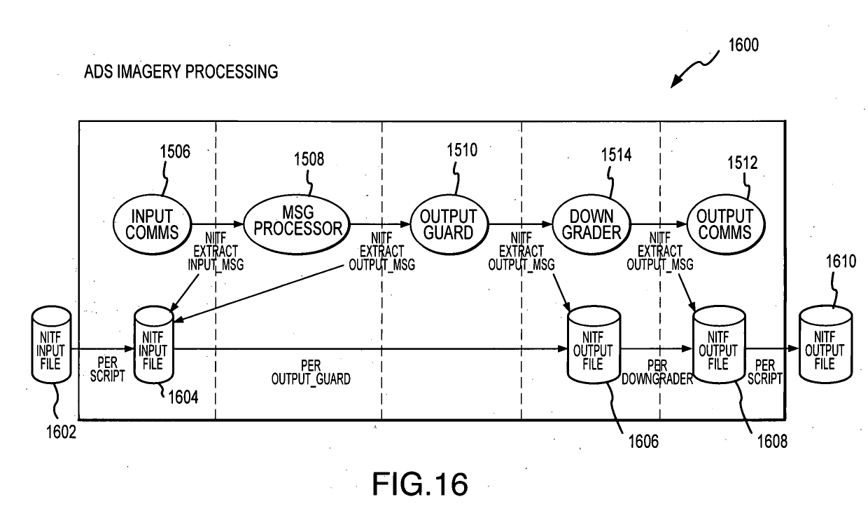

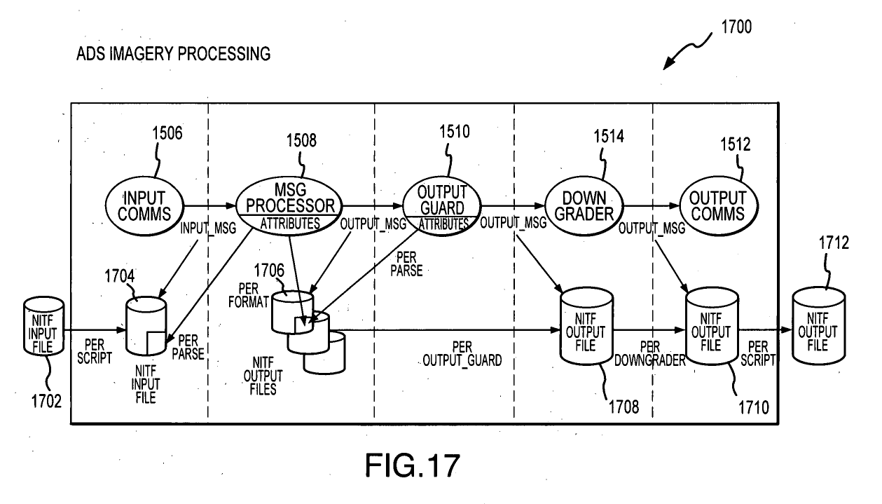

FIGS. 16 and 17 show certain modifications of the ADS module for handling messages including images. The components of the modules illustrated in FIGS. 16 and 17 that correspond to components of FIG. 15 are identified by the same numerals. In a variety of applications, including dissemination of tactical information, it is desirable to be able to sanitize and distribute messages including images. However, the processing of such image messages presents certain challenges. First, image messages include image elements that are not readily susceptible to analysis using conventional sanitization rules. In addition, when text and other data components are included together with images, there is a need to separate the intelligible data from the image components. Image messages also often constitute very large files, e.g., sometimes in excess of two gigabytes. Currently, many tactical systems do not have this much RAM. Accordingly, the module structures of FIGS. 16 and 17 include certain modifications to address the needs of handling image messages.

Referring first to FIG. 16, the sanitization module 1600 is illustrated in an exemplary application for processing an image message in one standard image messaging format; namely, NITF. A goal of the module 1600 is to process NITF messages as much as possible like simple textual messages. The principal modifications relate to file management. In this regard, the message text is kept in an external file. Thus, the input file 1602 is initially stored in an input file database directory 1604. Upon completion of processing by the Message Processor 1508 and Output Guard 1510 as discussed below, the file is transferred to the Downgrader working directory 1606. The message, as prepared for transmission by the Downgrader 1514, is finally stored in transmission output file directory 1608 from which the output message file 1610 is made available to addressee systems. It will thus be observed that the large message file including its inscrutable image components is never loaded into running memory. Rather, the message is separated into its inscrutable image components and its intelligible data components and the processing capabilities of the Processor 1508, Guard 1510 and Downgrader 1514 are allowed to operate only on the intelligible data components that are generally of a manageable size. Accordingly, an initial parsing or processing rule is added to the various parsing and processing rules used for handling data. This initial rule identifies and deletes from the working files to be processed by the Processor 1508, Guard 1510 and Downgrader 1514 certain inscrutable components. For example, such components may be identified based on size. In this regard, an attribute size threshold may be established that is sufficiently large to allow for processing of all text and other data, but sufficiently small to avoid loading image data into running memory. Such a rule is easily executed and the data components that remain for processing can then be processed using sanitization rules as discussed above.

More specifically, with regard to the input file 1602, a script can be used to access the NITF file from an external upstream system and write the NITF file into the Input Comms working directory 1604. The Input Comms 1506 is then operative to implement the initial rule as noted above for separating intelligible data from image components. The Input Comms 1506 also verifies message length and other components and passes the extracted input message to the Message Processor 1508. The Message Processor 1508 parses the extracted input message, applies the sanitization rules to the parsed extracted input message and generates an extracted output message that is passed to the Output Guard 1510. The Output Guard 1510 then verifies the extracted output message against release constraints, moves the NITF file to the Downgrader working directory 1606 and passes the extracted output message to the Downgrader 1514. The Downgrader 1514 moves the NITF file to the Output Comms working directory and passes the NITF extracted output message to the Output Comms 1512. Finally, the Output Comms 1512 invokes an output script to move the NITF file to an area where it can be accessed by an external addressee system.

FIG. 17 shows an ADS module 1700 with further modifications for image message handling. In this case, again, a script is used to access an NITF file 1702 from an external source system and write the file into the Input Comms working directory 1704. The Input Comms 1506, again, is operative to verify the message length and other parameters. However, in this case, the Input Comms does not attempt to parse the input message so as to extract intelligible data. Rather, the Message Processor 1508 parses the NITF file into intelligible elements (character and numeric attributes) and nonintelligible elements (file attributes, pointing to segments of original NITF file). The Message Processor 1508 then applies the sanitization rules to the parsed NITF file including attributes of all types and generates an output message pointing to an entirely new NITF file 1706 using the attributes. Finally, the Message Processor 1508 passes the output message to the Output Guard. The Output Guard 1510, in this case, also parses the NITF file into intelligible elements and nonintelligible elements and verifies the parsed NITF file 1706 per release constraints and moves the NITF file 1706 to the Downgrader working directory 1708. The Downgrader 1514 moves the NITF file 1706 to the Output Comms working directory 1710 and passes the output message pointing to the NITF file to the Output Comms 1512. Finally, the Output Comms 1512 invokes a script to move the NITF file to an area 1712 accessible by an external addressee system.

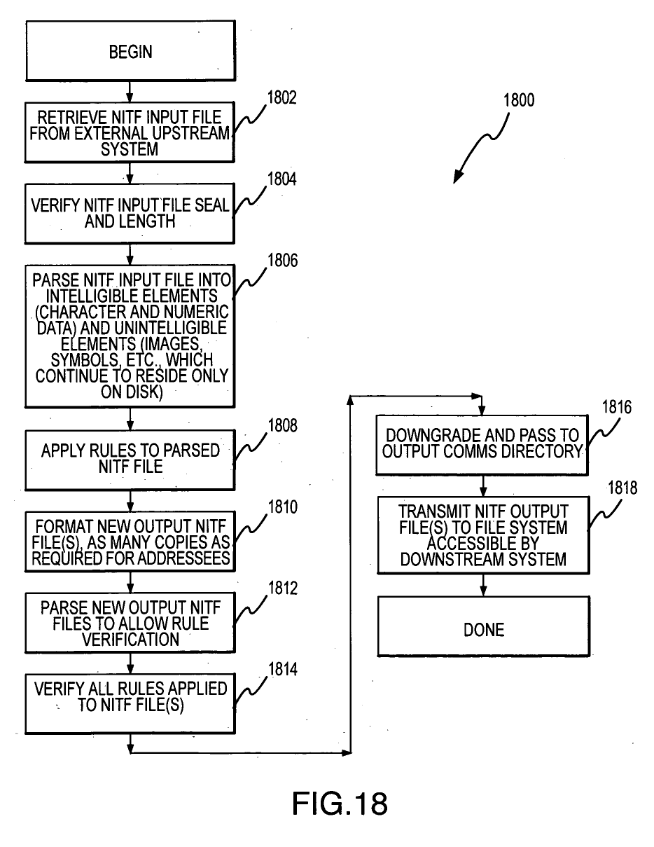

FIG. 18 is a flowchart illustrating the sanitization module processing 1800 for handling image messages in accordance with the structure of FIG. 17. The process is initiated by receiving (1802) an NITF input file from an external upstream (source) system. Next, the NITF input file's seal and length are verified (1804) and the input file is parsed (1806) into intelligible elements and unintelligible elements. In this regard, the intelligible elements can be moved into running memory while the unintelligible elements including images, symbols, and the like continue to reside only on disk. The module then applies (1808) the appropriate rule to the parsed NITF file and formats (1810) a new NITF file or files including as many copies as required for the addressees. The new output NITF files are then parsed (1812) to allow rule verification and all rules applied to NITF files are verified (1814). The NITF output files are downgraded and passed to the Output Comms directory. Finally, the NITF output files are transmitted (1818) to a file system that is accessible by a downstream (addressee) system.

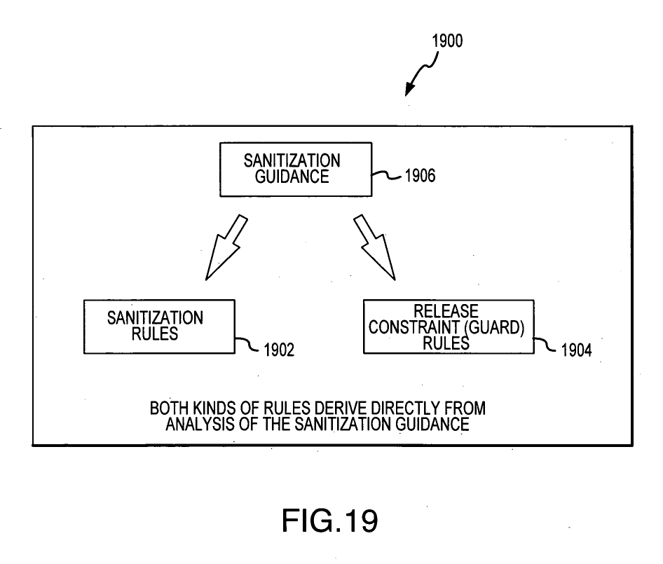

The foregoing discussion has made reference to two important categories of rules. These rules are illustrated in FIG. 19. The rules 1900 include sanitization rules 1902 and release constraint rules 1904. Together these rules are controlled by sanitization guidance 1906. Each of these types of rules will be discussed in turn below.

When the message processor component of the ADS module obtains a parsed message, the message is generally processed using sanitization tasks common to all messages entering the system over a specific communications network or from a particular source. In this process, the message processor can screen the incoming data either to reduce data throughput to only messages of interest (e.g., data germane to a current area of interest), or perform a change to the data which is pertinent to all addees who will receive this message (e.g., correct the spelling of a particular field value).

The processor can then perform sanitization for specific “addees”. An addee refers to an addressee or a group of addressees on a channel which has the same sanitization requirements for messages processed by the ADS module. For example, all Tomahawk ships on the same channel may be grouped under one addee name because each is only authorized to receive secret GENSER level messages. The message processor can then copy the message for each addee. A set of unique sanitization tasks, designed for each particular addee, is used to remove or replace data to satisfy security guidance required to downgrade or process the information for the particular addee. These sanitization tasks, as shown in FIG. 19, are derived directly from security guidance designed for the specific site of employment and the local security concept of operations. This guidance directs how messages processed by that site are to be sanitized for release at specific sensitivity levels.

The entire input message may be screened against a “dirty word” search task containing one or more definable tables of words or phrases or other strings that constitute a security risk. The dirty words may include code words or other classified names and/or locally prescribed dirty words that must be removed in order to properly sanitize the message.

Generally, one or more “rule” sanitization tasks have been developed by the operator to execute specific actions on fields in the message. Rules can add, replace, delete, round, adjust, copy, store or retrieve an attribute value. They can also send a message to the operator for review or delete free text in the message.

These sanitization tasks may be developed locally or imported from another system. The sequence or flow of sanitization tasks is defined by the operator and is generally under two person control, i.e., one person initiates an action and a second person approves the action. Once activated, the sanitization module handles the received messages automatically according to the plan designed by the operator.

The sanitization rules manipulate the parsed data based on a condition statement paired with an action statement, commonly called an if/then statement. If a certain condition exists in a message then the system performs a certain action. Each of these if/then statements is called a rule. Various examples of rules, as well as user interfaces for selecting, defining and implementing them, are set forth in the U.S. Provisional Patent Application Serial No. 60/215,114. Some such types of rules include the following.

TABLE 1

| | RULE BASED |
|---|---|
| CONDITION | SANITIZATION ACTION |
| Operator defined criteria to delete a | Delete contact being processed |
| contact | |
| Operator defined criteria to delete a | Delete specified attribute |
| specific attribute | |
| Free (unformatted) text in message | Delete free text in message |
| | being processed |
| Operator defined value requiring | Round the value of the attribute |
| numeric rounding | as specified |
| Operator designates attribute whose | Replace the value of the attribute |
| value is to be replaced and designated | with the supplied value |
| attribute exists in the message | |
| Operator designates attribute whose | Add a new attribute containing |
| value is to be replaced but designated | the supplied value |
| attribute does not exist in the message | |
| Operator defined condition when met | Apply the additional rules to the |
| requires additional actions to be | contact meeting the conditions |
| performed | |
| Operator designates attribute whose | Copy the value of the attribute |
| value is to be copied to another | to value of the designated |
| attribute | attribute |
| Operator designates attribute whose | Adjust the value of the |
| value is to be adjusted | attribute as specified |
| Operator designates attribute whose | Increment the value of the |
| value is to be incremented based on a | designated attribute |
| previously applied value | |
| Operator designates an attribute whose | Store the value of a designated |
| value is to be stored | attribute based on a key |
| | attribute which uniquely |
| | identifies the stored attribute |
| Operator designates key attribute which | Retrieve the value of a |
| identifies the stored attribute list from | designated attribute based on a |
| which the attribute value is to be | key attribute which uniquely |
| retrieved | identifies the stored attribute |
| | list from which the attribute |
| | is to be retrieved |

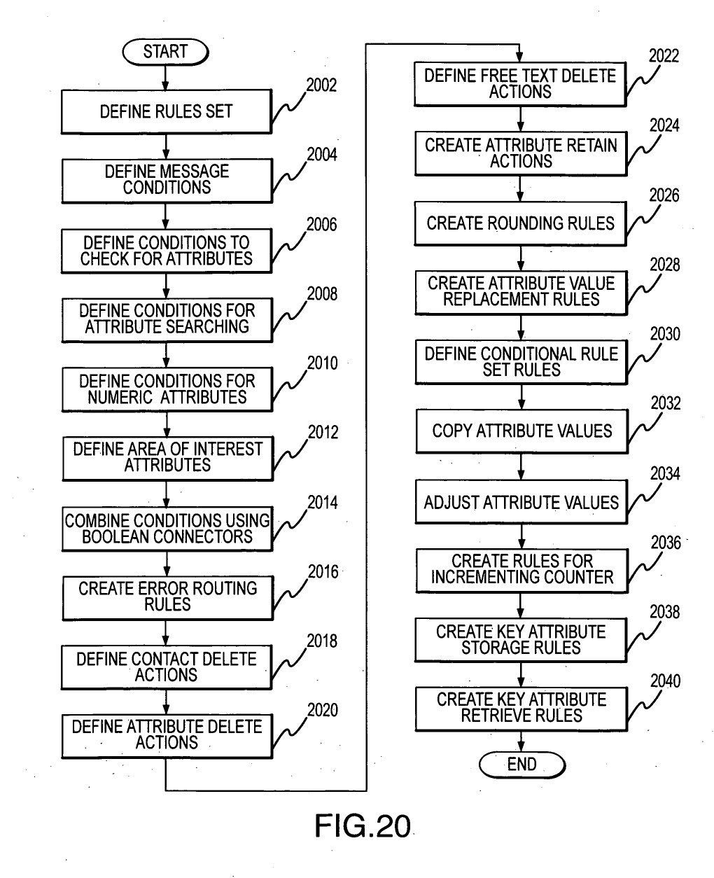

FIG. 20 is a flowchart showing the steps an operator may perform in the development of rules based sanitation. The associated steps are listed below:

1. Define (2002) a set of rules used to sanitize messages and their component contacts.

2. Define (2004) conditions on message-level attributes and attributes of contacts contained in the message.

3. Define (2008) conditions checking for the existence of attributes.

4. Define (2008) conditions for text or character attributes searching for the occurrence of a given string, which may include wildcards (symbols that represent any characters)

5. Define (2010) conditions for numeric attributes as a comparison to a given value using the relational operators (equal, less than, greater than) or their negations

6. Define (2012) conditions in which contact positions are within a specified Area of Interest (predefined geographic area, e.g., in terms of coordinates).

7. Combine (2014) conditions in a set using Boolean logical connectors.

8. Create (2016) rule actions to route messages being processed to the Error Queue.

9. Define (2018) contact deletion actions.

10. Define (2020) attribute deletion actions, specifying the attribute to delete.

11. Define (2022) actions to delete all attributes containing free text.

12. Create (2024) rule actions that designate attributes to be retained, deleting all attributes not listed.

13. Create (2026) rule actions that specify the precision to which a specified numeric attribute (integer, floating point number, position, or time) is to be rounded.

14. Create (2028) rule actions that replace attribute values with supplied values.

15. Define (2030) rule actions that provide an additional set of rules to be conditionally performed.

16. Copy (2032) one attribute value to that of another attribute.

17. Adjust (2034) an attribute value by a supplied amount.

18. Create (2036) rule actions which increment the value of an attribute by a specified amount based on a previously defined message counter definition.

19. Create (2038) rule actions which store the value of an attribute based on the presence of an associated key attribute.

20. Create (2040) rule actions that retrieve a stored attribute value based on the presence of an associated key attribute.

In addition to rules based sanitization, the ADS module determines the classification level of the received message by reading the sensitivity labels in the message. The input and output communications channels parameters are defined by the operator according to local site security requirements, e.g., from top secret/sensitive compartmented information (TS/SCI) to top secret/NATO releaseable (TS/NATO), or from TS/SCI to secret (S). Using these definitions, the ADS module initiates internal checks and verification processes to insure data is guarded against release to unauthorized channels and addressees. Once sanitized, the message is reformatted.

The ADS module as discussed above also contains a separate Guard. The Guard contains rules, called release constraint rules (RCRs). The RCRs are defined by the operator under two person control and, again, as depicted in FIG. 19, in accordance with the same sanitization guidance which governed the development of the sanitization rules. RCRs are designed to verify that each message has been properly sanitized by the sanitization rules. The Guard also verifies that correct classification markings are present and that the message header and body format are correct. It verifies that the correct constraints on message release are in place and that the message is at the right classification level to be released to the channel and addees prior to passing the message to the output channel for transmission.

The foregoing description has included a discussion of the various MAG and ADS components and processes. Further details in this regard, as well as user guide level instructions for operation of a specific product implementation is provided in U.S. Provisional Application Serial No. 60/215,114.

### III. Radiant Collaboration

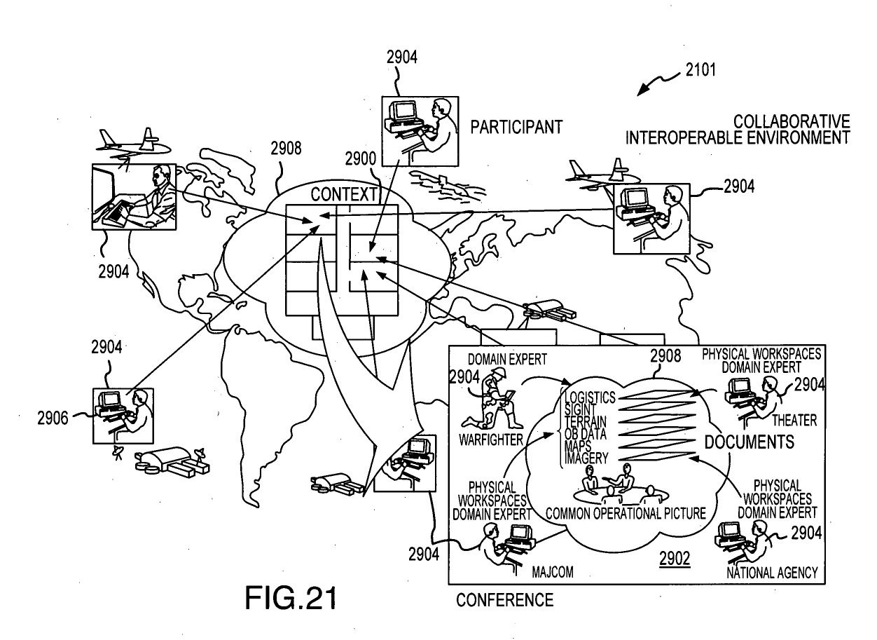

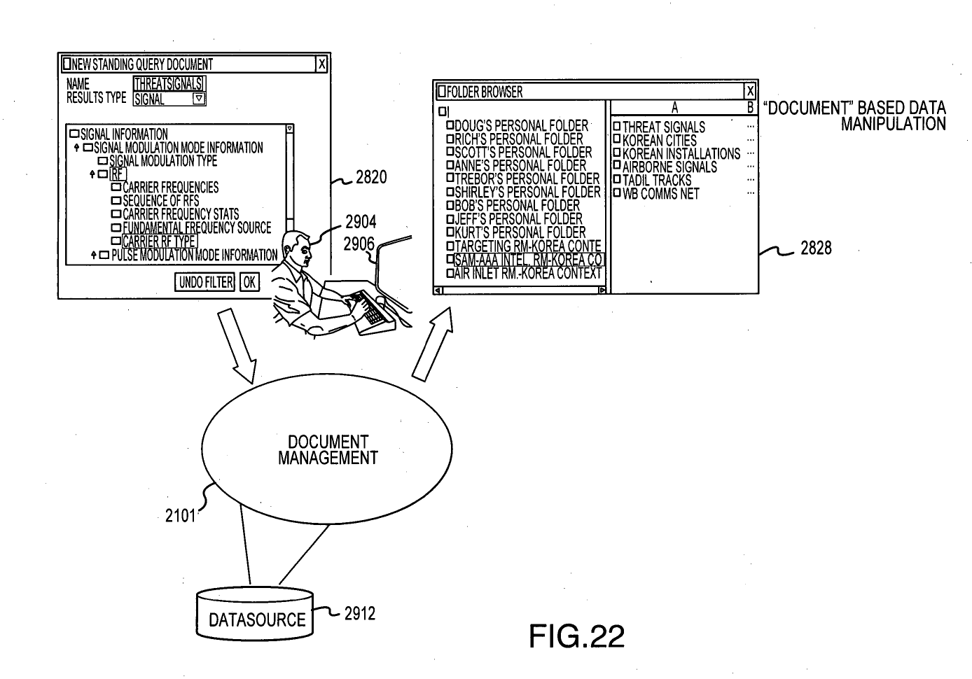

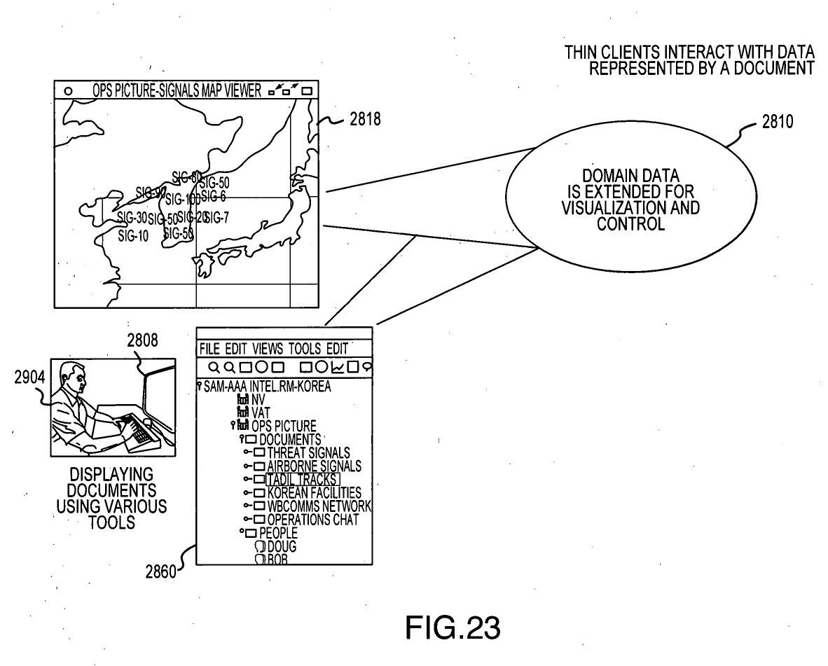

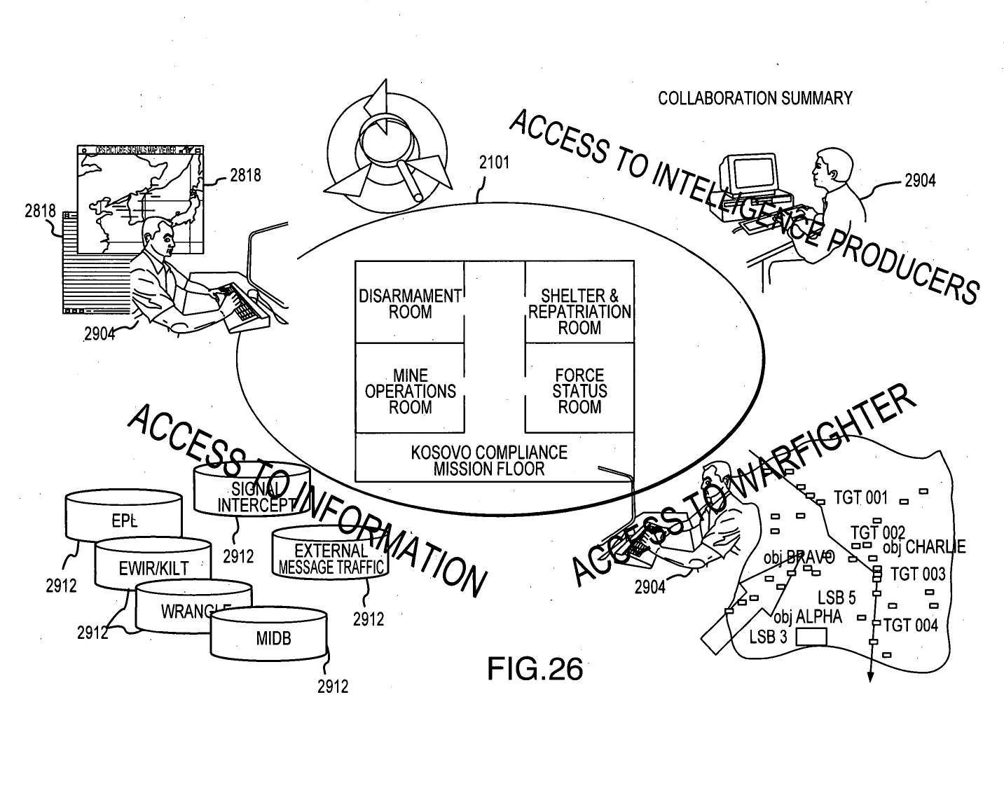

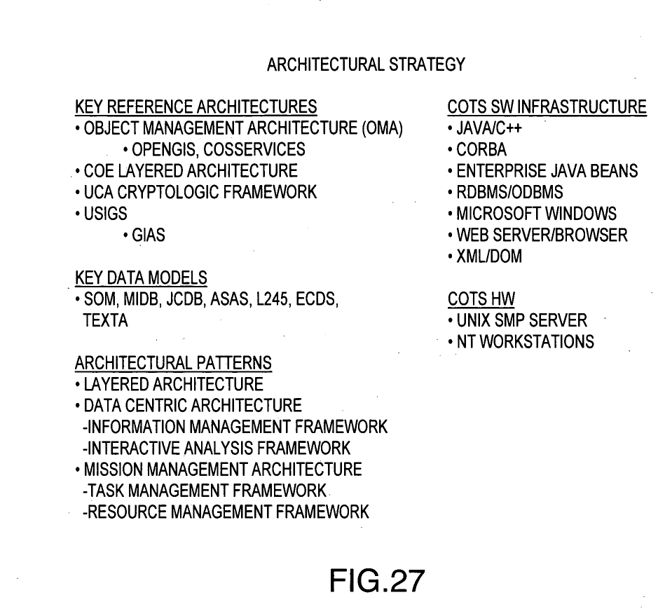

As discussed above, the sanitizer/guard subsystem operates in conjunction with a collaboration subsystem in the Radiant Trust System. Referring generally to FIGS. 21-29, a computer implemented collaboration subsystem 2101 of the present invention incorporates a component-based infrastructure providing an architectural foundation for developing/incorporating advanced capabilities into new or legacy systems. The infrastructure incorporates a data centric approach where domain information is extended with control and visualization attributes and presented as self-describing objects. Data access is provided through industry standard interfaces, adding to the ease of integration with legacy and commercial applications. The collaboration system builds on a data centric philosophy to provide key foundation frameworks for data access, collaboration, and component integration.

The collaboration subsystem infrastructure is designed to integrate with existing collaborative products such as, for example, Net Meeting, Sun Forum, CVW, InfoWorkspace and Placeware, and to make available additional collaborative capabilities not provided by existing tools. Specifically, the collaboration system infrastructure provides access to multiple domain data sources and allows data from those sources to be analyzed and manipulated within a multi-user distributed environment where all visualization, processing, and agent applications work collaboratively.

The collaboration subsystem is a fully distributed architecture allowing each service to be configured and executed anywhere within the network. It is built upon an architectural framework including CORBA and Java. The infrastructure is platform independent with demonstrated operation under heterogeneous operating environments consisting of Microsoft® Windows 9x, Windows NT, Windows 2000, and Unix (e.g., Solaris 2.x). The collaboration subsystem is based on established and emerging government and commercial open standards including the Geospatial Information Access Specification (GIAS), OpenGIS, and Document Object Model (DOM). All interfaces to the collaboration subsystem infrastructure are provided through standard Interface Definition Language (IDL), ensuring adaptability to legacy systems written in Java, C, C++, Ada, or any other language with IDL bindings.

Still referring generally to FIGS. 21-29, the collaboration subsystem data access framework incorporates an adaptive repository layer that accesses the domain data through the access methods native to the data source. This enables data from any data source (real-time data feed, object data base, relational database, file system, etc.) to be accessed from the infrastructure. The repository approach is non-intrusive such that domain data sources do not need to be modified in any way. The repository acts as a gateway to the native data. The repository is responsible for describing the data and making the data available through industry standard interfaces. This alleviates the need for client applications to have any knowledge of data location or specific access logic unique to the data source.

Extensibility and flexibility are key attributes of the collaboration system infrastructure. Data is made available in a self-describing format such that client applications learn about the data and are able to manipulate the data without any a'priori knowledge of its intrinsic structure. Client viewers are subsequently able to manipulate data from a variety of different domain sources without requiring any specialized software. Therefore, adding a new data source or changing the structure of an existing data source requires no changes to the infrastructure or client applications. In addition, adding client applications that can provide extended capabilities, e.g., to manipulate data within any available data source.

Referring more specifically to FIG. 21, there is shown an overview of a collaborative interoperable context 2900 that is provided by the computer implemented collaboration subsystem 2101 of the present invention. Within the collaborative interoperable context 2900 one or more conferences 2902 are provided in which multiple participants 2904 are able to collaboratively access and manipulate data from one or more data sources at the same time to solve a problem. The participants 2904, who may be geographically remote from one another, access the conferences 2902 via user terminals 2906 connected to a data network 2908. The participants 2904 to a conference 2902 are able to access and manipulate the data through one or more documents 2910 that represent the data sources. For example, as is illustrated, within a conference 2902 of a context 2900 relating to an intelligence gathering and analysis operation there may be documents 2910 representing logistics data, signal intelligence data, terrain data, map data, image data and the like, together providing a common operational picture. It will be appreciated that although the illustrated context 2900 is of an intelligence related nature, the collaborative interoperable context 2900 may relate to many other non-military related matters.

The context 2900 provides a higher order organization for the conference 2902. A context 2900 may be a floor in a building, a region within a country or a conference room. Contexts 2900 may be entered by participants 2904 as a room would be entered and conferences 2902 can be established. Conferences 2902 provide the context 2900 to drop documents 2910 for collaboration. A document 2910 dropped within a conference 2902 will have an associated data channel that will maintain and make available the collection of information represented by the document 2910 as well as any extended visualization or control properties.

Referring now to FIGS. 21-23, each document 2910 represents data from a corresponding data source 2912. A document 2910 may be created by performing queries against the corresponding data source 2912 or it may be created as an empty document 2910 to be populated using interactive tools. In the former case, the query may be one of two types, standing or static. A standing query acts as an agent, constantly being evaluated to ensure that the collection of data represented by the document 2910 is up-to-date relative to the query specification. As changes are made to the corresponding data source 2912, the document 2910 is updated and those updates are propagated to any viewer that may be displaying the document 2910. A static query represents a snapshot of the data in the corresponding data source 2912 at the time that the query was invoked. The document 2910 representing the corresponding data source 2912 is not updated when the data source 2912 changes but may be manipulated by other software agents or individuals interacting with the document 2910 directly.

Once created, one or more documents 2910 maybe placed into a conference 2902 by a participant 2904 (e.g., by dragging a document 2910 and dropping it into a conference 2902), then opened and acted upon by various client applications, such as display/processing tools (e.g., map viewers, list viewers, analytical packages, etc.). Within each conference 2902, the domain data (i.e., the data from the corresponding data sources 2912 represented in the documents 2910) is extended through the addition of visualization and control properties such as, for example, an associated color and/or symbol for displaying the data or an indication of what data has been selected by a participant 2904 using a client application. The visualization and control properties become part of the data represented in the documents 2910, allowing the client applications to focus on the presentation of the information rather than needing complex logic for accessing the data or logic dealing with collaboration between the participants 2904 to a conference 2902. Documents 2910 may be graphically overlaid or textually combined to show relationships between data from different data sources 2912 and to extract information that could not be extracted by viewing the data separately. Documents 2910 can be attached to tasks and may be passed from place-to-place or person-to-person following a process.

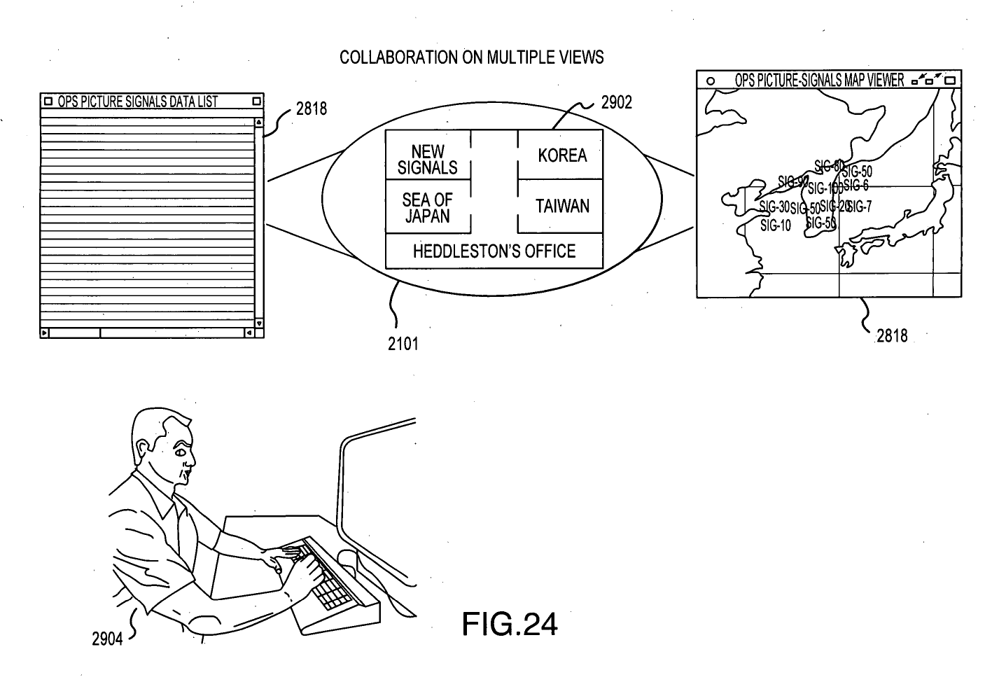

Referring now to FIG. 24, the computer implemented collaboration system 2101 of the present invention provides for single user collaboration. Single user collaboration is a concept used to describe a single user interacting with multiple visualization or data processing tools against one or more documents 2910 within the collaborative context 2900. By having all domain, control, and visualization properties available through the collaboration system 2901, collaborative tools work together to extract information from the data and cooperate for problem solving. It is important to note that, in accordance with the present invention, there is no direct communication between the tools.

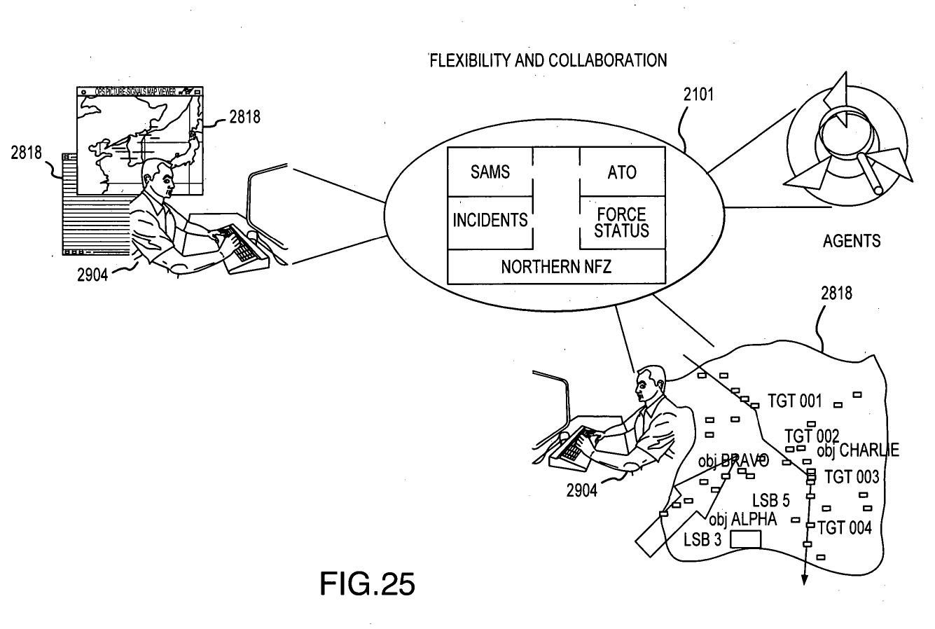

Referring now to FIG. 25, the computer implemented collaboration system 2101 of the present invention also provides for multi-user collaboration. Multi-user collaboration is an extension of the single user collaboration environment to include multiple participants 2904. The collaborative framework of the collaboration system 2101 provides inherent multi-user collaboration in that no specialized logic is required for client applications to act collaboratively. Multiple users enter conferences to combine and apply various human knowledge, agent/application processing, and data resources to solve a problem. The computer implemented collaboration system 2101 of the present invention permits collaboration between multiple users without requiring that images be pasted onto a common “whiteboard” in order for the multiple users collaborate on the same data. Instead, collaboration is accomplished directly within the tools. Additionally, collaboration between multiple users is possible without requiring the incorporation of special logic within the tools. It will be appreciated that, in addition to human collaborators, there may be software agents involved in the collaborative process.

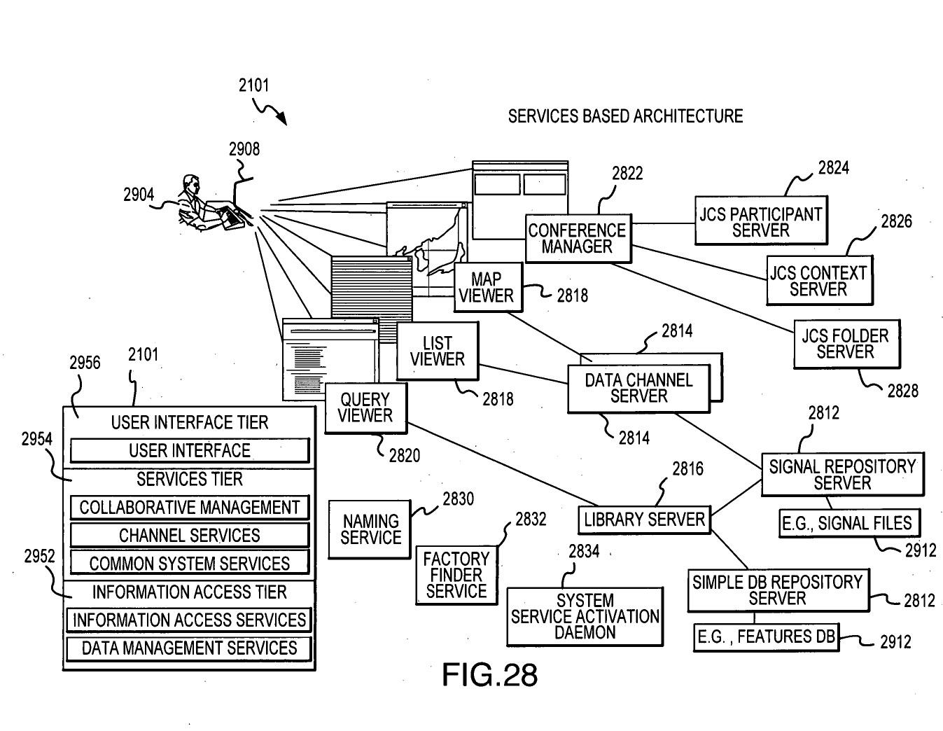

Referring now to FIG. 28, a block diagram of the components of one embodiment of a collaboration system 2101 in accordance with the present invention is shown. The collaboration system 2101 includes one or more repository servers 2812, one or more data channel servers 2814, a library server 2816, one or more client data viewing tools 2818 (e.g., a list viewer tool, a map viewer tool, or an X-Y viewer tool), a query viewer tool 2820, and a conference manager tool 2822. Each repository server 2812 is enabled for accessing data within a corresponding data source 2912, using data access methods native to its corresponding data source 2912. It will be appreciated that, since the repository servers 2812 provide access to the data sources 2912, the client data viewing tools 2818 do not need to be enabled for accessing the data within the data sources 2912, and therefore require no specific knowledge of the nature of the data within the data sources 2912. The data channel servers 2814 manage data centric channels within which extended data properties (e.g., visualization and control properties) are maintained. Maintaining the extended properties of the data within the data channel servers 2814, rather than within the client data viewing tools 2818, allows for single user and multiple user collaboration without requiring that the client data viewing tools 2818 be enabled for direct communication with one another or have any knowledge of each other.

The collaboration system may include additional management components supplied by the MITRE Corporation as part of the Joint Collaborative Services (JCS) Project, such as a JCS participant server 2824, a JCS context server 2826, and a JCS document server 2828. The participant server 2824 maintains a listing of all authorized participants 2904 as well as the processing state of the participants 2904 and the conferences 2902 that they have entered. The document server 2828 provides interfaces to manipulate documents 2910 within folders. Interfaces provide for creation and deletion of documents 2910 as well as folder management to allow organization of documents 2910 in a hierarchical storage structure. The context server 2826 provides the interfaces to manage collaboration contexts 2900 and conferences 2902 within those contexts 2900. The collaboration system 2101 may also include such standard CORBA services as a naming service 2830, a factory finder service 2832 and a system service activation daemon 2834.

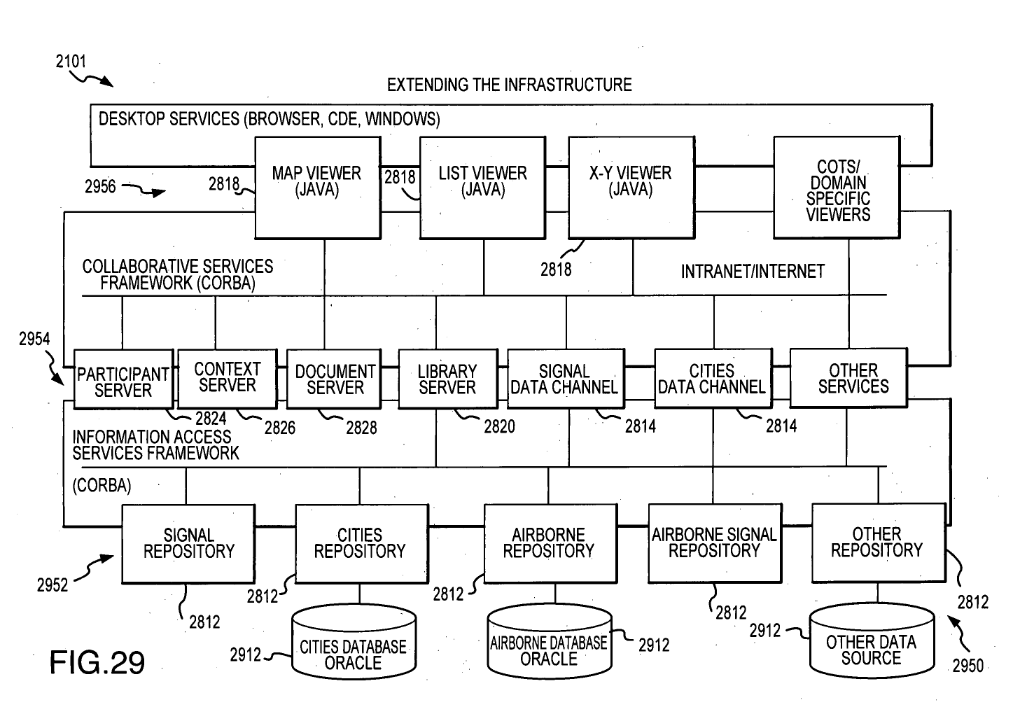

Referring to FIG. 29, the components of the collaboration system 2101 are organized into an N-tier infrastructure including a data management tier 2950, an information access tier 2952, a services tier 2954, and a user interface tier 2956. Each tier is made up of components accessed and manipulated through a defined interface. The infrastructure of the collaboration system 2101 rides upon a CORBA communications framework. The data management tier 2950 includes and the data sources 2912 (e.g., a cities database, an airborne database). The data management tier 2950 provides the data management capabilities normally supplied by database management systems.

The repository tier 2952 is comprised of the repository servers 2812 (e.g., a signal repository, a cities repository, an airborne repository, an airborne signal repository). The repository tier 2952 provides the adaptive services to make the data maintained within the data sources 2912 available to the services in the services tier 2954 and the client tools in the user interface tier 2956. Each repository server 2812 in the repository tier 2952 interacts with its associated data source 2912 using the data source's 2912 native access methods. This allows virtually any data source 2912 to be integrated with the infrastructure without requiring modifications to the rest of the infrastructure services or client tools. The repository servers 2812 in the repository tier 2952 perform two functions. They act as proxies to execute service requests using their associated data source's 2912 native access methods, and they provide requested data to the infrastructure in self-describing structures.

Requests are made to the repository servers 2812 in two ways: standing queries and static queries. Upon initialization, each repository server 2812 interrogates its associated data source 2912 to extract the structure of the data maintained within it. This definition is described as a feature type. Each repository server 2812 then registers' with the library server 2816, providing the supported feature type and the type of queries that the repository can perform (blank, standing, static). When a query is executed, the result of the query is transformed in to a self-describing data structure made accessible through a component called a “feature collection.”

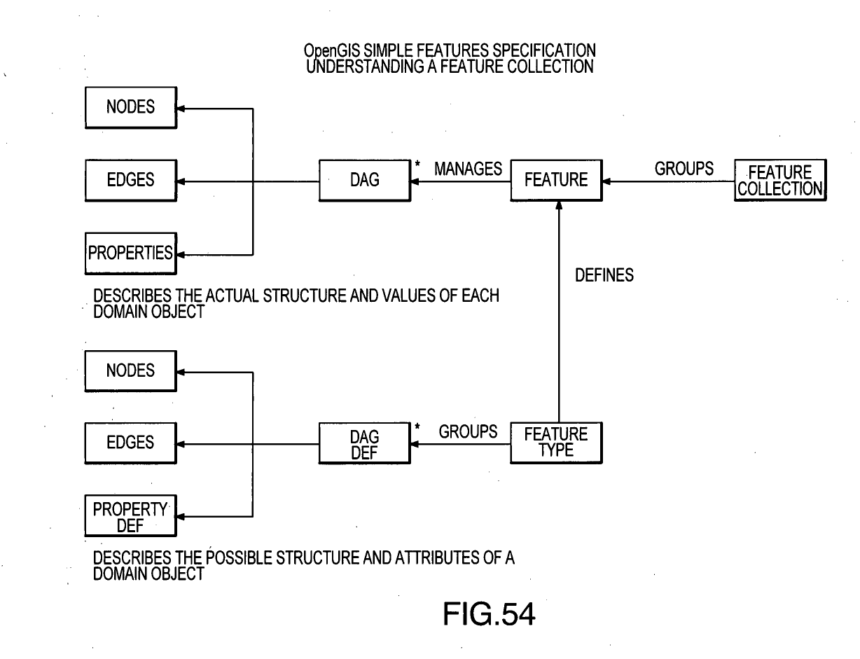

The repository servers 2812 are responsible for accepting requests for information, executing those requests and then managing the resulting collection of information. The collection of information resulting from a query, called a “feature collection,” is made available in a self-describing format. The information and the access methods to manipulate the collection are modeled after the “Simple Features Specification” developed by the Open GIS Consortium. FIG. 54 illustrates the components that make up a “feature collection”.

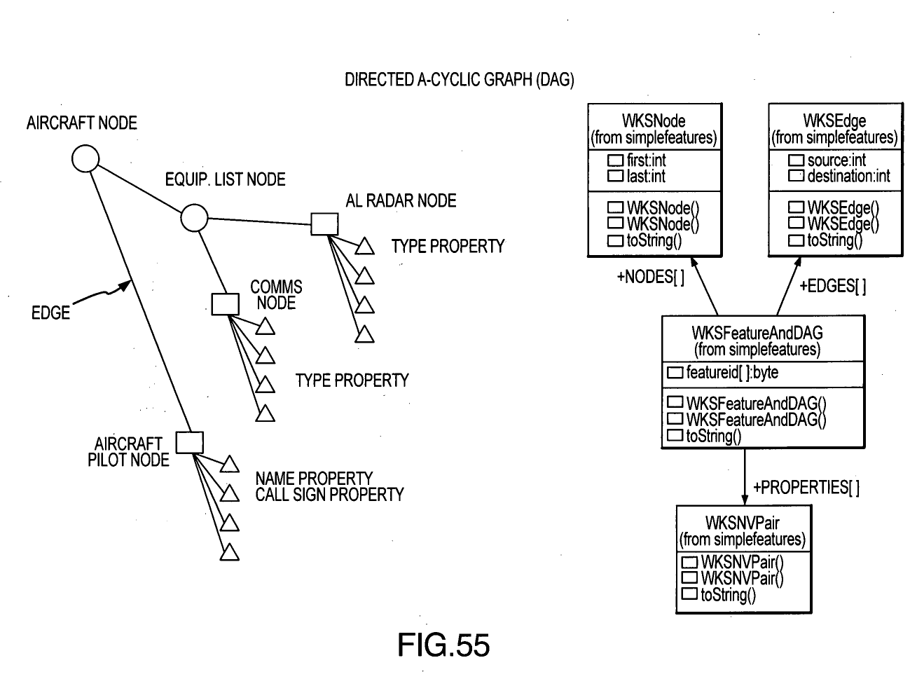

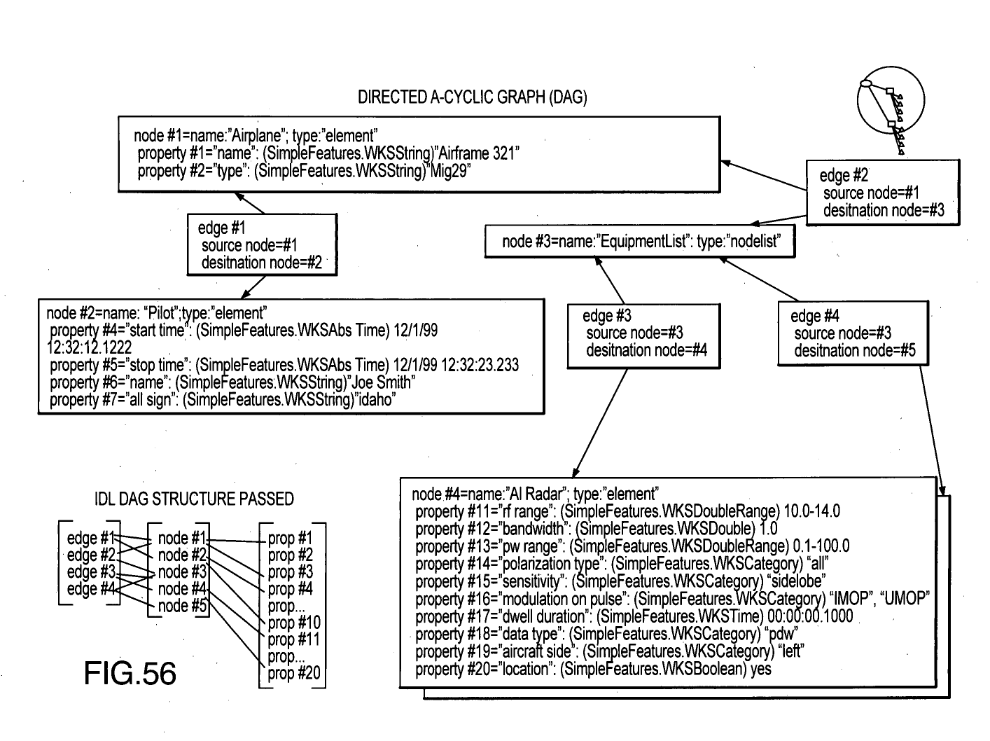

Each feature in a “feature collection” is managed in the form of a Directed Acyclic Graph (DAG). The DAG structure is used to describe the information resulting from a query and is subsequently used to communicate (pass-by-value) the object information between the client and server. The DAG structure, which is illustrated in FIGS. 55-56 has three parts: (1) an array of properties that contain only attribute information; (2) an array of nodes that contains lists of attributes (element node) or lists of other nodes (node list); and (3) an array of edges that connects two nodes. It will be appreciated that the DAG structure is easily converted from/to the DOM Objects.

The services tier 2954 is comprised of the data channel servers 2814, the library server 2816, the participant server 2824, the context server 2826, and the document server 2828, as well as other services. The services tier 2954 provides services that are accessible to any other service, client tool or repository. The services tier 2954 maintains the majority of the business logic as applied to a specific domain problem. The services tier 2954 is designed to be extended, allowing domain specific business logic to be added and made available to the enterprise system. New services register their existence with the naming service 2830 (FIG. 28), providing their home interface such that client tools and other services can learn and utilize their capabilities.

The user interface tier 2956 is comprised of thin client applications/applets/servlets (the client tools 2818) that allow the user to interact with the data. Each client tool 2818 interfaces directly with the collection (if no collaboration is desired) or directly with the data channel(s) 2814 (provides collaboration features).

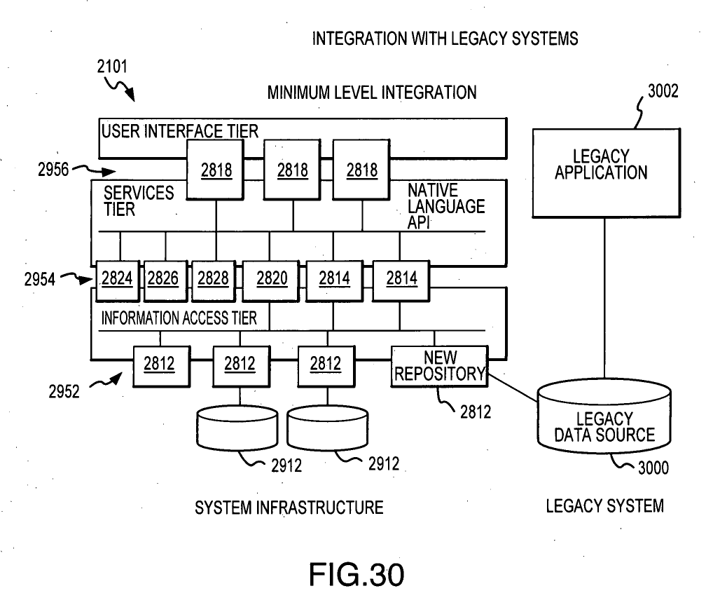

Referring to FIGS. 30-42, the collaboration subsystem 2101 of the present invention provides an infrastructure for integrating legacy system capabilities and those provided by the collaboration system 2101. The infrastructure of the collaboration subsystem 2101 provides a foundation for keeping up with rapidly changing technology and supports adaptation of new capabilities as systems evolve. The collaboration subsystem 2101 has an open architecture, providing multiple options for integrating legacy systems. The level of integration selected for each legacy component depends on the capabilities of the infrastructure being utilized and the plans for system expansion. If long-term migration plans include extensive use of legacy software components, higher levels of integration are required to fully utilize the benefits of the architecture. If the plan is to make temporary use of legacy components until other capabilities are developed, a lower level of integration may be appropriate. One recommended approach provides for three levels of integration. This approach allows each component (data source, processing components, user interface) of the legacy system to be integrated as necessary to achieve the desired system capabilities.

FIG. 30 illustrates first (or minimum) level integration of the collaboration subsystem 2101 with a legacy system. First level integration requires no change to the legacy system. A repository 2812 in the information access tier 2952 is developed to provide access to the legacy data source 3000. This level of integration allows access and manipulation of domain data by the existing tools 2818 provided by the collaboration system 2101 infrastructure. It allows full access to query and create documents from new and legacy data sources and allows existing viewing tools 2818 (those provided with the collaboration subsystem 2101 infrastructure) to act on the data collaboratively without requiring changes to the legacy application 3002 software.

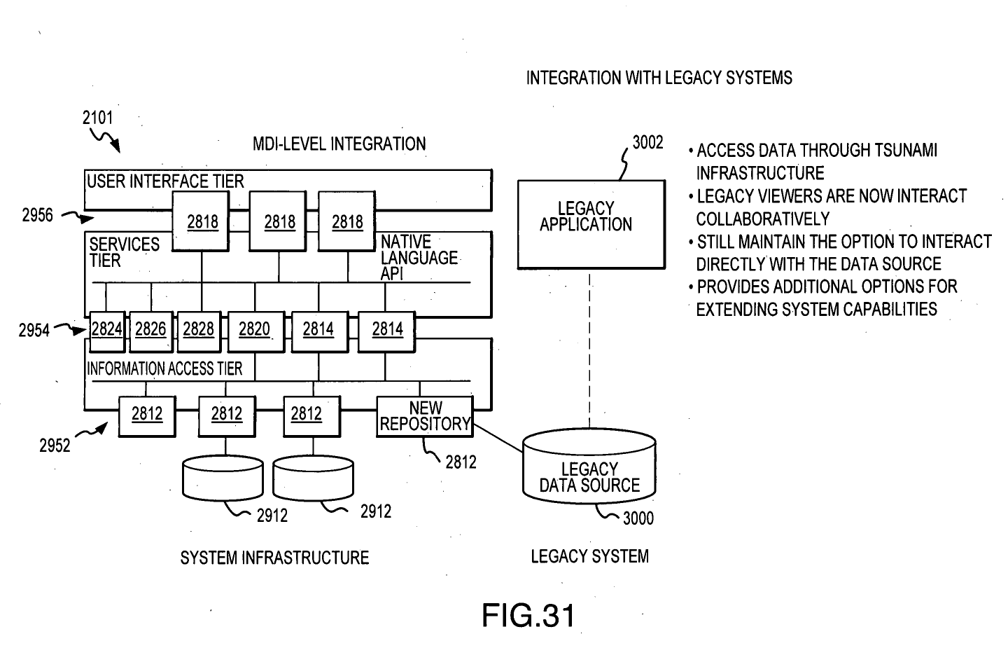

FIG. 31 illustrates second (or midlevel) level integration of the collaboration system 2101 with a legacy system. Second level integration involves modifying one or more of the legacy client viewers and/or processes to access the legacy data 3000 through the collaboration subsystem 2101 infrastructure. In addition to having a new repository server 2814 in the information access tier 2952 associated with the legacy data source 3000, the legacy application 3002 is connected through a native languages API to the services tier 2954. This enables selected portions of legacy applications 3002 (combined user interfaces and processing applications) to operate in a collaborative environment and to manipulate the legacy data source 3000 as well as all other data sources 2912 made available to the infrastructure, while still maintaining the ability to interact directly with the legacy data source 3000 using the legacy application 3002.

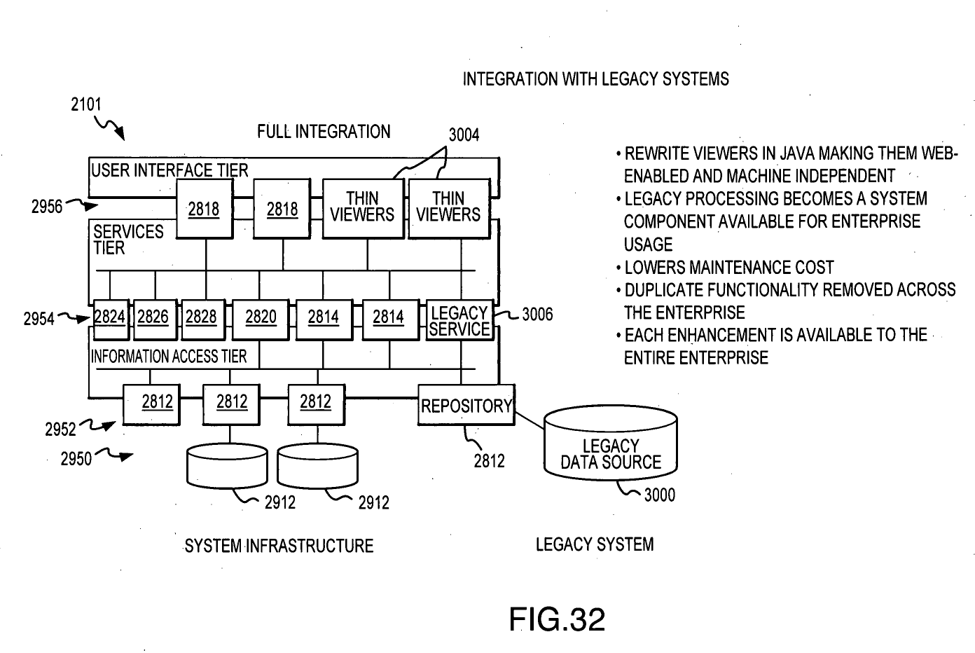

FIG. 32 illustrates third (or full) level integration of the collaboration subsystem 2101 with a legacy system. Third level integration involves rewriting components (data viewers, processing) of the legacy system using the underlying component architecture of the collaboration system 2101. This provides the benefits of component distribution, system management, viewers that are Web enabled, and supports lifecycle management (activation, passivation, and persistence). As with first and second level integration, a new repository 2814 is provided in the information access tier 2952 that is associated with the legacy data source 3000. However, in the case of full integration, the legacy application is rewritten as one or more thin viewers 3004 included in the user interface tier 2956 and a legacy processing service 3006 included in the services tier 2954. The thin viewers 3004 may, for example, be rewritten in Java, making them Web enabled and machine independent. Incorporating the legacy user interface and processing services into the user interface tier 2956 and services tier 2954, respectively, makes them a system component available for enterprise usage. It will be appreciated that full integration of the collaboration subsystem 2101 with a legacy system lowers system maintenance costs, eliminates duplicate functionality across the enterprise, and makes each enhancement available to the entire enterprise. In addition, the integration technique chosen, and corresponding benefits, are managed stepwise with respect to both cost and risk, in accordance with project needs, using the present invention.

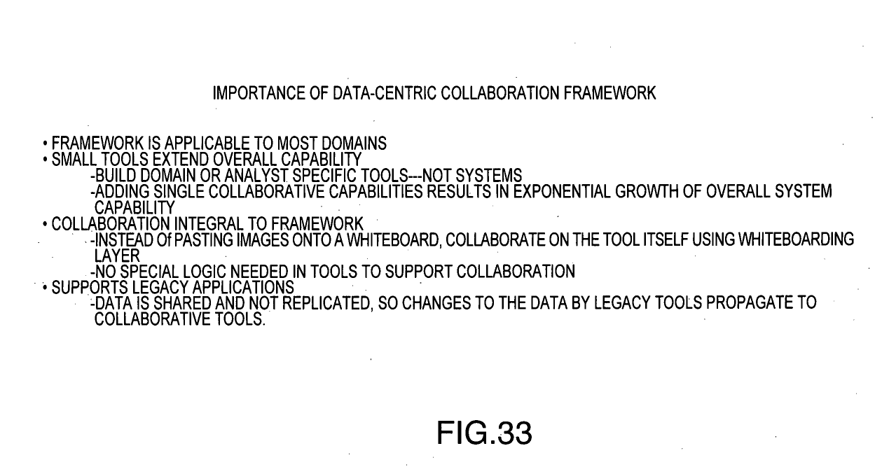

Referring to FIG. 33, the collaboration subsystem 2101 of the present invention moves the complexity of collaborative processing into the infrastructure. Visualization and control properties (color, selection, symbology, etc.) become an extended part of the data within the infrastructure rather than simply being a hard-coded characteristic of the client-viewing tool 2818. In this approach, client applications (user interfaces, processing agents) are simplified by removing the need for specialized data access methods or collaboration implementation logic. Viewing tools 2818 simply access the data through the infrastructure, display or manipulate the data as appropriate to the tool 2818, and provide any updates back to the infrastructure. Any interactions with the data, including manipulating visualization characteristics, are viewed collaboratively by all tools 2818 interacting within the same conference 2902. Because all of the visualization and control properties are treated as an extension of the domain data, the infrastructure provides a natural environment for software agent technology to be applied as “collaborative agents” working to solve a problem. Agents can monitor and act on actions performed by human participants or can be configured to perform actions based on control information.

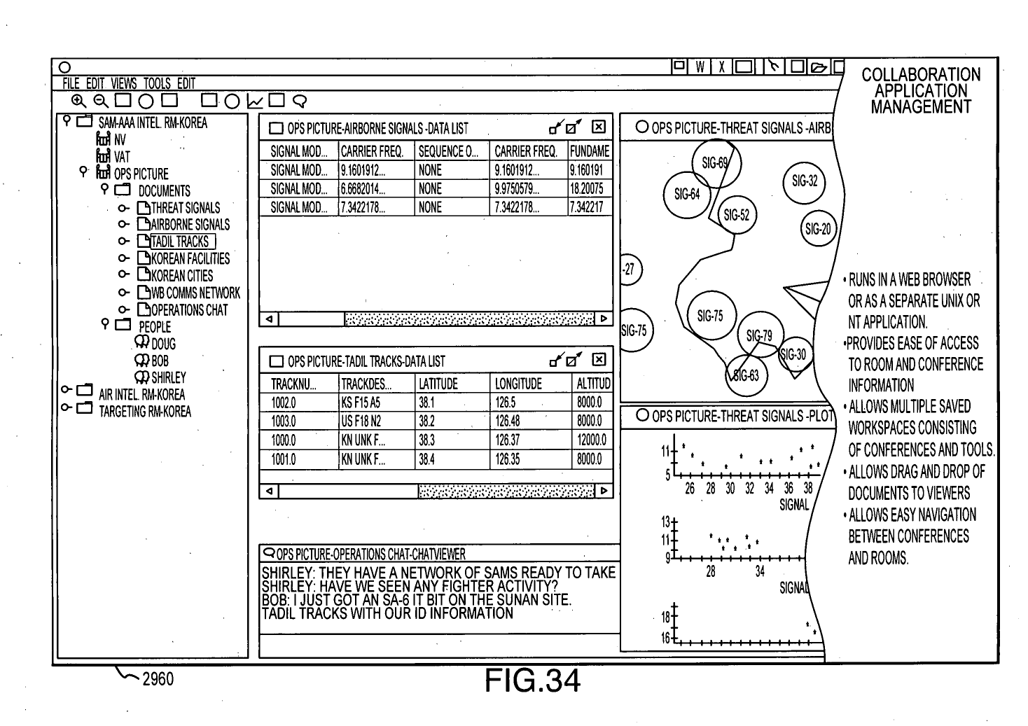

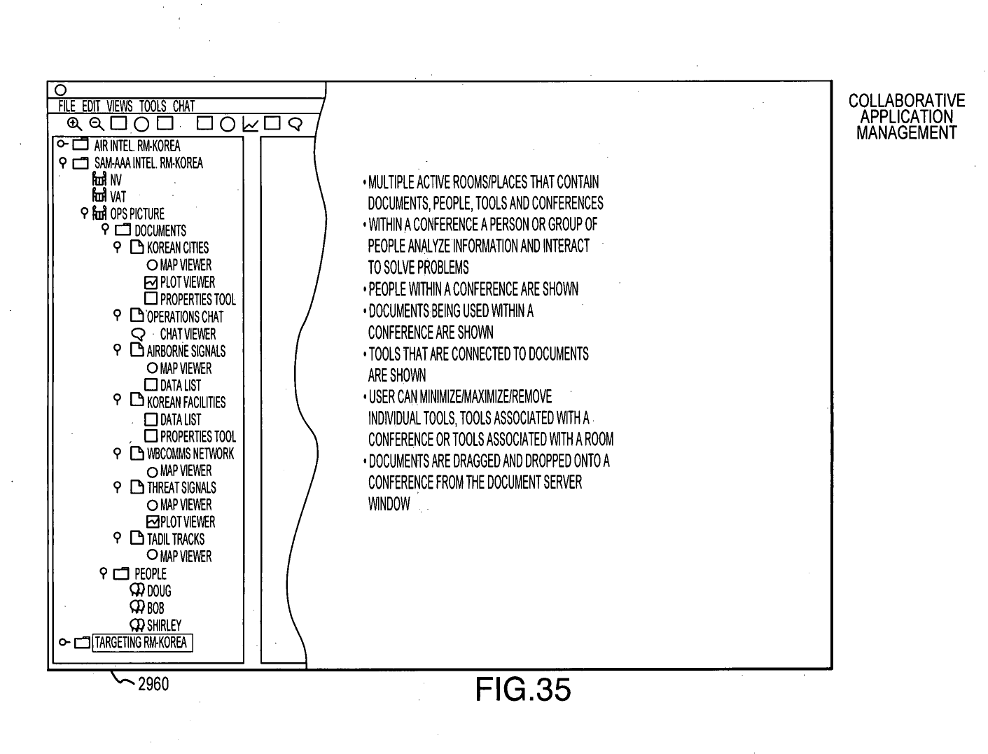

Referring now to FIGS. 34-41, exemplary user interfaces of the collaboration subsystem 2101 and several components thereof are shown. FIGS. 34-35 show an exemplary embodiment of a user interface 2860 of the collaboration subsystem 2101. The collaboration system user interface 2860 may be configured to run within another application, such as a Web browser, or as a separate application within the operating system environment of the user terminal 2906. The collaboration system user interface 2860 provides for ease of access to the conferences 2902 and information within a conference 2902. In this regard, the various conference rooms 2902 within a context 2900 may be displayed in a left hand side panel of the collaboration system user interface 2860. Windows associated with the various client tools 2818 are displayed within a right hand side panel of the collaboration system user interface 2860. The collaboration system user interface 2860 allows multiple saved workspaces consisting of conferences 2902 and tools 2818. It also allows for the dragging and dropping of documents 2910 into the various viewing tools 2818. Additionally, the collaboration system user interface 2860 permits easy navigation between conferences 2902. There may be multiple active conferences 2902 containing documents 2910, participants 2904, and tools 2818. Within a conference 2902, a participant or group of participants 2904 analyze information and interact to solve problems.

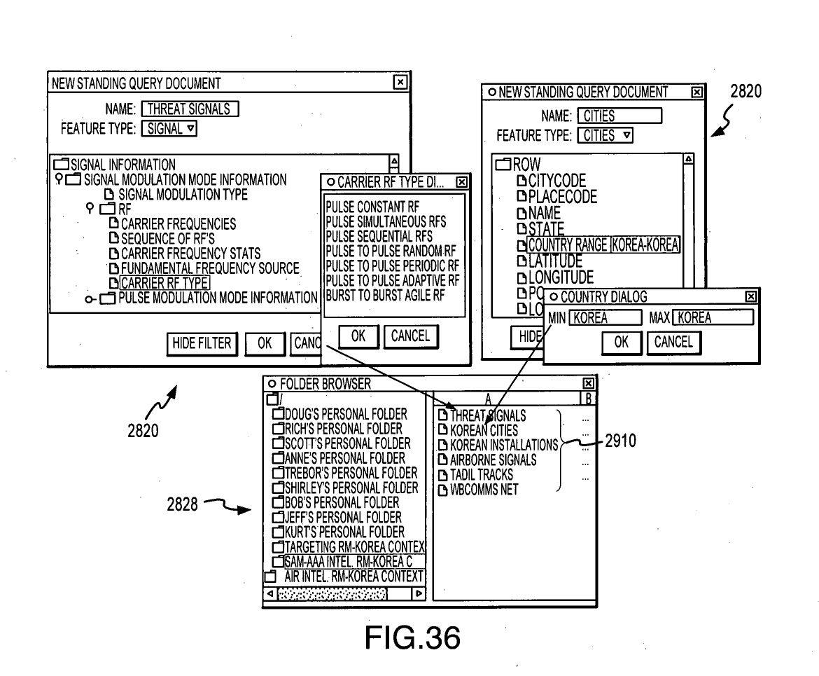

FIG. 36 illustrates interfaces of the query viewing tool 2820 and view into JCS document server 2828. The query-viewing tool 2818 dynamically learns about the repositories 2812 and gets attribute metadata from the repositories 2812. It creates an agent representing the standing query. The results of the query become a document 2910 which may then be used for collaboration. The document itself is a token representing the results—no document data is conveyed to the user's viewer by this action. The documents 2910 created by the standing query agents are displayed within the JCS document server 2828 interface.

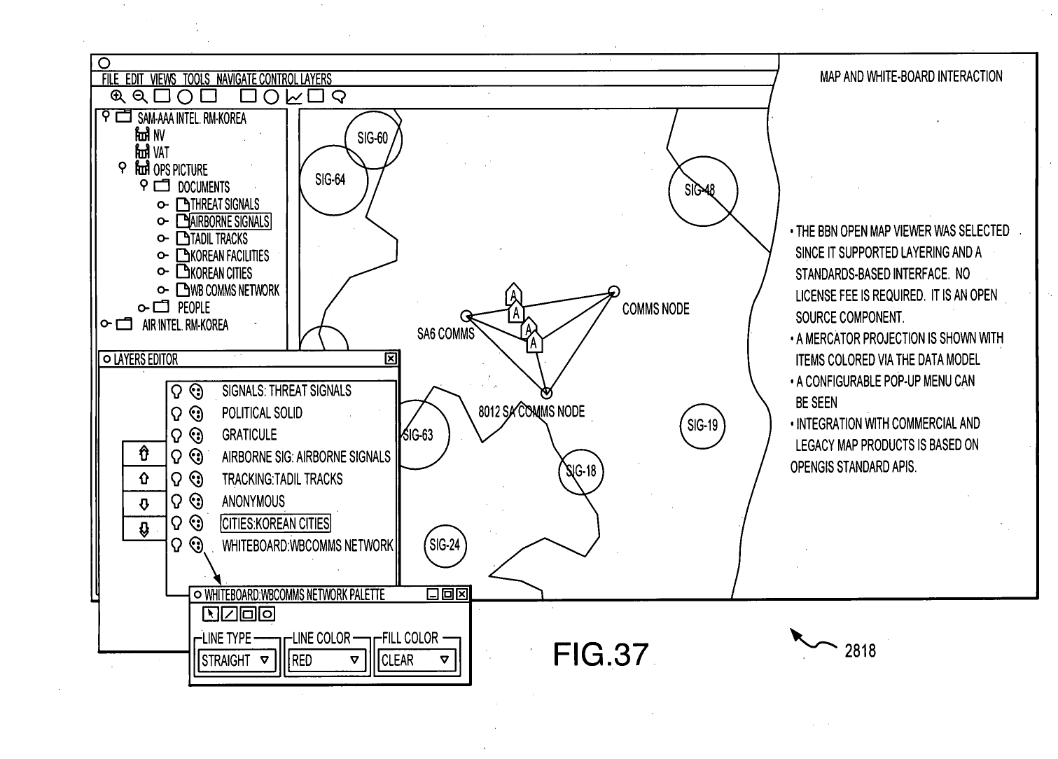

FIG. 37 shows an interface of the map-viewing tool 2818. The map-viewing tool 2818 may comprise an open source component such as, for example, the BBNOpen Map Viewer, which supports layering and a standards-based interface. The map viewing tool 2818 displays a map in a chosen projection (e.g., a Mercator projection as is shown) with the data items overlaid on the map and colored in accordance with their extended properties in the data model. The map-viewing tool 2818 includes a configurable pop-up “layers editor” menu where the user may edit visualization attributes (e.g., line type, line color, fill color) for display of the data items.

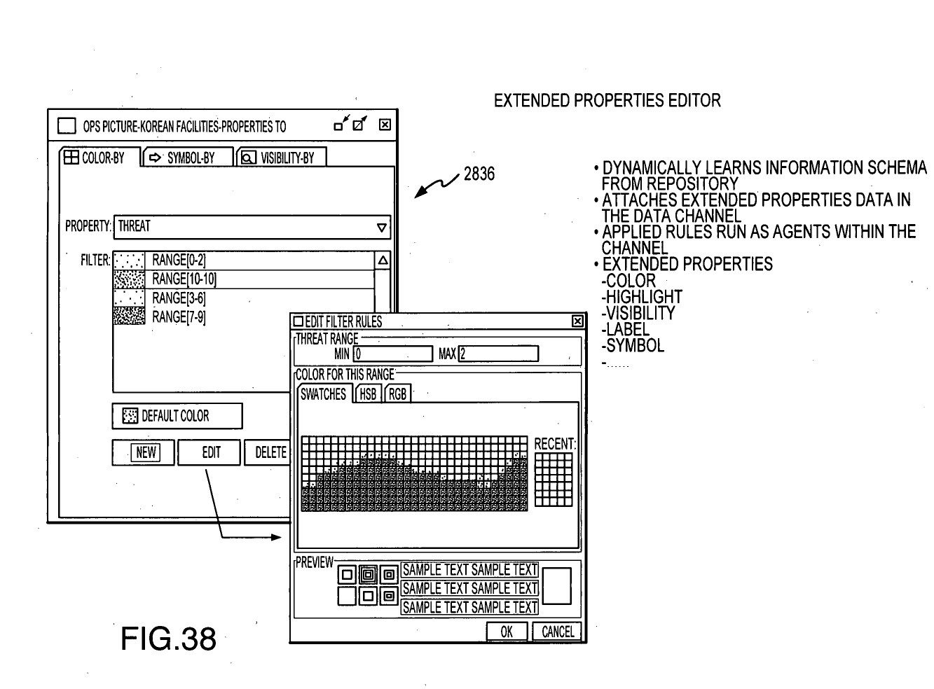

FIG. 38 shows an interface of an extended properties editor 2836. The extended properties editor 2836 provides for attachment of extended properties (e.g., color, highlight, visibility, label, symbol, etc.) to data items in the data channel(s) 2814. The extended properties editor 2836 dynamically learns the information schema from the repositories 2812. The rules applied through the extended properties editor 2836 run as agents within the data channel(s) 2814.

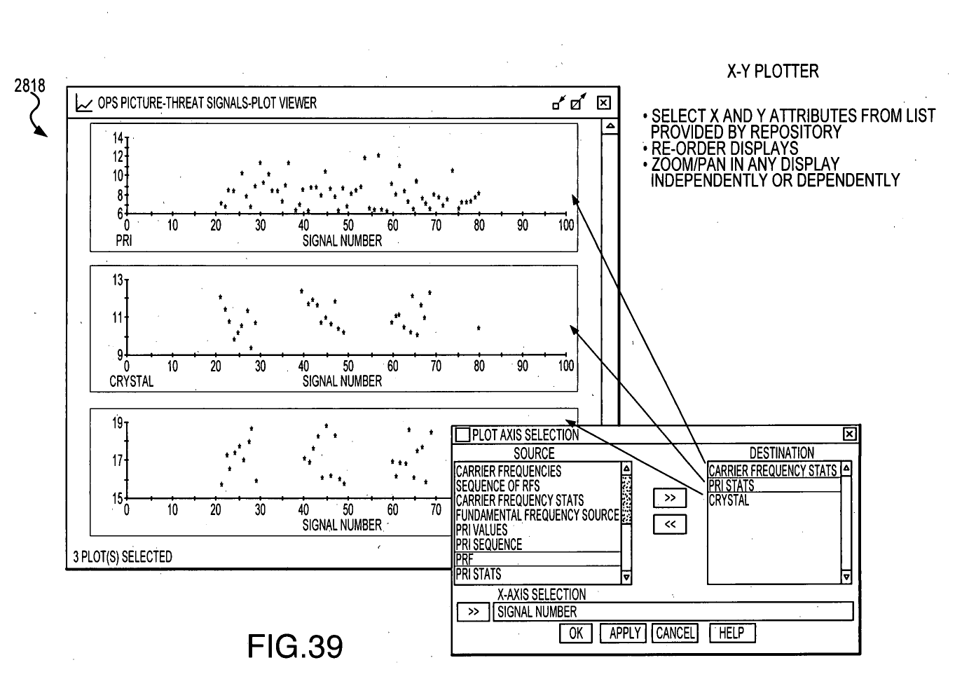

FIG. 39 shows an interface of the X-Y data-viewing tool 2818. The X-Y data viewing tool 2818 allows the users to select X and Y attributes from the list provided by the repositories 2812 for display within one or more plots, provides for reordering of the plots, and permits zooming and panning in any plot independently or independently.

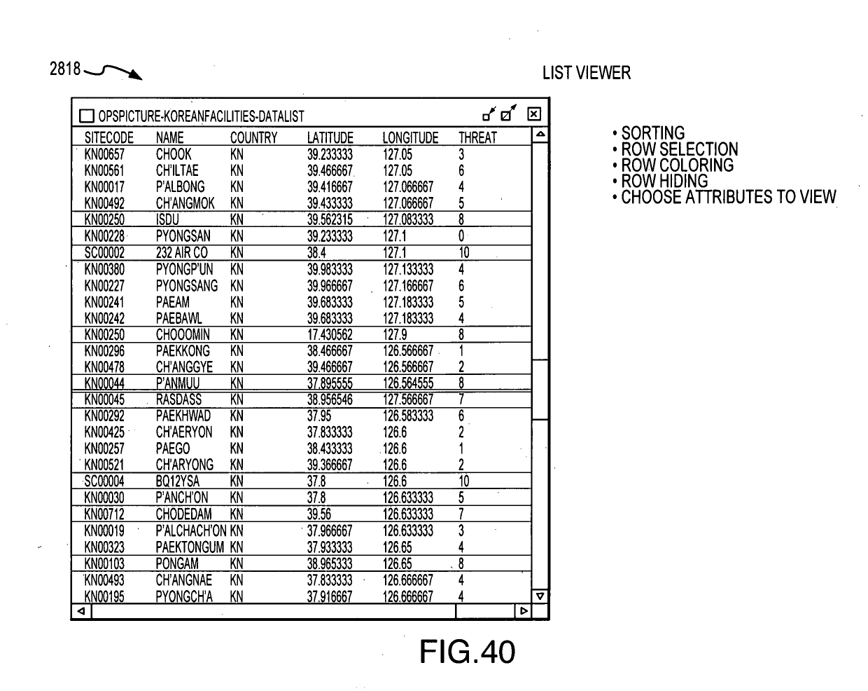

FIG. 40 shows an interface of the list viewer tool 2818. The interface of the list viewer tool 2818 provides for viewing and manipulation of data items from the data sources 2912 in a table format. In this regard, the data items may be sorted. Specific rows within the data table may be selected, colored, and hidden. Additionally, the participants 2904 may select various attributes of the data items for viewing.

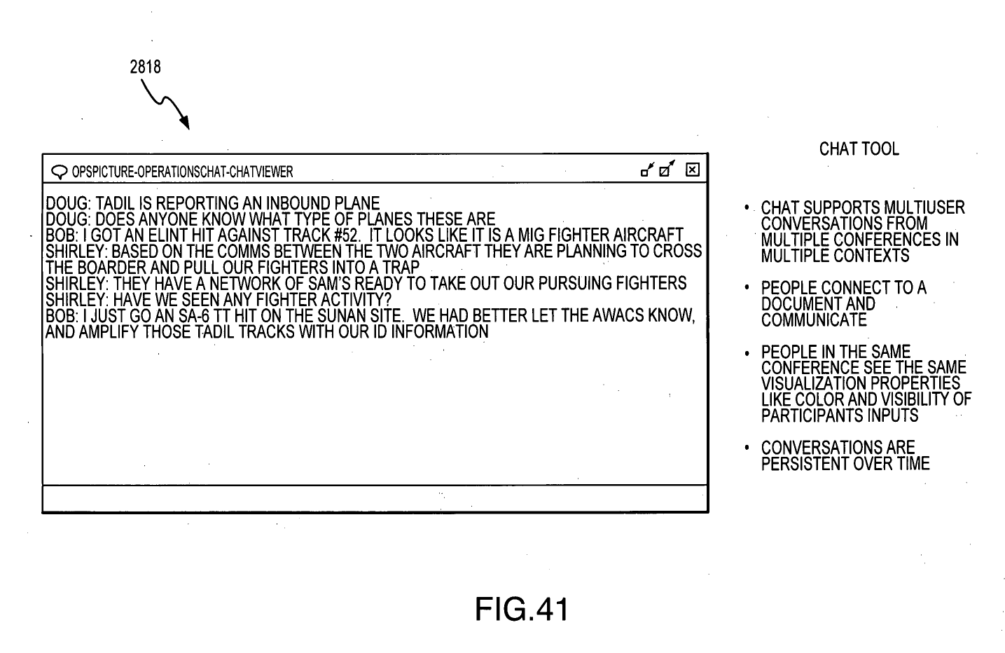

FIG. 41 shows an interface of the chat tool 2818. The chat tool 2818 supports multi-user conversations from multiple conferences 2902 in multiple contexts 2900. As shown by the example text within the chat tool 2818 interface, participants 2904 connect to a document 2910 and communicate with one another. Participants 2904 in the same conference 2902 see the same visualization properties such as color and visibility of participant inputs.

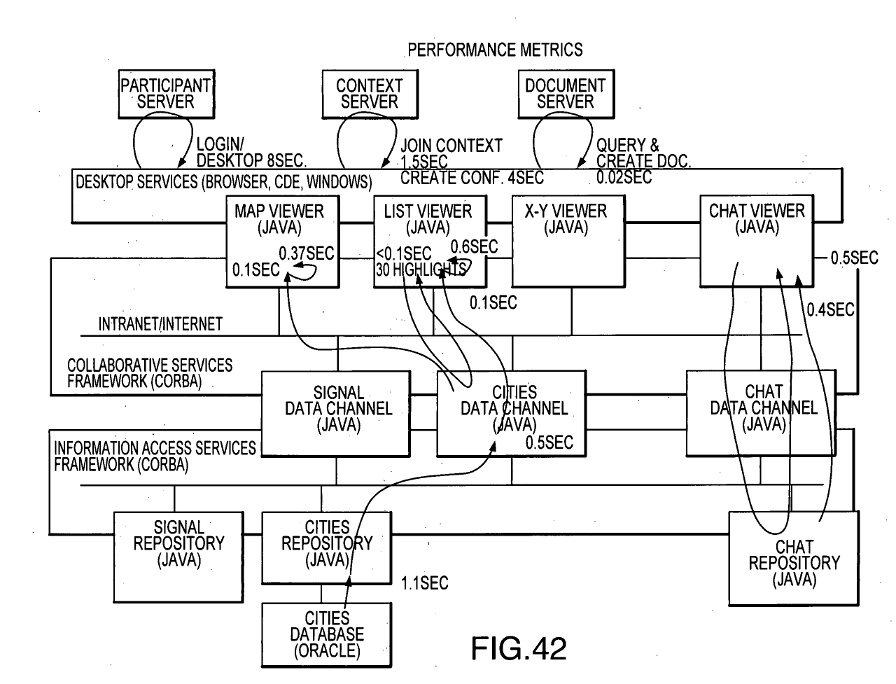

It will be appreciated that the previously described collaboration subsystem 2101 infrastructure provides a change to the way systems are built and enhanced. Using the collaboration subsystem 2101 infrastructure, new capabilities can be added to the system as small client applications that interact through the infrastructure. The resulting system is constructed of many small applications providing unique capabilities that work together to form the entire system. Each client user interface, processing component, or data repository interacts in a data centric collaborative environment where each component capability extends the capabilities of the other components. The result is a system whose overall capability grows exponentially with every added capability. With the collaboration subsystem 2101 infrastructure, each user is free to select the appropriate tools 2818 to be most effective at analyzing and manipulating data no matter what the data source 2912. This allows human resources with varying backgrounds (engineering, analytical, mathematical, operational, etc.) to use specialized tools that enable the most effective application of their diverse skills to solve problems. In this regard, the performance metrics of one embodiment of a computer implemented collaboration subsystem 2101 in accordance with the present invention are summarized in FIG. 42.

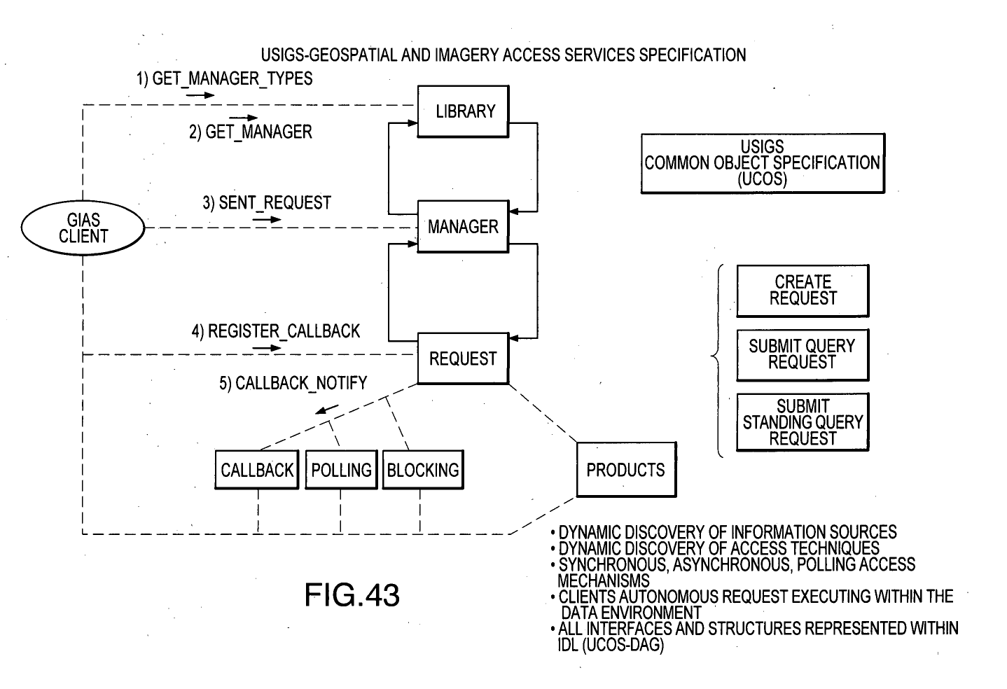

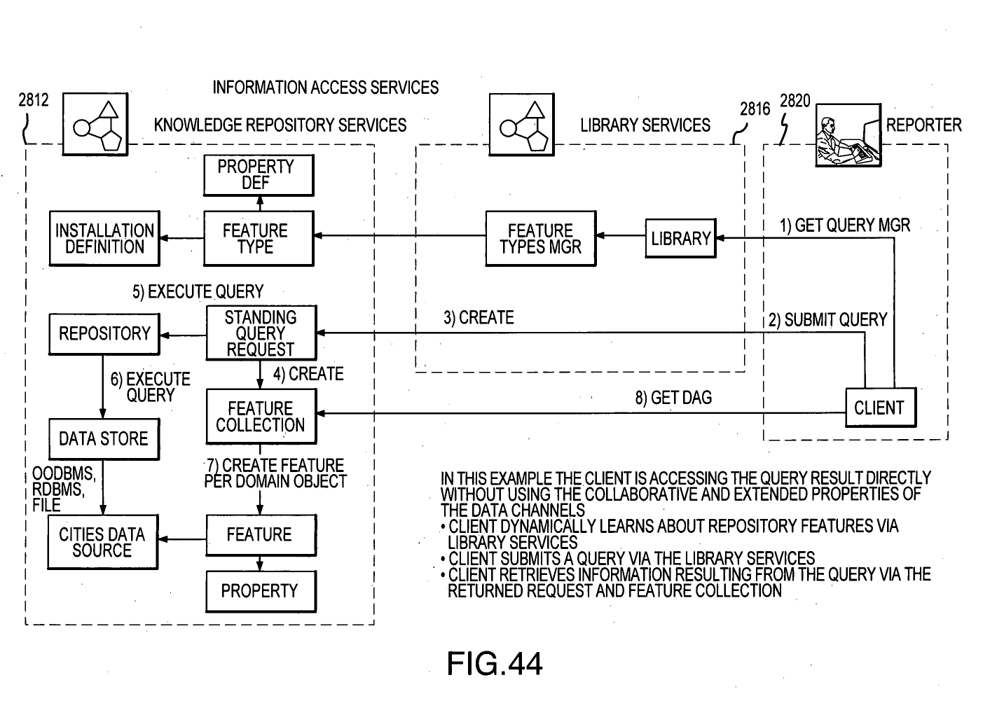

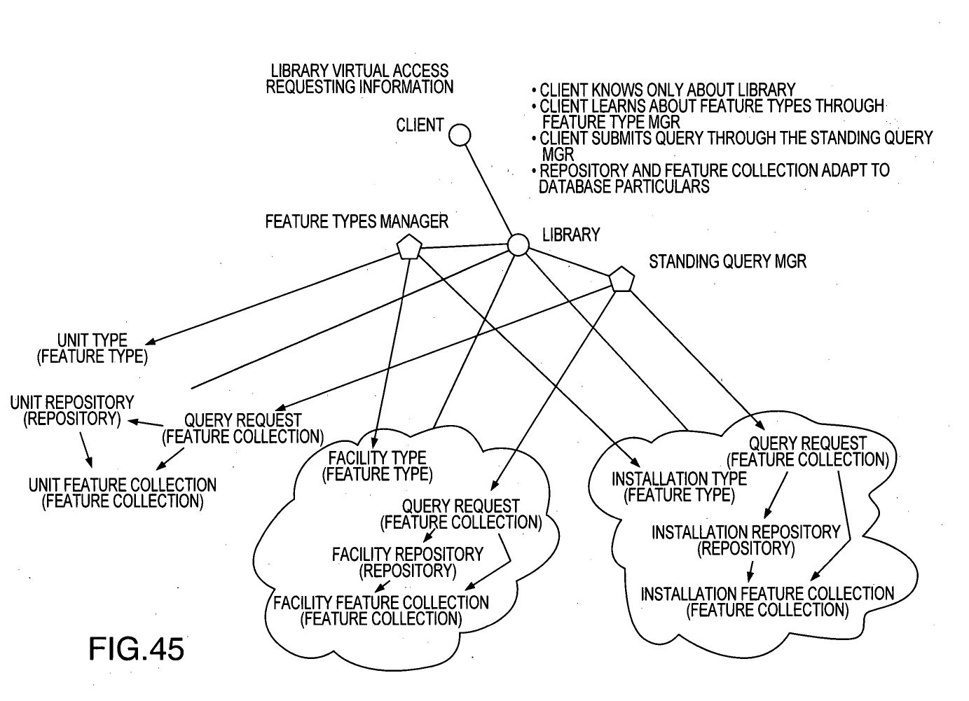

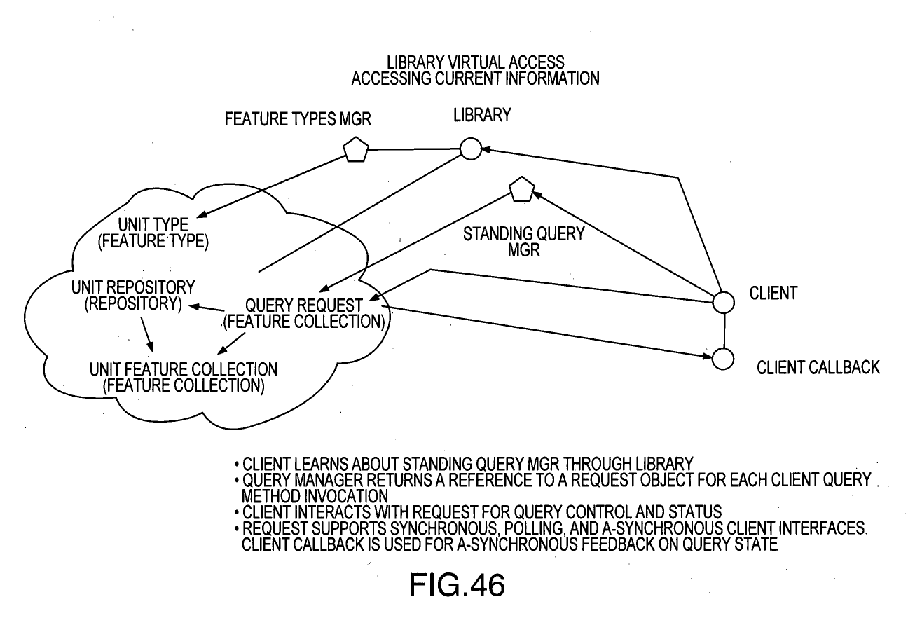

Referring now to FIGS. 43-46, the collaboration subsystem 2101 of the present invention provides information access services (also referred to as library services). The information access services (IAS) are composed of a set of factory components, management components, library components, and request components that provide methods for discovery of available data sources 2912 and the creation of requests for information from those data sources 2912. These components are based on the United States Imagery and Geospatial Services (USIGS) Geospatial and Imagery Access Services (GIAS) Specification. FIG. 43 illustrates the high level interaction between libraries, managers and requests. FIGS. 44-46 illustrate the lower level interaction between the (IAS) components in performing a query on a data source 2912 and subsequently retrieving data to be used by a client tool 2818.

Features of the various interface components in FIGS. 43-46 are summarized in the table below.

Library: “Named” Object within the production domain that supports information access capabilities. All IAS services accessible through the Library Object. Database location, data representation (schema, object model), and type (RDBMS, OODBMS, file) are transparent to users of IAS.

Standing Query Manager: Is responsible for initiating the client request and then managing the request objects over the duration of the transactions. Other types of Managers (Query Manager, Agent Manager, etc.) support different forms of information access.

Standing Query Request: Client query transactions result in the creation of a Request Object. The Request provides the client visibility into the information access process. The client has three methods of being notified when information is available: Post a callback for a-synchronous notification; Synchronously block until information is available; or Poll for Request status periodically.

Feature: Provides a common adapter (interface) to a domain object. Through the Feature, a client can access a domain object's information. The Feature and Repository Objects provide an adapter layer that shield client programs from the difference database storage and access mechanisms.

Property: A Directed Acyclic Graph (DAG) of Properties is used to retrieve/update the information on a particular Domain Object. Associations between two Features (Facility—>Equipment) is represented as a DAG property that contains a sequence of feature association structures. From this property (within Facility) a client can create a second collection of Features (Equipment) that can be displayed.

Feature Type: The SIGINT Object Model (SOM) and Fusion Object Model (FOM) have identified a set of core classes (Features—Installation, Facility, Equipment, Unit, Signal, etc) that make up a domain. Through the Feature Type a client can obtain retrieve meta-data that is used to construct a query.

Property Def: A Directed Acyclic Graph of Property Def's (DAG Def.) is used to pass the definition of a particular Domain Object.

Repository: Provides a common interface to a storage server for query evaluation and management. Each Feature Type within a database will have an associated Repository Object. The Query Request created by the Query Manager goes to the Repository for evaluation. The Repository is responsible for converting the query, which is in the domain terms, into the specific language and schema of the database. The Repository performs the query and populates the Feature Collection with feature objects.

Factory: Provides services for construction of instance objects. There is a specific factory for each class. Multiple construction methods may be provided depending on the factory.

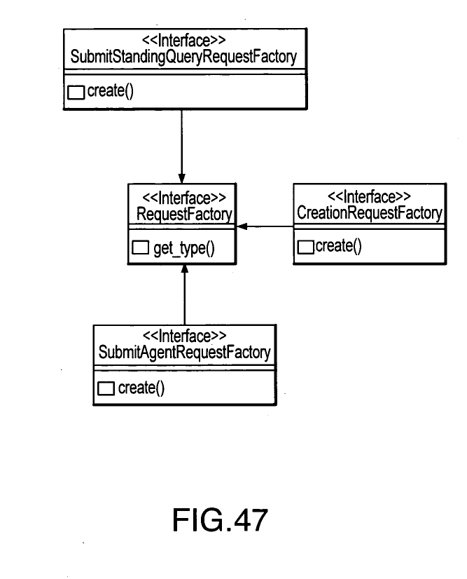

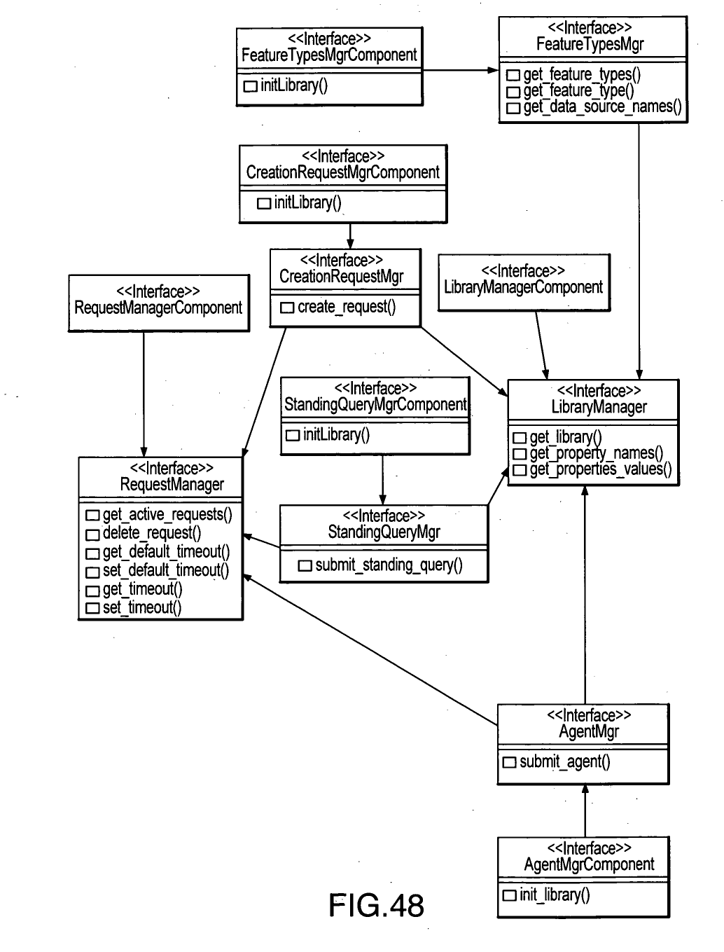

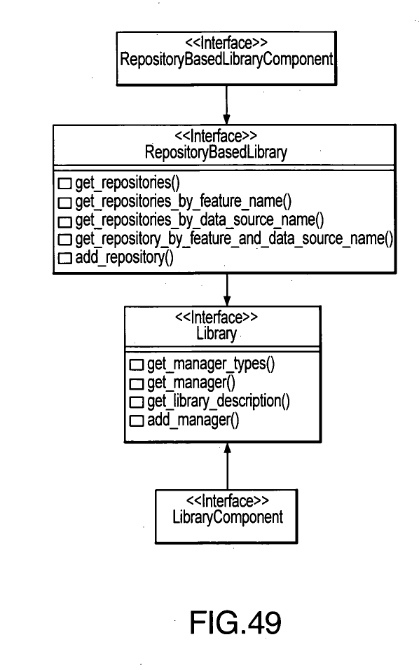

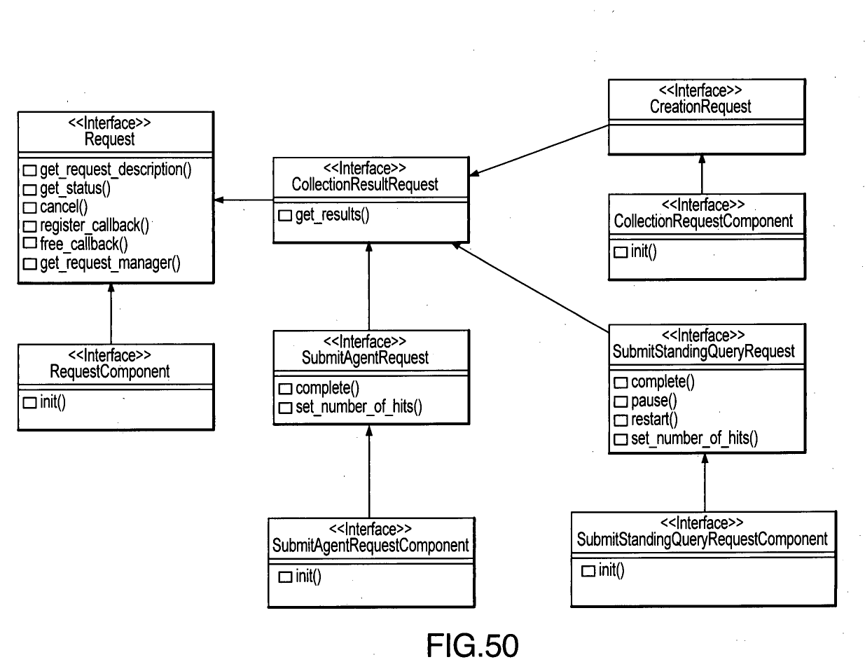

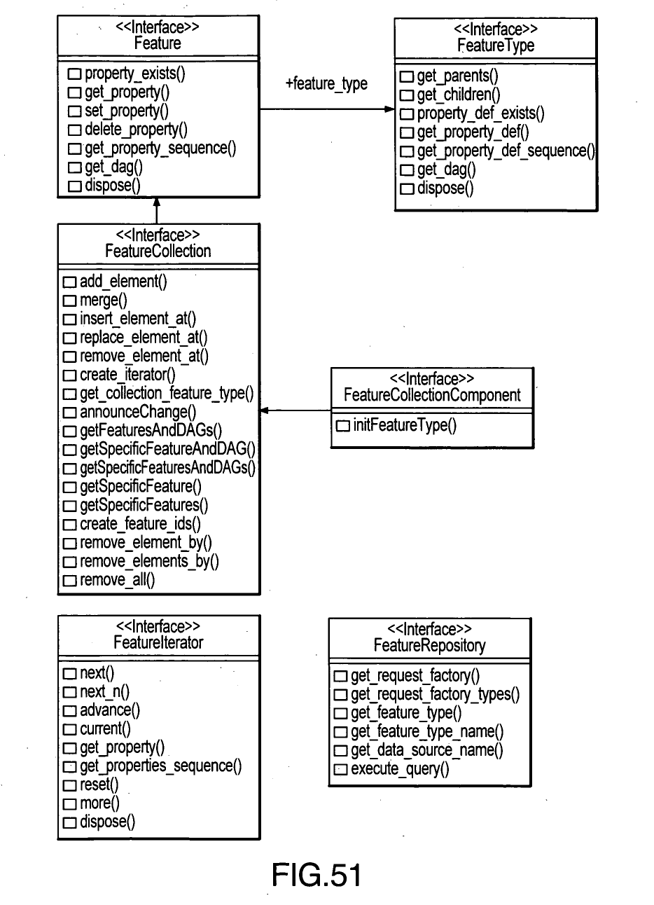

The inheritance structure of the various IAS components is illustrated in FIGS. 47-51.

Referring more particularly to FIG. 44, when a user of the collaboration subsystem 2101 activates the query viewer client tool 2820, the query viewer client tool 2820 dynamically learns about repository features via the library server 2816. In this regard, the query viewer client tool 2820 gets the query manager from the library server 2816, which includes a library and a feature types manager. The feature types manager in turn accesses a feature type within the repository server 2812. The feature type includes a property definition and an installation definition. Using the query viewer client tool 2820, a query is submitted via the library server 2816 to the repository server 2812. In this regard, when the repository server 2812 receives a query request created through the library server 2816, the repository server 2812 creates a standing query request. The repository server 2812 then creates a document 2910 (also referred to herein as a feature collection) and also executes the query. The standing query request is executed through a repository and a data store to access data within a data source 2912 associated with the repository server 2812. The repository server 2812 creates a feature for each domain data item meeting the specified query criteria. Each feature created includes an extended property. The document 2910 created in response to the query is returned in the form of a Directed Acyclic Graph (DAG) to the query viewer client tool 2820.

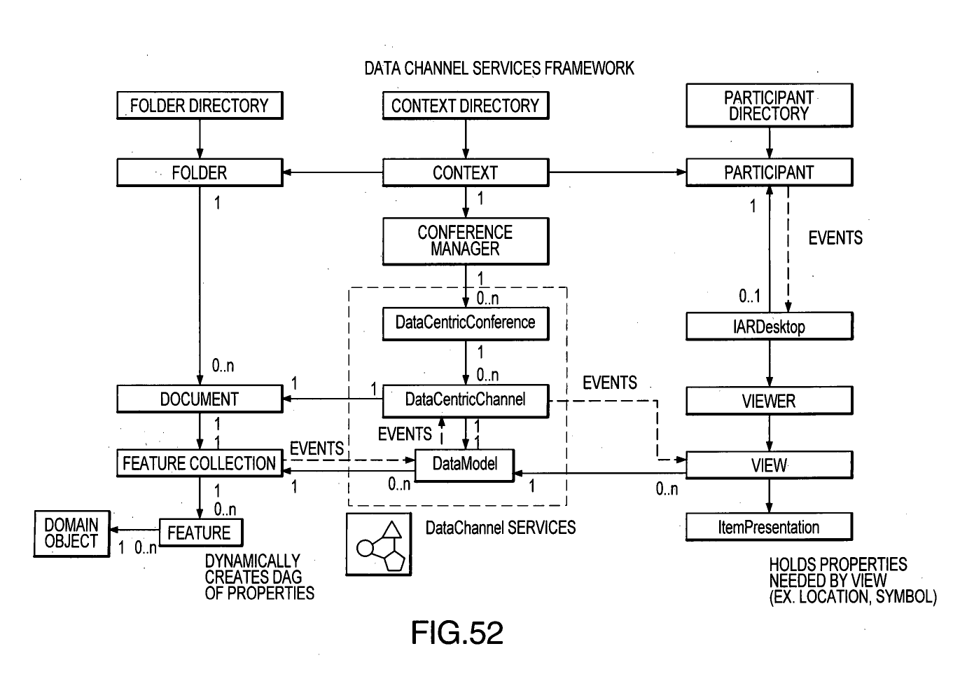

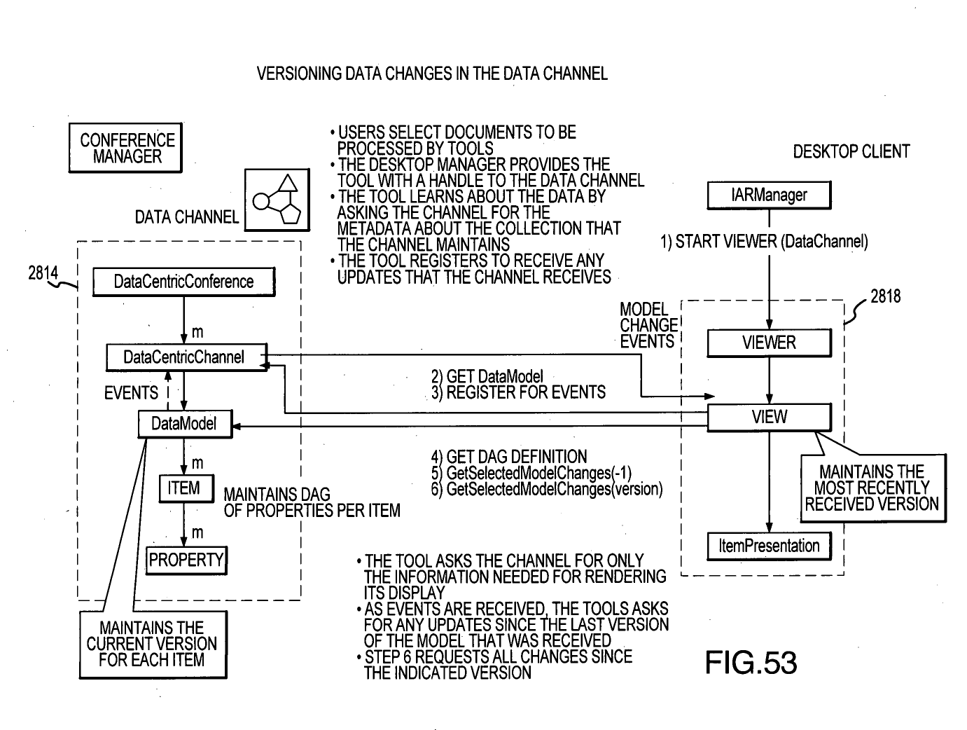

Referring now to FIGS. 52-53, the data channel is the collaborative interface to the data provided by a document 2910. A data channel server 2814 is created when a document 2910 is placed into a conference 2902. Upon initialization, the data channel server 2814 is extended to provide visualization and control properties such as highlight, visibility, and color. The data channel server 2814 is extendable from client applications or agents in real-time by calling methods on the extended properties manager to teach the data model additional collaborative attributes. FIG. 52 shows the data channel services framework in relation to other component interfaces within the collaboration subsystem 2101 architecture.

FIG. 53 illustrates the components that make up a data channel server 2814 and describes the interactions between a client and the data channel sever 2814 to learn about the data referenced by a document 2910 and to extract the information through the data channel server 2814 interface, as well as register for updates that the data channel server 2814 may receive. As is shown in FIG. 53, the data channel server 2814 includes a conference 2902. Within each conference 2902 there are multiple data channels. Each data channel includes a data model. Each data model represents multiple data items having multiple extended properties. Each data model maintains the current version of each of its data items. When a client data-viewing tool 2818 is started, the desktop manager provides a handle to the viewer within the client data viewing tool 2818. The viewer includes a view that includes an item presentation. The view maintains the most recently received version of the data model obtained by the client data-viewing tool 2818 from the data channel server 2814. In this regard, the client data-viewing tool 2818 gets the data model from the data channel server 2814 and registers with the data channel server 2814 to be informed of events that the data channel receives from the data model. The next step undertaken by the client data-viewing tool 2818 is to get the DAG definition of the properties of each data item. In this regard, the client data-viewing tool 2818 asks the data channel server 2814 for only the information needed for rendering its display. Next the client data-viewing tool 2818 gets all of the changes to the data model. Then, as events are received, the client data-viewing tool 2818 asks for any updates to the data model since the last version of the data model was obtained from the data channel server 2814.

Several features of the present invention are applied to reduce a required network bandwidth for collaboration and to reduce data copying across the network. These mechanisms avoid some known performance problems with distributed object systems.

First, the repository sets policies to access the data it manages. This allows “lazy evaluation” of queries, postponing actual querying until the data is needed. The repository also has control of how many queries are supported, the ability to bundle updates, and the ability to limit the amount of data retrieved in a collection. Typically, the repository is placed topologically and computationally close to the data source to minimize network usage between the data source in the repository.

The feature collection is implemented as a CORBA proxy, that is, a token, so that no matter how many users and conferences the data is represented in, the collection itself is created and managed exactly once. The feature collection may be located topologically and computationally near the repository where creation and updates of collections minimize network communications bandwidth and latency.

The data channel is selected via a “finder” service, which has the ability to find the best data channel manager for the particular collection and conference. The data channel uses two mechanisms to optimize its performance vis-a-vis the viewers: first, viewers receive only the features that they request, and secondly, the data changes are not sent to all subscribers immediately. Instead, version change events are sent, which viewers can manage in the best way suited to their behavioral use (e.g., ignoring events altogether, responding to, at most, one event every 10 seconds, displaying the availability of an update but requiring a user to take action to receive the update).

The Radiant Trust System is capable of receiving inputs from a variety of sources that may be associated with a variety of different formats, data structures and messaging protocol. The modern repository-based approach of the Radiant Trust System supports the ability to learn about such input information. In this regard, the input information can be synthesized and is made self-describing by using standards such as DLM and XML. In this manner, interoperability between systems that are not designed to be interoperable is supported. The repository layer also eliminates the need for knowledge of particular data space management system and storage methods, as well as the location of the data. The data, which was in the data sources, is accessed using native access methods and legacy systems. The Radiant Trust System thereby seamlessly supports agent-based data acquisitions.

While various embodiments of the present invention have been described in detail, further modifications and adaptations of the invention may occur to those skilled in the art. However, it is to be expressly understood that such modifications and adaptations are within the spirit and scope of the present invention.

What is claimed:

1. A method for use in managing a collaborative environment involving multiple data systems, comprising the steps of:
providing a collaboration system, separate from said multiple data systems, for controlling messages between said multiple data systems, wherein said collaboration system is configured to communicate with each of said multiple data systems via a defined network interface;
first accessing a communication between identified users of said multiple data systems;
second accessing processing information, indexed to one or more of said identified users, using said collaboration system, said processing information including instructions (executable rules) for use in processing said communication transmitted between said multiple data systems;
using said executable rules and said communication to obtain processed information; and
providing an output to one or more of said identified users based on said processed information.

2. A method as set forth in claim 1, wherein said step of first accessing comprises obtaining said first information from a non-government source.

3. A method as set forth in claim 2, wherein said step of first accessing comprises obtaining said second information from a government source.

4. A method as set forth in claim 1, wherein said processing information relates to converting at said communication into a converted form related to data structure.

5. A method as set forth in claim 4, wherein said converted form is an internal form of said collaboration system.

6. A method as set forth in claim 1, wherein said processing information relates to one or more of said identified users intended to receive said output.

7. A method as set forth in claim 1, wherein said processing information relates to modifying a content of said communication.

8. A method as set forth in claim 1, wherein said processing information relates to combining a first content of said communication with a second content of a second communication between certain users of said multiple data system.

9. A method as set forth in claim 1, wherein said processing information relates to using said first content and said second content in performing a comparison to a threshold for identifying a condition of interest.

10. A method as set forth in claim 1, wherein said processing information relates to controlling a content of said output based on an identity of a recipient user.

11. A method as set forth in claim 1, wherein said processing information relates to controlling a content of said output based on a policy of said multiple source systems.

12. A method as set forth in claim 1, wherein said processing information relates to controlling a content of said output based on a civil liberties related criterion.

13. A method as set forth in claim 1, wherein said processing information relates to controlling a content of said output based on one of an authorization and a security clearance associated with said recipient user.

14. A method as set forth in claim 1, wherein said collaboration system enables collaboration between a number of said multiple source systems with respect to collaboration subject matter.

15. A method as set forth in claim 1, wherein said processing information comprises executable rules for operating on data objects of said communication.

16. A method as set forth in claim 15, wherein said rules access content of said data objects.

17. A method as set forth in claim 15, wherein said rules differ depending on a source and recipient pairing of said communication.

18. A method as set forth in claim 17, wherein said rules differ depending on a direction of transmission of said communication as between said source and recipient pairing.

19. A method as set forth in claim 1, further comprising the step of establishing a log relating to a processing of said communication by said collaboration system, wherein said log allows for verification of handling of said communication by said collaboration system in accordance with a predefined policy.

20. A method as set forth in claim 19, wherein said collaboration system is further operative for automatically processing logs relating to communications between said multiple data systems for auditing compliance with said predefined policy.

21. A method as set forth in claim 1, wherein said collaboration system is further operative for parsing said communication into data objects of a desired size and separately applying said instructions with respect to each of said objects.

22. A method as set forth in claim 21, wherein said parsing is performed recursively to provide progressively simpler data objects.

23. A method for use in sharing information between at least one source system and multiple recipient systems, comprising the steps of:
providing a collaboration system interposed between said source system and said recipient systems for facilitating sharing of information between said source system and said recipient systems, said collaboration system configured for communication with each of said source system and said recipient system using a defined network interface;
first accessing, using said collaboration systems, first input information from said source system;
second accessing, using said collaboration system, a first instruction set related to a first recipient system;
third accessing, using said collaboration system, a second instruction set related to a second recipient system;
first operating said collaboration system to provide a first output to said first recipient system based on said first input information and said first instruction set; and
second operating said collaboration system to provide a second output to said second recipient system based on said first input information and said second instruction set, where said second output has a content different than said first output.

24. A method as et forth in claim 23, wherein said first instruction set and said second instruction set are both defined by a policy for controlling sensitive information.

25. A method as et forth in claim 23, further comprising accessing a third instruction set and providing a third output to a third recipient system based on said first input and said third instruction set.

26. A method as set forth in claim 23, wherein said first output differs from said second output based on different rights associated with said first and second recipient systems regarding sensitive information according to a policy controlling said sensitive information.

27. A method for use in network-based collaboration, comprising the steps of:
establishing collaboration subject matter;
establishing a conference, wherein multiple collaborators access said collaboration subject matter during a time interval of said conference, wherein said time interval can be of indefinite duration and less than all of said collaborators can participate in the conference at times within said time interval;
first processing said collaboration subject matter, in connection with said conference, to provide a first output for a first collaborator based on a state of said collaboration subject matter at a first time, said first output having a first content; and
second processing said collaboration subject matter, in connection with said conference, to provide a second output for a second collaborator based on said state of said collaboration subject matter at said first time, said second output having a second content different than said first content, wherein said first output is provided at a second time, the same or different than said first time, and said second output is provided at a third time, the same or different than said second time.

28. A method as set forth in claim 27, wherein said step of processing comprises parsing said collaboration subject matter into a number of information objects and applying said rule set to each of said information objects.

29. A method as set forth in claim 27, wherein said step of first processing comprises parsing said collaboration subject matter into a number of information objects, identifying sensitive information associated with one of said objects and modifying said collaboration subject matter relative to said identified sensitive information.

30. A method as set forth in claim 20, wherein said step of modifying comprises modifying a portion of the content of said one of said objects.

31. A method as set forth in claim 26, wherein said step of modifying comprises deleting said one of said objects.

32. A method as set forth in claim 27, wherein said step of second processing comprises accessing a second content-based rule set associated with said second collaborator and processing said collaboration subject matter based on said second content-based rule set.

33. A method for allowing collaboration between multiple users of a data network, comprising the steps of:
providing collaboration subject matter including first information from at least one information source;
providing a collaboration system for enabling access to at least portions of said first information by a first user system and a second user system;
first operating said collaboration system to receive said collaboration subject matter;
second operating said collaboration system to identify said first user system, access a first content-based rule associated with said first user system, process said first information using said first content-based rule to establish a first output based on said collaboration subject matter, and provide access to said first output by said first user system; and
third operating said collaboration system to identify said second user system, access a second content-based rule associated with said second user system, process said first information using said second content-based rule to establish a second output, different than said first output, based on said collaboration subject matter, and provide access to said second output by said second user system;
wherein said first and second user systems can be used for collaborative work related to said collaboration subject matter in accordance with said first and second content-based rules.

34. A method as set forth in claim 33, wherein said first content-based rule and said second content-based rule are both defined by a policy for controlling sensitive information.

35. A method as set forth in claim 33, wherein said first output differs from said second output based on different rights associated with said first and second user systems regarding sensitive information according to a policy controlling said sensitive information.

36. A method for securely sharing information among multiple information systems, comprising the steps of:
establishing a first community of multiple first information systems for secure sharing of information therebetween;
establishing a second community of a plurality of second information systems for secure sharing of information therebetween;
providing a collaboration system for facilitating sharing of information between multiple information systems;
storing, for access by said collaboration system, a first set of rules governing distribution of information among said first information systems;
storing, for access by said collaboration system, a second set of rules governing distribution of information among said second information systems; and
operating said collaboration system to control sharing of information between said first information systems based on said first set of rules and between said second information systems based on said second set of rules.

37 A method as set forth in claim 36, further comprising the steps of storing a third set of rules governing distribution of information between said first information systems and said second information systems and operating said collaboration system to control sharing of information between said first information systems and said second information systems based on said third set of rules.

38. A method for use in securely sharing information among multiple information systems, comprising the steps of:
first establishing a community of multiple information systems to be included within a secure context for sharing of information;
second establishing a collaboration system for facilitating sharing of information among said community of multiple information systems, said collaboration system being configured to communicate with each of said multiple information systems using a defined network interface;
said collaboration system being configured to process information transmitted between first and second systems of said community on a system dependent basis with regard to one of a form and a content of said information so as to facilitate sharing of information;
establishing an algorithm for detecting a condition of interest based on monitored communications;
monitoring a content of communications within said community; and
based on said monitored communications and said algorithm, selectively generating an alert message indicating the existence of said condition of interest.

39. A method as set forth in claim 38, wherein said step of monitoring comprises aggregating contents of multiple ones of said communications to identify the existence of said condition of interest.

40. An apparatus for use in managing a collaborative environment involving multiple data systems, comprising:
a processing structure, separate from said multiple data systems for controlling communications between said multiple data systems, wherein said processing structure is configured to communicate with each of said multiple data systems via a defined interface;
said processing structure being operative to access a communication between identified users of said multiple data systems, access executable rules indexed to one of said identified users, and execute said rules with respect to said communication to obtain processed information; and
output structure for providing an output to one or more of said identified users based on said processed information.

41. A method for use in processing information received from sources associated with multiple independent data systems, comprising the steps of:
receiving first input information from a first source of a first source system, wherein said first source is associated with a first input form related to data structure;
receiving second input information from a second source of a second source system separate from said first source system, wherein said second source is associated with a second input form, different from said first input form, related to data structure;
combining, using said collaboration system, at least a portion of said first information and a portion of said second information to generate processed information; and
providing an output to at least one recipient system based on said processed information;
wherein at least one of said steps of combining and providing an output is based on a defined rule set executed by said collaboration system governing sharing of information among said source and recipient systems.

42. A computer program product for use by a computer in connection with a network where interaction of multiple source systems is controlled by a collaboration system that executes system specific rules governing interaction between said multiple source systems, comprising:
logical instructions for enabling the computer to perform predetermined operations; and
a computer readable medium bearing the logical instructions;
said predetermined operations including:
accessing resources of one of said multiple source systems, where said resources have at least one system dependent attribute; and
establishing an interface to said resources such that said system dependent attribute is rendered system independent, wherein said resources are available for use across said network subject to said system dependent rules governing interaction between said multiple source systems.
